(19) United States
(12) Patent Application Publication
(10) Pub. No.: US 2002/0015064 A1
(43) Pub. Date: Feb. 7, 2002

(54) Gesture-based user interface to multi-level and multi-modal sets of bit-maps

(76) Inventors: John S. Robotham, Belmont, MA (US); Charles Lee Johnson, Newton, MA (US)

Correspondence Address: Brian M. Dingman, Mirick, O'Connell, 100 Front St., Worcester, MA, 01608, US

(21) Appl. No.: 09/726,163

(22) Filed: Nov. 29, 2000

Related U.S. Application Data
(60) Provisional application No. 60/223,251, filed on Aug. 4, 2000.
(60) Provisional application No. 60/229,641, filed on Aug. 31, 2000.

(51) Int. Cl. G06F 3/00

(52) U.S. Cl. 345/863; 345/854

(57) ABSTRACT

A method of navigating within a plurality of bit-maps through a client user interface, comprising the steps of displaying at least a portion of a first one of the bit-maps on the client user interface, receiving a gesture at the client user interface, and in response to the gesture, altering the display by substituting at least a portion of a different one of the bit-maps for at least a portion of the first bit-map.

### CROSS REFERENCE TO RELATED APPLICATION

This application claims priority of Provisional Application Ser. No. 60/223,251, filed on Aug. 7, 2000, and of Provisional application Ser. No. 60/229,641, filed on Aug. 31, 2000, and of a Provisional application entitled “Remote Browser Systems Using Server-Side Rendering”, filed on Oct. 30, 2000, attorney docket number ZFR-001PR2.

### BACKGROUND OF THE INVENTION

User Interface Actions

A client is a device with a processor and a bit-map display that supports a user interface. When a bit-map is displayed on the client's bit-map display, the client can support one or more user interface action(s) associated with the bit-map. These user interface actions provide input to the software function(s) generating the bit-map display. A user interface action can have an associated pixel location on the client display device, or it can be independent of any specific location.

A pointing device is commonly used to express the location of pixel(s) on the client display. Examples of pointing devices include a mouse, pen, touch-sensitive or pressure-sensitive surface, joystick, and the arrow buttons on a keyboard. Key presses on an alphanumeric keyboard (other than arrow keys) are typically location-independent, although an associated location of an input field may have been previously established.

For a given bit-map, a location-specific action can be a direct action or indirect action. A direct action is directly associated with a location on the given bit-map, while an indirect action is associated with a pixel region other than the given bit-map.

Direct actions allow the user to interact with the bit-map itself. For example, a typical paint program allows the user to “draw” on a bit-map and directly change the bit-map pixel values of the associated pixels. The bit-map can include rasterized representations of visual controls (or widgets) directly embedded into the given bit-map. In this case, direct actions can be associated with the embedded visual controls (or widgets). A hyperlink can be considered a special type of visual control, typically with a visual appearance of rasterized text or a bit-map image.

The software processing the direct action can provide visual feedback, either within or outside the given bit-map. For example, a cursor can be painted “over” the bit-map at the current location, or selected bit-map pixel intensities and/or colors can be changed to highlight the current location on the bit-map, or an (X,Y) location can be displayed either over or outside the bit-map.

Indirect actions are associated with a pixel location other than the bit-map itself. This includes interactions with areas of the client display not allocated for the bit-map (including window borders or other “decorations” around the given bit-map area), or interactions with pixel regions that may occlude some portion(s) of the bit-map but are not directly embedded within the bit-map. For example, menus, scroll bars, visual controls (or widgets) not embedded within the bit-map, tool palettes and pop-up dialog boxes are all commonly used to implement indirect actions.

The software processing indirect actions can provide visual feedback, such as displaying a cursor, highlighting a menu item, or visually simulating a user interface action on a visual control. Visual feedback for indirect actions can also include changes to the given bit-map.

Bit-Map Pixel Representations

Generally, bit-maps are displayed according to a single representation. While the bit-map might be scaled and/or clipped for display purposes, the underlying representation remains the same. The scaled and/or clipped versions are not maintained as a set, there are no data structures to maintain correspondences between and among the versions, and there are no user interface gestures to select and display a particular version within the set. Any scaling and/or clipping functions for display purposes are done dynamically and the intermediate results are usually not saved for future use.

When manipulating the scaling and/or clipping of a single bit-map pixel representations, the gestures are typically based on indirect actions rather than direct actions. These indirect actions include menu selections, pop-up dialog boxes with visual controls that select the desired level, scroll bars, or separate visual controls displayed within or outside the bit-map's window border.

Clipping is often done through indirect user actions on horizontal or vertical scroll bars, placed as user interface “decorations” around the bit-map's display area. Some user interfaces provide clipping through gestures to directly “drag” a bit-map around within a given display area (or window). Scaling is typically done by indirect actions to adjust a scaling factor as a percentage of the bit-map's pixel resolution. Sometimes visual controls are placed below the bit-map's display area which support indirect actions to toggle “zoom in” or “zoom out” functions.

Dynamic “zoom in” or “zoom out” over a selected portion of a bit-map has been provided by gestures that combine an indirect action to select a “magnifying glass” tool and a direct action of moving the tool over the bit-map. The “zoom factor” is often adjusted through the +/−key presses. Note that “zoom in” and “zoom out” are typically implemented through pixel replication or decimation on a per-pixel basis, rather than a filtered scaling that computes each resulting pixel from a surrounding neighborhood of source pixels.

Icons

Icons (also called “thumbnails”) are commonly used to represent a software function and/or an element of visual content (such as a document). An icon can be generated as a scaled version of a rendered representation of the associated visual content element. A double-click is a commonly used as a direct action gesture on the icon, to launch software associated with the icon and view the associated visual content element (if any).

The generation of an icon from a rendered visual content element is typically done as a software service, with little or no user control over scaling and/or clipping functions. In some systems, the user can choose which page of a multi-page document to represent in the icon. User control over scaling, if available, is typically limited to choosing from a limited set of available icon pixel resolutions.

There is typically no direct action gesture to access the associated icon from the rendered visual content element. Often there is no user interface mechanism whatsoever to access the icon from a display of the rendered visual content element. When available, this access is typically done through one or more indirect actions, such as a menu pick or selecting a visual control displayed within an associated window border.

An icon/document pair is not a multi-level set of bit-map pixel representations, as defined herein. The icon/document pair is not maintained as a set. Once the icon is generated, it is typically maintained and stored separately from the associated visual content element. The icon will contain data to identify the associated visual content element, but the associated visual content element will not contain data to identify any or all associated icons. Often the icon is maintained as an independent visual content element, and multiple independent icons can be generated from a single associated visual content element.

Location correspondence information is not maintained within an icon/document pair. When a specific pixel location is selected within an icon, there is no information maintained to determine the corresponding pixel location(s) within the rendered visual content element. Since there is no information, there are also no gestures within the prior art to make such a location-specific selection.

Location correspondence information is not maintained from the rendered visual content element to the corresponding pixel location(s) on the icon, and there are no location-specific gestures from the rendered visual content element to pixel location(s) on a corresponding icon.

Background Summary

Bit-maps often have a pixel resolution greater than the pixel resolution of the allocated display area. Therefore, improved gestures to support scaling and/or clipping are highly desirable. There is a need for improved gestures that emphasize direct actions, require less user movement and/or effort, and are based on a more intuitive model that connects the gestures to corresponding software processing functions. This is particularly true for new classes of intelligent devices with limited screen display areas, such as personal digital assistant (PDA) devices and cellular telephones with bit-map displays.

Furthermore, the processing power to support scaling (particularly high-quality filtered scaling) can be greater than certain client devices can provide while still maintaining rapid responsiveness to user actions. Therefore, there is a need to provided pre-scaled representations that are stored as a set. Finally, there is a need for improved gestures that allow the user to work directly with a multi-level or multi-modal set of bit-maps, and easily move among and between the different representation levels or modes, taking advantage of the correspondences (such as pixel location correspondences) between levels or modes.

### SUMMARY OF THE INVENTION

Overview of the Invention

The client displays one or more levels of the multi-level or multi-modal set of bit-map pixel representations on its bit-map display device. The multi-level set can be derived from any input bit-map pixel representation, including but not limited to images, rendered representations of visual content, and/or frame-buffers. The multi-modal set can be derived from different renderings of the same visual content element. One or more of these renderings can be transformed into multi-level set. Consequently, a multi-level set can be a member of a multi-modal set. The client then interprets certain user interface actions as gestures that control the navigation through and/or interaction with the multi-level or multi-modal set.

Client Device

A client device provides a user interface to a multi-level or multi-modal set of bit-map pixel representations. The client device can be a personal computer, hand-held device such as a PalmPilot or other personal digital assistant (PDA) device, cellular telephone with a bit-map display, or any other device or system with a processor, memory and bit-map display.

Displaying a Bit-Map Pixel Representation

A client device with a bit-map display device is capable of displaying one or more bit-map pixel representations. A bit-map pixel representation (or “bit-map”) is an array of pixel values. A bit-map can represent any or all of the following:

a) one or more image(s),

b) rendered visual content, and/or

c) a frame-buffer captured from:

i) the output of an application, application service or system service,

ii) a “window”, using a windowing sub-system or display manager,

iii) some portion (or all) of a computer “desktop”

An image is a bit-map data structure with a visual interpretation. An image is one type of visual content. Visual content is data and/or object(s) that can be rendered into one or more bit-map pixel representation(s). A frame-buffer is the bit-map output from one or more software function(s). A frame-buffer has a data structure specifically adapted for display on a bit-map display device. Visual content can be rendered into one or more image(s) or frame-buffer(s). Frame-buffers can be stored as images.

The terms “render” and “rendering” are used herein to mean the creation of a raster (bit-map pixel) representation from a source visual content element. If the source visual content element is already in a raster form, the rendering function can be the identity function (a 1:1 mapping) or include one or more pixel transform function(s) applied to the source raster. “Render” and “rendering” are used herein interchangeably with the terms “rasterize”, “rasterizing”, respectively.

The term “transcoding” is used herein to mean the source transformation of a source visual content element into a derived visual content element. The output of a transcoding function is a representation in a source format. A source format is an encoding of visual content other than a bit-map, although it may include an encapsulation of a bit-map or a reference to a bit-map. HTML (hypertext markup language) is an example of a source format. A source format requires a rasterizing (or rendering step) to be displayed as a fully rasterized (bit-map) representation.

Examples of visual content include electronic documents (such as word-processing documents), spreadsheets, Web pages, electronic forms, electronic mail (“e-mail”), database queries and results, drawings, presentations, images and sequences of images.

Each element of visual content (“visual content element”) can have one or more constituent components, with each component having its own format and visual interpretation. For example, a Web page is often built from multiple components that are referenced in its HTML, XML or similar coding. Another example is a compound document with formatted text, an embedded spreadsheet and embedded images and graphics.

The constituent component(s) of a visual content element can be retrieved from a file system or database, or dynamically generated (computed as needed). When using object-oriented technologies to define object components and their behaviors, a constituent component can be (but is not required to be) an object. The data (and/or methods) for the constituent component(s) can be stored locally on one computer system or accessed from any number of other computer or file systems.

Rasterizing (or rendering) is a function for converting a visual content element from the data (and/or object) format(s) of its constituent component(s) into a bit-map pixel representation.

The display of rasterized visual content can be presented on an entire display screen, or within a “window” or “icon” that uses a sub-region of the display screen. Computer “desktops” are visual metaphors for accessing and controlling the computer system, typically using windows and icons to display rendered representations of multiple visual content elements.

Any bit-map generated for output to a display screen can be captured as a frame-buffer. A frame-buffer can represent any portion of rasterized visual content (including rendered images), or any portion of a window or computer desktop. A frame-buffer is a bit-map intended for display on a bit-map display device. When a frame-buffer is captured, it can be saved as an image or some other type of visual content element. A remote frame-buffer system transmits a frame-buffer from one computer system to another, for eventual display on a remote system's bit-map display device.

Gestures

A gesture is a semantic interpretation of one or more user interface actions. A gesture has an implied semantic meaning, which can be interpreted by the software receiving user input. The software determines how to interpret the user interface action(s) into associated gesture(s).

The interpretations can differ based on modifiers. A modifier can be set within a specific user interface action, by a previous user interface action, or by software. For example, a simultaneous button press can be used to modify the meaning of a movement or selection over some portion of the bit-map. The level of pressure on a pressure-sensitive surface can also be used as a modifier. The interpretation of a modifier can be set by user preference, typically through previous user interface action(s), or set by software.

When the gesture involves more than one user interface action, the sequencing of the actions can carry semantic information. This allows two or more actions in different sequences to be interpreted as different gestures. For example, a movement followed by a selection might be interpreted as different gesture from a selection followed by a movement.

When a gesture is composed of multiple actions, direct actions can be combined with indirect actions. For example, an indirect selection within an external menu, dialog box or visual control can be combined with a direct movement or selection on the bit-map.

While gestures are commonly used to express semantic intent within user interfaces, they can vary widely in their ease of expression and applicability. Gestures to express similar semantic intents can vary in the number and sequence of actions of actions required for a gesture, and the amount of effort and/or movement required on the part of the user. For example, a sequence of direct actions typically takes less movement and effort than a combination of direct and indirect actions.

Gestures can also vary in their appropriateness to the semantic intent being expressed. The appropriateness of a gesture depends on a shared mental model, between the user and the software designer, of the gesture and its meaning. Within a set of gestures, each new gesture is appropriate if it fits within the shared model or readily extends the model. When the shared mental model is easily understood, and the set of gestures readily fits within (and/or extends) this model, then the user interface is generally considered more “intuitive”.

For example, a gesture that traces a check mark to signify “OK” and a gesture that traces an “X” to signify “NO” are based on familiar paper-and-pencil symbols. But reversing the meanings of these gestures would be very confusing (counter-intuitive) to most users. Another example is the use of platform-specific “style guide” conventions which define certain gestures and their meanings on a class of client devices. Sometimes it is appropriate to follow these conventions, other times not. Following a style guide makes the gestures more compatible with other user interfaces on the same platform, but breaking the style guide can often create a more intuitive user interface within a given application domain.

### Multi-Level Set of Bit-Map Pixel Representations

Multi-level sets of bit-map pixel representations have been used primarily within the technical domain of image processing, and not for more general-purpose display of visual content (such as Web pages, word processing documents, spreadsheets or presentation graphics).

In a multi-level set, each version within the set is related to an input bit-map pixel representation, and represents a scaled (possibly 1:1) version of some portion of the input bit-map pixel representation. In a multi-level set:

a) the scaled and/or clipped versions are maintained as a set,

b) there are data structures to maintain correspondences between and among the versions, and

c) the correspondence data structures support mapping from pixel location(s) in one version to the corresponding pixel location(s) in at least one other version within the set.

Novel techniques for using a multi-level or multi-modal set of bit-map pixel representations are described in the co-pending Provisional patent application “Content Browsing Using Rasterized Representations”, Provisional application Ser. No. 60/223,251, filed Aug. 7, 2000, and the related non-Provisional application filed on even date herewith (attorney docket no ZFR-001), entitled “Visual Content Browsing Using Rasterized Representations”, and Provisional application Ser. No. 60/229,641, filed Aug. 31, 2000, all of which are incorporated herein by reference.

User interfaces for manipulating a multi-level set of bit-map representations have favored indirect actions over direct actions. Often, there are no specific user interface gestures that reflect the relationships between members of a set. For example, there are typically no specific gestures for switching between representation levels within a given set. Instead, each member of the set is treated as a separate bit-map and the indirect gestures for displaying each level are the same as for selecting any bit-map (within or outside a given set). These indirect gestures are typically provided through menu selections or external visual controls (e.g. tool bars) coupled with pop-up dialog boxes to select the bit-map to display.

Methods are disclosed for a gesture-based user interface to multi-level and multi-modal sets of bit-map pixel representations.

A client device provides a user interface to a multi-level or multi-modal set of bit-map pixel representations. In a multi-level set, an input bit-map pixel representation is transformed through one or more pixel transform operation(s) into a set of at least two derived bit-map pixel representations. Each level represents a scaled (possibly 1:1) view of the input bit-map pixel representation.

The representation levels in a multi-level set are ordered by the relative resolution of the derived bit-map pixel representation in comparison to the equivalent region of the input bit-map. The ordering is from lowest relative pixel resolution to highest. Applying different scaling factors (including 1:1) during the pixel transformation operation(s) creates the different relative pixel resolution levels.

In a multi-modal set, multiple rendering modes generate multiple bit-map representations of a source visual content element. The resulting bit-map representations are associated into a multi-modal set. A multi-modal set can include one or more multi-level representations.

The representations in a multi-modal set are grouped by rasterizing mode. For any given rasterizing mode, there can be multi-level representations that are internally ordered by relative pixel resolution. There can also be partial representations within a multi-modal or multi-level set, representing a partial subset of the source visual content element or original input bit-map .

The user interface gestures allow the user to control various aspects of navigating and/or browsing through the multi-level or multi-modal set of bit-maps. This includes gestures to control the process of:

a) panning across one or more bit-map(s) in the multi-level or multi-modal set,

b) scrolling across one or more bit-map(s) in the multi-level or multi-modal set,

c) moving to a location on one or more bit-map(s) in the multi-level or multi-modal set,

d) selecting a location on one or more bit-map(s) in the multi-level or multi-modal set,

e) selecting or switching from one representation level to another within the multi-level or multi-modal set of bit-maps, and/or

f) changing the input mode associated with one or more bit-map(s) in the multi-level or multi-modal set

Applications of the present invention for multi-level or multi-modal representations of various types of visual content including Web pages, e-mail attachments, electronic documents (including word processing documents and spreadsheets), electronic forms, database queries and results, drawings, presentations, images and sequences of images are presented. Applications for multi-level representations of frame buffers captured from user interfaces, windowing systems, and/or computer “desktops” are also presented.

The applications can be provided on a variety of devices including personal computers (PCs), handheld devices such as personal digital assistants (PDAs) like the PalmPilot, or cellular telephones with bit-map displays. A variety of user interface styles, including mouse/keyboard and pen-based user interface styles, can be supported. The present invention has particular advantages in pen-based handheld devices (including PDAs and cellular telephones with bit-map displays).

The present invention provides new methods to work more effectively and/or more conveniently with a multi-level or multi-modal set of bit map pixel representations. The user is no longer constrained to working with a single level or mode at a time. Neither is the user limited to prior methods for working with a multi-level or multi-modal set of bit-maps, where the gestures of the present invention are not available within the user interface.

Client Display Surfaces

The client's bit-map display allows the client to provide visual output, represented as two-dimensional bit-maps of pixel values. The client's bit-map display device is typically refreshed from its bit-map display memory. The pixel values stored within the display memory are logically arranged as a two-dimensional array of pixels, which are displayed on the bit-map display device. Client software can write directly into the bit-map display memory, or work cooperatively with a window subsystem (or display manager) that mediates how the bit-map display memory is allocated and used.

A display surface is an abstraction of a two-dimensional array of bit-map pixels. The client application, application service or system service writes its output pixel values into one or more client display surfaces.

The client displays the multi-level or multi-modal set of bit-maps using one or more client display surface(s). The client display function maps pixels from one or more representation level(s) or rasterized mode(s) into an allocated client display surface. The client display surface is then viewed on the client's bit-map display device, as further described below in the section “Client Viewports”. The mapping to the display surface can include optional clipping and/or scaling. Clipping selects certain pixel region(s) of the representation level(s) or rasterized mode(s). Scaling transforms the selected pixels to a scaled bit-map pixel representation.

The client display function controls how the client display surface is generated. Along with the pixels mapped from the multi-level or multi-modal set of bit-maps, the client display function can add additional pixels to a client display surface. These additional pixels can represent window borders, rendered (and rasterized) visual controls, or other bit-maps being displayed within a given client display surface. These additional pixels can be adjacent to the pixels mapped from the multi-level or multi-modal set and/or generated as one or more overlay(s) over the pixels mapped from the multi-level or multi-modal set.

When a pixel location is given in terms of a client display surface, the client maps this back to the associated pixel(s) of a representation from the multi-level or multi-modal set being displayed. The client is responsible for maintaining this mapping, which is the inverse of the mapping used to generate the client display surface. If the pixel on the client display surface is not related to a bit-map pixel representation of the multi-level or multi-modal set (e.g. it represents a window border or additional visual control), then the mapping is null.

A single client display surface can include pixels mapped from multiple representation levels of a multi-level set. However, in an illustrative embodiment, each client display surface includes pixels mapped from only one representation of a multi-level or multi-modal set (along with any other additional pixels generated by the client display function). This makes it easier for the user to mentally associate a given client display surface with a single representation of a multi-level or multi-modal set.

Display Surface Attributes

The primary attributes of a display surface are its pixel resolution, pixel aspect ratio and pixel format. Pixel resolution can be expressed as the number of pixels in the horizontal and vertical dimensions. For example, a 640×480 bit-map is a rectangular bit-map with 640 pixels in the horizontal dimension and 480 pixels in the vertical dimension.

The pixel aspect ratio determines the relative density of pixels as drawn on the display surface in both the horizontal and vertical dimensions. Pixel aspect ratio is typically expressed as a ratio of horizontal density to vertical density. For example a 640×480 bit-map drawn with a 4:3 pixel aspect ratio will appear to be a square on the drawing surface, while the same bit-map drawn with a 1:1 pixel aspect ratio will appear to be a rectangle with a width to height ratio of 640:480 (or 4:3).

Pixel aspect ratio can also be expressed as the “dots per inch” (or similar measure) in both the horizontal and vertical dimensions. This provides the physical dimensions of a pixel on the display surface, while the ratio only describes the relative dimensions. Some rendering algorithms take into account the physical dimensions and pixel density of the display surface, others use the aspect ratio (with or without the physical dimensions), and still others render the same results regardless of the aspect ratio or physical dimensions.

Pixel format describes how each pixel is represented in the bit-map representation. This includes the number of bits per pixel, the tonal range represented by each pixel (bi-tonal, grayscale, or color), and the mapping of each pixel value into a bi-tonal, grayscale or color value. A typical bit-map pixel representation uses the same pixel format for each pixel in the bit-map, although it is possible to define a bit-map where the pixel format differs between individual pixels. The number of bits per pixel defines the maximum number of possible values for that pixel. For example, a 1-bit pixel can only express two values (0 or 1), a 2-bit pixel can express four different values, and so on.

The tonal range determines if the pixel values should be interpreted as bi-tonal values, grayscale values or color values. Bi-tonal has only two possible values, usually black or white. A grayscale tonal range typically defines black, white, and values of gray between. For example, a 2-bit grayscale pixel might define values for black, dark gray, light gray and white. A color tonal range can represent arbitrary colors within a defined color space. Some pixel formats define a direct mapping from the pixel value into a color value. For example, a 24-bit RGB color pixel may have three 8-bit components, each defining a red, green, and blue value. Other pixel formats define a color map, which uses the pixel value as an index into a table of color values.

The pixel format can also define other per-pixel data, such as an alpha value. The alpha value provides the “transparency” of the pixel, for combining this pixel value with another related pixel value. If the rendering function combines multiple bit-map pixel representations into a single bit-map pixel representation, the alpha values of each pixel can be used to determine the per-pixel blending. In rendering of three-dimensional data into a bit-map pixel representation, the pixel format may define a depth value per pixel. When other per-pixel data is required, this can also be defined in the pixel format.

Client Viewports

A display surface can be allocated directly within the bit-map display memory, or allocated outside the bit-map display memory and mapped into a client viewport.

A client viewport is an allocated pixel region within the bit-map display memory. A client viewport can be the entire display region, or a subset. Client viewports are a convenient way for a window subsystem (or display manager) to mediate how different software applications, application services and/or system services share the bit-map display device. The window subsystem (or display manager) can determine which client viewport(s) are visible, how each is mapped to the actual bit-map display device, and manage any overlapping between viewports.

Each display surface is painted into one or more client viewport(s). The painting function selects which portion(s) of the client display surface should be realized within each client viewport. The painting function provides a level of indirection between a client display surface and a client viewport, which is the basis for most windowing or display management schemes.

If the client display surface is allocated directly within the display memory, then the client display surface and the client viewport share the same data structure(s). In this case, the painting process is implicitly performed while writing the output pixels to the display surface.

The painting function (see FIG. 1) maps the display surface to the bit-map display device. In the simplest case, this is a direct 1:1 mapping. The mapping function can include these optional steps:

clipping the display surface to the assigned output area on the actual bit-map display device, and/or

a) performing simple pixel replication (“zoom”) or pixel decimation (“shrink”) operations,

b) translating the pixel format to the native pixel format of the bit-map display device, and/or

c) transfer of the pixels to the client viewport(s) allocated for viewing the display surface

The optional clipping function (1-2) selects one or more sub-region(s) (1-3) of the rendered display surface that correspond(s) to the “client viewport” (1-7): the assigned output area on the actual bit-map display device. Clipping is used when the pixel resolution of the rendered display surface is greater than the available pixels in the client viewport. Clipping is also used to manage overlapping windows in a windowing display environment.

Clipping is simply a selection function. Clipping does not resize the display surface (or any sub-region of the display surface), nor does it re-compute any pixels in the display surface. Resizing (other than shrink or zoom) or re-computing are considered bit-map conversion operations, and are therefore part of a rendering or pixel transform function and not the painting function.

Optional pixel zoom or shrink are simple pixel replication or pixel decimation operations (1-4), performed on one or more selected sub-region(s) of the clipped display surface. Zoom and shrink are done independently on each selected pixel. They do not require averaging among pixels or re-computing any pixels in the display surface, which are bit-map conversion operations that are not part of the painting function. In FIG. 1, there is no pixel zoom or shrink performed, so the clipped sub-region after pixel replication or decimation (1-5) is the same as the input clipped sub-region (1-3).

Optional pixel format translation (1-6) is a 1:1 mapping between the pixel format of each pixel in the display surface and the pixel format used by the actual bit-map display device. Pixel format translation is often done through a look-up table. Pixel format translation does not re-compute the pixel values of the display surface, although it may effectively re-map its tonal range. Any translation operation more complex than a simple 1:1 mapping of pixel formats should be considered a bit-map conversion operation, which is not part of the painting function.

The final optional step in the painting function is the pixel transfer (1-8) to the client viewport (1-9): the allocated pixel region within the display memory for the bit-map display device. If the display surface was directly allocated within that display memory, this step is not required. Pixel transfer is typically done through one or more bit block transfer (“bit blt”) operation(s).

Note that the ordering of the optional steps in the painting function can be different than that presented in FIG. 1 and the above description. For example, the optional pixel translation might be done before optional clipping. Also note that a display surface can be painted into multiple client viewport(s), each with its own clipping, pixel format translation and/or pixel transfer parameters.

User Interface Actions and Events

User interface actions are typically reported to the client as “events”. A user interface event is a software abstraction that represents the corresponding user interface action. An event informs the client that the action has occurred. The client can respond to the event, or ignore it. User interface events typically provide (or provide access to) event-related information. This can include information about the event source, along with any event-related information such as the pixel location associated with the event.

Along with user interface events, the client can process other types of events. For example, timer events can signal that a specified time interval has completed. Other software running on the client device, or communicating with the client device, can generate events. Events can be triggered by other events, or aggregated into semantically “higher-level” events. For example, a “mouse click” event is typically aggregated from two lower-level events: a mouse button press and mouse button release.

The client software will typically have one or more “event loops”. An event loop is a set of software instructions that waits for events (or regularly tests for events), and then dispatches to “event handlers” for processing selected types of events. Events and event loops will be used as the framework for discussing the processing of user interface actions. However, any software mechanism that is capable of reporting user interface actions and responding to these actions can be used as an alternative to event-based processing.

There are two primary types of user interface events:

a) location events: events which define the location of a pointing device on a client display surface

b) selection events: events which define a selection action associated with a client display surface

In a location event, the pointing device is typically a mouse, pen, touch-pad or similar locating device. The location is typically an (X,Y) pixel location on the client display surface. This may be captured initially as an (X,Y) pixel location on the client viewport on the client's bit-map display device, which is then mapped to the to an (X,Y) pixel location on the associated client display surface. If the location on the client display surface is currently not being displayed within the client viewport, the client device may pan, scroll, tile or otherwise move the client viewport to include the selected location.

The client device may also define other user interface actions that generate location events. For example, moving a scroll bar outside the client viewport might generate a location event on the client display surface. Another example might be a client timer event that automatically generates a location event.

In a selection event, a selection action is associated with the client display surface. While many selection actions also have an explicit or implicit (X,Y) pixel location on the client display surface, this is not required of all selection events. If there is an (X,Y) pixel location, this may also have been initially an (X,Y) location on the client viewport which is mapped to the client display surface. Selection events are typically generated by user interface actions where the user has made a choice to start, continue or end a selection action. Examples include mouse-button state changes (mouse-button up/mouse-button down, or combined mouse click), pen state changes (pen up/pen down, or combined pen “tap”), or key state changes (key up/key down, or combined key press).

Movements of a pointing device can be reported as selection events, if there is an appropriate selection modifier during the movement. For example, a mouse move with a simultaneous mouse-button press can be reported as a selection event. Similarly, a pen movement with the pen down (e.g. applying pressure to a pressure-sensitive surface) can be reported as a selection event. These selection events have an associated pointing device location. Each client implementation determines which selection modifiers are associated with selection events, and how to report the selection modifiers as data elements within an event data structure.

The client device may also define other user interface actions that generate selection events. For example, clicking within a certain sub-region of a separate client viewport might generate a selection event on a client display surface. Another example might be a client timer event that automatically generates a selection event.

Multi-Level Set of Bit-Map Pixel Representations

A input bit-map pixel representation is transformed through one or more pixel transform operation(s) into a multi-level set of at least two derived bit-map pixel representations. Each representation level represents a scaled (possibly 1:1) view of the input bit-map pixel representation. Methods for generating a multi-level set of bit-map pixel representations are further described in the co-pending patent application “Visual Content Browsing Using Rasterized Representations” (Attorney Docket No. ZFR-001), filed Nov. 29, 2000, incorporated herein by reference.

The representation levels are ordered by the relative resolution of the derived bit-map pixel representation in comparison to the equivalent region of the input bit-map. The ordering is from lowest relative pixel resolution to highest. Applying different scaling factors (including 1:1) during the pixel transformation operation(s) creates the different relative pixel resolution levels.

Each representation level provides a scaled (possibly 1:1) view of at least one common selected region of the input bit-map pixel representation. The common selected region can be the entire input bit-map pixel representation, or one or more sub-region(s) of the input bit-map. The scaling factor applied to the common selected region is the one used to order the levels by relative pixel resolution. In an illustrative embodiment, each level has a different scaling factor, and therefore a different relative pixel resolution.

Also in an illustrative embodiment, a scaling factor is consistently applied within a given level of a multi-level set. All views of the input bit-map within a given level, whether within or outside the common selected region, use the same scaling factor. This makes it easier for the user to perceive the intended proportions and overall layout of the input bit-map, as displayed within a given level.

In an illustrative embodiment, the view of the common selected region is at least ½ of each representation level in both the vertical and horizontal pixel dimensions. This degree of commonality allows the user to more easily maintain a mental image of the relationships between the different levels of the multi-level set. If the representation level is a partial representation (a pixel sub-region of an equivalent full representation), then this commonality requirement is instead applied to the equivalent full representation.

The multi-level set consists of at least two bit-map pixel representations derived from the input bit-map pixel representation. One of these derived representations can be the input bit-map, or a copy of the input bit-map.

The representation levels are:

1) an overview representation: providing a reduced scaled view of the common selected region at a pixel resolution that provides at least an iconic view (at least 10×10 pixels) of the common selected region, but at no more than one-half the pixel resolution of the common selected region in at least one dimension (the overview representation is between 96×96 and 320×320 pixels in an illustrative embodiment),

2) an optional intermediate representation: providing a scaled (possibly 1:1) view of the common selected region at a pixel resolution suitable for viewing and/or navigating the major viewable elements of the common selected region, and of a higher pixel resolution in at least one dimension from the view of the common selected region in the overview representation,

3) a detail representation: providing a scaled (possibly 1:1) view of the common selected region at a pixel resolution that presents most of the viewable features and elements of the common selected region, at a higher resolution in at least one dimension from the overview representation and (if an intermediate representation is present) at a higher resolution in at least one dimension from the view of the common selected region in the intermediate representation (between 640×480 and 1620×1280 pixels in an illustrative embodiment)

While the intermediate representation is entirely optional, it is also possible within the present invention to have multiple levels of intermediate representation. Each of these optional levels presents a scaled (possibly 1:1) view of the common selected region at a pixel resolution that is higher in at least one dimension from the preceding intermediate representation.

If there are multiple intermediate representation levels, the lowest level of intermediate representation has a view of the common selected region at a higher pixel resolution (in at least one dimension) from the view of the common selected region in the overview representation. Also, the highest level of intermediate representation has a view of the common selected region at a lower pixel resolution (in at least one dimension) from the view of the common selected region in the detail representation.

A derived representation can be based on a clipped version of the input bit-map pixel representation. Clipping can be used to remove:

a) unneeded region(s) of the input bit-map pixel representation (such as “white space”),

b) unwanted region(s) (such as advertising banners), and/or

c) region(s) that are considered less important (such as the lower or lower right portion of a Web page)

Different levels of the multi-level set can apply different clipping algorithms, provided that at least a portion of a common selected region is included in all representation levels. In an illustrative embodiment, a clipped region used for the overview representation is the same as, or a proper subset of, the corresponding region used for the detail representation. Also in an illustrative embodiment, a similar rule is applied between the overview representation and any optional intermediate representation(s), and between any optional intermediate representation(s) and the detail representations. This reduces the complexity of mapping (mentally or computationally) between representation levels. When a given level is a partial representation, this clipping rule is applied to the equivalent full representation.

The derived representations can differ in their pixel aspect ratios, tonal ranges, and/or pixel formats. For example, the overview representation might have a pixel aspect ratio matched to the client viewport while the detail representation has a pixel aspect ratio closer to the original input bit-map. In an illustrative embodiment, any and all pixel scaling operations applied at any given level use the same scaling factor.

FIG. 2 shows an example of an input bit-map pixel representation (2-1) for a Web page and a set of derived representations: a sample overview representation (2-2), a sample intermediate representation (2-3), and a sample detail representation (2-4). FIG. 3 is an example of a rendered spreadsheet, with an input bit-map pixel representation (3-1), a sample overview representation (3-2) and a sample detail representation (3-3).

FIG. 4 shows an example of displaying two levels of transformed representations on a client device. These are taken from a PalmPilot emulator that runs on a personal computer, which emulates how the representations would appear on an actual PalmPilot device. FIG. 4 shows a sample overview representation (4-1) and a clipped region of a sample detail representation (4-2), as displayed within an allocated client viewport.

If a representation does not fit within the client viewport of the client device's display, the client paints a sub-region of the associated client display surface through a clipping operation. In this case, the client display surface can be treated as a set of tiled images. The tiles are constructed such that each tile fits into the client viewport of the display device, and the client device switches between tiles or scrolls across adjacent tiles based on user input.

In an illustrative embodiment, the overview representation should be displayable in its entirety within an allocated client viewport of 140×140 pixels or greater (and thus is a single tile). Also in an illustrative embodiment, an optional lowest level intermediate representation should have no more than four tiles in each dimension within an allocated client viewport of 140×140 pixels or greater.

Multi-Modal Set of Bit-Map Pixel Representations

A source visual content element is rasterized into two or more bit-map representations through at least two different rasterizing modes. One rasterizing mode can differ from another through any or all of the following:

1. differences in the parameter(s) to the rasterizing (or rendering) function,

2. differences in rasterizing (or rendering) algorithms,

3. insertion of one or more transcoding step(s) before the rasterizing (or rendering function),

4. differences in the parameter(s) used in a transcoding step, and/or

5. differences in transcoding algorithm(s) used in a transcoding step.

For example, the expected or preferred horizontal dimension of the client viewport can be a parameter to a rasterizing function. One rasterizing mode can generate a display surface optimized for a display viewport with 1024 pixels in the horizontal dimension, while another rasterizing mode generates a display surface that is optimized for a display viewport with 160 pixels in the horizontal dimension. Another example is a parameter that controls the point size of a text component. The text component can be rasterized in one mode with 10 point Times Roman type, and in another mode with 12 point Arial type.

Different rasterizing (or rendering) algorithms can produce different bit-map pixel representations, often with different layouts. For example, one rendering mode can use a rasterizing algorithm that intermixes the layout of text and non-text components (such as images or tables), like a typical layout of a Web page on a PC. Another mode can use a rasterizing algorithm where each text component is visually separated in the layout from non-text components (such as images or tables).

Two different rendering algorithms can generate different representations of the same visual component. For example, one can be capable of generating a fully graphical representation of an HTML table while the other renders a simplified text-oriented representation of the same table. Some rendering algorithms are not capable of rasterizing certain types of visual components, and will either not include them in the rasterized representation or include some type of substitute place-holder representation. These algorithms produce a different rasterized representation from an algorithm that can fully render the same visual components.

Transcoding is a function that converts a visual content element from one source format to another, before a rasterizing (or rendering) function is performed. The transcoding function can include filtering or extractive steps, where certain types of encoded content are converted, transformed or removed from the derived source representation. Transcoding can also perform a complete translation from one source encoding format to another. Transcoding can be loss-less (all of the visually significant encoding and data are preserved) or lossy (some portions are not preserved).

For example, an HTML document can be rendered by an HTML rendering function in one rasterizing mode. This HTML source can also be transcoded to a WML (Wireless Markup Language) format and then rasterized by a WML rendering function in a second rasterizing mode. The two different representations can be associated as a multi-modal set, based on their relationship to the original HTML-encoded visual content element.

Transcoding can also be used to generate a different version of the source visual content element using the same encoding format as the original. For example, an HTML document can be transcoded into another HTML document, while changing, translating or removing certain encoded data. For example, references to unwanted or objectionable content can be removed, automatic language translation can be applied to text components, or layout directives can be removed or changed to other layout directives.

FIG. 17 illustrates an example of a multi-modal set of bit-map pixel representations. In this example, the source visual content element (17-1) is:

a) rasterized (17-2) to a multi-level set (17-3),

b) transcoded (17-4) to a derived source format (17-5) which is then rasterized (17-6) to a bit-map representation (17-7), and

c) rasterized (17-8) using a different rasterizing algorithm to produce an alternative bit-map representation (17-9).

Correspondence Maps for Multi-Level and Multi-Modal Sets

In a multi-level or multi-modal set, a correspondence map can be created to map between corresponding parts of the different representations. This correspondence map assists in providing functions that require mappings between representations, such as supporting a user interface that selects or switches between the different representations. For example, the correspondence map can allow the user to select a pixel region on one rendered representation and then view the corresponding region rendered from a different representation. A reverse mapping (from the second representation to the first) can also be generated.

There are four types of possible correspondence maps, based on the type of each representation being mapped. A representation can be a “source” or a “raster”. A source representation encodes the visual content in a form suitable for eventual rasterizing (or rendering). An HTML document, or Microsoft Word document, is an example of a source representation. A transcoding operation takes a source representation as input and generates a transcoded source representation as output.

A “raster” representation is a bit-map pixel representation of rasterized (or rendered) visual content. A raster can be the bit-map pixel output of a rasterizing (or rendering) process, but it can be any bit-map pixel representation (such as an image or frame buffer).

The four types of correspondence maps are:

a) Source-to-source: This maps the correspondences from one source to another related source. These correspondences can be positional (corresponding relative positions within the two sources) and/or structural (corresponding structural elements within the two sources). Source-to-source maps are typically used to map between a transcoded visual content element and its original source.

b) Source-to-raster: This maps the correspondences from a source element to a rendered representation of that source. Each entry in the map provides a positional and/or structural reference to the source representation, along with a corresponding pixel region within the raster representation. A source-to-raster correspondence map can be generated as a by-product of a rendering function. Some rendering functions provide programmatic interfaces that provide source-to-raster or raster-to-source mappings.

c) Raster-to-source: This is the inverse of a source-to-raster mapping.

d) Raster-to-raster: This is a mapping between corresponding pixel regions within two related raster representations. If the corresponding pixel regions are related through one or more transform operations (such as scaling), then these transform operations can be referenced within the correspondence map.

A correspondence map allows correspondences to be made between related areas of different (but related) representations. Correspondence maps support functions such as switching or selecting between related representations, based on a “region of interest” selected within one representation. Correspondence maps are also used to process user input gestures, when a pixel location on one raster representation must be related to a different (but related) raster or source representation.

Some source formats define a formal data representation of their contents, including layout directives encoded within the contents. Source-to-source, source-to-raster or raster-to source correspondence maps can be statically or dynamically derived through appropriate software interfaces to such a data representation.

For example, the HTML specification defines a Document Object Model (DOM). Both Microsoft's Internet Explorer and Netscape's Navigator software products support their own variants of a DOM and provide software interfaces to the DOM. Internet Explorer also provides interfaces to directly map between a rendered (rasterized) representation of a visual content element and the DOM. These types of interfaces can be used instead of, or in addition to, techniques that map raster-to-source (or source-to-raster) correspondences through software interfaces that simulate user interface actions on a rasterized (or rendered) proxy display surface.

FIG. 18 illustrates examples of correspondence mapping. An entry in a raster-to-raster map is shown as 18-1, between on overview representation and detail representation of a multi-level set. An entry in a raster-to-source map (18-2) maps the detail representation to the corresponding segment of the source visual content element. This, in turn, is mapped by an entry in a source-to-raster map (18-3) to a text-related rendering of the visual content element.

It is possible to “chain” related correspondence maps. For example, consider a source visual content element that is rendered first to one raster representation and then transcoded to a second source representation. When the transcoded source representation is rendered, the rendering process can generate its own correspondence map. In this example, chaining can be used to determine correspondences (if any) between the first raster representation and the second (transcoded) raster representation. The second raster-to-source map can be chained to the transcoded source-to-source map, which in turn can be chained to the first source-to-raster map.

Correspondence maps have an implicit “resolution”, related to the density of available mapping data. At a high “resolution”, there are a relatively high number of available mappings. A low “resolution” correspondence map has relatively fewer available mappings. The “resolution” determines the accuracy of the mapping process between a given place within one representation and the corresponding place within a different representation.

The density of the mappings can vary across different parts of the different representations, which results in variable “resolution” of correspondence mappings. The client (or server) can interpolate between entries in the correspondence map, in order to improve the perceived “resolution” of the mapping process. A technique such as location sampling (as described in the section “Server-Side Location Sampling”) can be used to initially populate or increase the density of a correspondence map.

There can be some areas of a given representation with no direct correspondence to a different representation. This occurs, for example, when an intermediate transcoding removes some of the visual content data from the transcoded representation. These areas of no direct correspondence can be either handled through an interpolation function, or treated explicitly as areas with no correspondence.

In a client/server configuration of the present invention, correspondence map(s) can be transmitted from the server to the client as required. This allows the client to directly handle mapping functions, such as user requests that select or switch between representations. The correspondence map(s) can include reverse mappings, if appropriate, and can be encoded for efficient transmittal to the client.

To improve perceived user responsiveness, a correspondence map can be separated into multiple segments, based on sections of the mapped content and/or multiple “resolution” levels. When segmenting into multiple “resolution” levels, a lower “resolution” map is created and is then augmented by segments that provide additional “resolution” levels. Segmenting can be done such that a smaller map is first generated and/or transmitted to the client. Subsequent segments of the map can be generated and/or transmitted later, or not at all, based on the relative priority of each segment using factors such as current or historical usage patterns, client requests and/or user preferences.

Multi-Modal Combination of Rasterizing and Text-Related Transcoding

In an illustrative embodiment of the present invention, rasterizing of a visual content element is combined with a transcoding step, in order to provide an alternative representation of the text-related content within a visual content element. This combination creates a multi-modal set, where a text-related representation is used either instead of, or in addition to, the initial rasterized representation.

Since text is often an important part of a visual content element, this combination allows text-related aspects to be viewed, navigated and manipulated separately through a client viewport and/or user interface optimized for text. The multi-modal combination of rasterizing and transcoding preserves, and takes advantage of, the correspondences between the text and the overall design and layout of the content (including the relationships between the text and non-text aspects of the visual content).

FIG. 19 shows an example of combining rasterizing and text-related transcoding. A rasterized overview representation of a Web page is shown in 19-1. A rasterized detail representation of the same Web page is shown in 19-2. Note that the detail representation is presented within a client viewport, and the user can pan or scroll within the viewport to see the entire detail representation. A text-related version of the same Web page is shown in 19-3, this time with word-wrapping and a scroll bar for scrolling through the text.

When combining rasterizing and text-related transcoding, an intermediate transcoding step can extract the text-related aspects of the visual content and store these in a transcoded representation. The transcoded text-related content can then be rasterized (or rendered). If a server performs the transcoding function and a client performs the rasterizing (or rendering) of the transcoded content, then the transcoded content can be transmitted to the client for eventual rasterizing (or rendering) by the client.

The text-related aspects of the visual content can include the relevant text and certain attributes related to the text. Text-related attributes can include appearance attributes (such as bold, italic and/or text sizing), structural attributes (such as “new paragraph” or “heading” indicators), and/or associated hyper-links (such as HTML “anchor” tags). Text-related formatting, such as lists and tables (e.g. HTML tables) can also be included in the text-related transcoding. The transcoded text-related content can be represented in any suitable format including text strings, Microsoft Rich Text Format (RTF), HTML, Compact HTML, XHTML Basic, or Wireless Markup Language (WML).

The text-related transcoding can be done as part of a more general transcoding function that supports additional structural attributes beyond those that are text-related. In other cases, an alternate version of the visual content element may already be available that is more suitable for text-related rendering and can be used instead of transcoding. The text-related rendering can be restricted to rendering only text-related attributes, or it can support additional structural attributes. These can include forms (e.g. HTML forms) or other specifications for visual controls that will be rendered into the text-related rendering.

In this illustrative embodiment, the server-side or client-side rasterizing function generates one or more bit-map pixel representation(s) of the visual content and its associated layout. This is combined with rendering that is limited to text-related aspects of the visual content. If multiple rasterized representations are generated from the results of the initial rasterizing function, this can be a multi-level set of bit-map pixel representations.

By rendering the text separately, the text rendering function can optimize the readability and usability of the visual content's text-related aspects. This includes providing appropriate word-wrapping functions tailored to the client viewport being used to view the rendered text representation. Text rendering can also support user control over text fonts and/or font sizes, including customization to the user's preferences.

During the transcoding process, one or more correspondence map(s) can be generated to map between the initial rasterized representation(s) and the text-related transcoding of the visual content (raster-to-source and/or source-to-raster maps). A correspondence map assists in providing a user interface that selects or switches between the text representation and the rasterized representation(s). A correspondence map can also allow the user to select a pixel region on a rasterized representation and then view the associated text (as rendered from the text-related transcoding). Reverse mapping, from the rendered text to an associated pixel region within a rasterized representation, is also possible.

If a server performs the transcoding function and a client performs the rendering of the transcoded content, the relevant correspondence map(s) from the initial rasterized representation(s) to the text-related representation can be transmitted from the server to the client. This allows the client to directly handle user requests that switch between representations. If a reverse-mapping (from text-based transcoding to rasterized version) is supported, this can also be transmitted to the client. There can also be a mapping generated between the text-based transcoding and its rendered bit-map pixel representation, as part of the rasterizing (or rendering) function applied to the transcoded source representation.

For example, text-related transcoding on a server can include information that a region of text has an associated hyper-link, but the server can retain the data that identifies the “target” of the hyper-link (such as the associated URL) while sending the client a more compact identifier for the “target” information. This reduces the amount of data transmitted to the client and simplifies the client's required capabilities. In this example, the client sends hyper-link requests to the server with the server-supplied identifier, so that the server can access the associated data and perform the hyper-linking function.

If at least one of the initial rasterized representation(s) is at a lower relative pixel resolution (such as an overview representation), then multi-level browsing can be provided between this rasterized representation and the rendered text-related representation. The text-related representation can be used instead of, or in addition to, an initially rasterized representation at a higher relative pixel resolution (such as a detail representation).

In an illustrative embodiment, at least one initially rasterized representation is used as the overview representation. This overview representation acts as an active navigational map over the text-related representation, in addition to acting as a map over any other rasterized representations at higher relative pixel resolutions. A pixel region selection within the overview representation can be used to select or switch to a corresponding part of the rendered text-related representation. The appropriate correspondence maps can also be used to select or switch between the rendered text-related representation and a corresponding pixel region of a rasterized representation (such as a detail representation).

Multi-Modal Combination of Rasterizing with a Text-Related Summary Extraction

When an overview representation is displayed in a client viewport, this display can be supplemented with additional information taken from a text-related summary extraction of the associated visual content element. The summary extraction is a transcoding function that extracts text-related data providing summary information about the visual content element. In one embodiment, this includes any titles; “header” text elements; and text-related representations of hyperlinks. A correspondence map can be generated between the summary information and the overview representation.

In response to a user request for summary information at a specified pixel location, the corresponding summary text can be rendered and displayed in the client viewport. As a result, the extracted summary text is “revealed” to the user while selecting or moving across the overview representations based on correspondence map data. The “revealed” text can be rendered and displayed in a pop-up window over the client viewport, or in a designated location within the client viewport. The client can provide a mechanism to select and process a “revealed” hyperlink. The client can then switch the client viewport to display a rasterized representation of the hyperlink's “target” visual content element.

The summary representation is typically much smaller than either a text-related transcoding of the entire visual content element or a detail level rasterization of the visual content element. This is well suited for implementations where a server generates the summary representation and transmits this to the client. In this case, the client can request the server to send the entire associated correspondence map, or make individual requests for correspondence data as required. If the server performs the summary extraction, it can encode hyperlink “targets” as more compact identifiers known to the server, to further reduce the size of the summary representation transmitted to the client.

Partial Representations

In both a multi-level and a multi-modal set, a representation can be a partial representation. A partial representation is the result of a selection operation. The selection can be applied either in source form to the source visual content element, or in raster form to a rasterized representation. A selection in source form can be applied during a transcoding function or within the rasterizing (or rendering) function. A selection in raster form can be applied after the rasterizing (or rendering function).

The selection function, and its results, can be reflected in the appropriate correspondence map(s). The correspondence map can have entries for the selected portion of the source or raster, but no entries for those portions of the associated source or raster excluded from the selection.

When only a partial representation is available for a given mode or given level of a multi-level set, then the remaining portions outside the selection are null. These null areas can be either be not displayed, or displayed with a special “null representation” (such as white, gray or some special pattern). When multiple partial representations are available for the same mode, or for the same level of a multi-level set, they can be combined into a composite representation (in either raster or source form, as appropriate).

Partial representations, and composite partial representations, can save processing, communications and/or storage resources. They represent the portion of the visual content element or input bit-map representation of interest to the user, without having to generate, transmit and/or store those portions not needed.

By providing a user interface to these partial and composite partial representations, the present invention makes these advantages available within the context of a consistent set of user interface gestures. These gestures provide easy and consistent user access to full representations, partial representations and composite partial representations within a multi-level or multi-modal set. They also provide new means to specify, generate and/or retrieve partial or composite partial representations based on gestures applied to related full, partial or composite partial representations within a multi-level or multi-modal set.

Partial and composite partial representations provide significant advantages in configurations where the client has limited processing, power and/or storage resources. This is the case for most handheld devices such as Personal Digital Assistants (PDAs, like the PalmPilot or PocketPC) or cellular telephones with bit-map displays. Partial representations also provide advantages when a representation is being sent from a client to a server over a communications link with limited bandwidth, such as a serial communications port or the current cellular telephone network.

Pointing Devices

The gestures require that the client device support at least one pointing device, for specifying one or more pixel location(s) on the client's bit-map display device. Commonly used pointing devices include:

a) a mouse,

b) a “pen” or stylus (typically used with an input tablet or pressure-sensitive display screen),

c) a pressure-sensitive surface (such as a touch-pad or pressure-sensitive display screen) which may or may not use a pen or stylus,

d) a joystick,

e) the “arrow” keys on a keyboard.

There are numerous types and variations of these devices, and any that supplies pointing functionality can be used.

Voice-activated, breath-activated, haptic (touch-feedback), eye-tracking, motion-tracking or similar devices can all provide pointing functionality. These alternative input modalities have particular significance to making the present invention accessible to persons with physical handicaps. They can also be used in specialized applications that take advantage of the present invention.

Some gestures combine a selection action with a location specification. The selection action can be provided by:

a) a button press on a mouse device,

b) a press of a pen or stylus on an appropriate surface,

c) a press on a touch-sensitive surface,

d) a keyboard button press,

e) a physical button press on the client device (or device that communicates with the client device), or

f) any other hardware and/or software than can provide or simulate a selection action.

Keyboard/Mouse and Pen-Based Interface Styles

Illustrative embodiments of the present invention can support gestures for two user interfaces styles: “keyboard/mouse” and “pen-based”. For purposes of describing an illustrative embodiment, the following distinctions are made between the “keyboard/mouse” and “pen-based” user interface styles:

a) in the “keyboard/mouse” user interface, the pointing device has one or more integrated button(s), and the state of each button can be associated with the current location of the pointing device,

b) in the “pen-based” user interface, the pointing device can report both its location and an associated state that differentiates between at least two modes (pen-up and pen-down),

c) in the “keyboard/mouse” user interface, alphanumeric input can be entered through a keyboard or keypad,

d) in the “pen-based” user interface, alphanumeric input can be entered through gestures interpreted by a handwriting recognition function (such as the Graffiti system on a PalmPilot).

In a pen-based device with a pressure-sensitive surface, the pen modes are typically related to the level of pen pressure on the surface. Pen-down means that the pressure is above a certain threshold, pen-up means that the pressure is below the threshold (or zero, no pressure). Some pen-based devices can differentiate between no pressure, lighter pressure and heavier pressure. In this case, a lighter pressure can correspond to location mode, while a heavier pressure can correspond to selection mode. Some pen-based devices can differentiate between three or more levels of pressure, and the client can determine which level(s) correspond to location and selection modes.

It is possible to emulate a mouse with a pen, or a pen with a mouse. It is also possible to emulate either a pen or mouse with any other pointing device. For example, a finger pressing on a touch-sensitive screen can emulate most pen functions. A keyboard can be emulated by displaying a keypad on the display screen, with the user selecting the appropriate key(s) using a pointing device.

Therefore, the distinctions between “keyboard/mouse” and “pen-based” are not about the physical input devices but instead about the user interface style(s) implemented by client software. The client software can blend these styles as appropriate, or support a subset of features from either style. The style distinctions are simply a way to clarify different gestures and their meanings within an illustrative embodiment.

Personal computers (PCs), intelligent terminals (with bit-map displays), and similar devices typically support a keyboard/mouse interface style. The mouse is the primary pointing device, with one or more selection button(s), while the keyboard provides alphanumeric input. The keyboard can also provide specialized function keys (such as a set of arrows keys), which allows the keyboard to be used as an alternate pointing device.

In a pen-based user interface, the primary pointing device is a pen (or stylus) used in conjunction with a location-sensitive (typically pressure-sensitive) surface. The surface can be a separate tablet, or a pressure-sensitive display screen. Handheld devices, such as a personal digital assistant (PDA) like the PalmPilot, typically support a pen-based user interface style. Cellular telephones with bit-map displays can combine a pen-based user interface style with a telephone keypad.

A pen-based user interface can support alphanumeric data entry through any or all of the following:

a) an alphanumeric keyboard or keypad,

b) handwriting recognition of pen gestures (e.g. the Graffiti system on a PalmPilot), and/or

c) displaying a keypad on the display screen and allowing the user to select the appropriate key(s).

A single client device can support various combinations of keyboard/mouse and pen-based user interface styles. If a client device supports both multiple simultaneous pointing devices (physical or virtual), it can provide a means to determine which is the relevant pointing device at any given time for interpreting certain gestures of the present invention.

Interpreting Events as Gestures

User interface actions are typically reported to the client as user interface events. Location events specify one or more location(s) on a client viewport. Pointing devices can generate location events. Selection events specify a selection action, and may also provide one or more associated location(s). When a pointing device generates a selection event, it typically also provides location information.

As the client processes these events, it interprets some subset of these events as gestures. A gesture is interpreted from a sequence of one or more events. The gesture is determined by the ordering of these events, the information associated with each event (such as location information) and the relative timing between events.

Gesture-Based User Interface

The user interface gestures allow the user to control various aspects of navigating and/or browsing through the multi-level and/or multi-modal sets of bit-maps. This includes gestures to control the process of:

a) panning across one or more bit-map(s) in the multi-level or multi-modal set,

b) scrolling across one or more bit-map(s) in the multi-level or multi-modal set,

c) moving to a location on one or more bit-map(s) in the multi-level or multi-modal set,

d) selecting a location on one or more bit-map(s) in the multi-level or multi-modal set,

e) selecting or switching from one representation level to another within the multi-level or multi-modal set of bit-maps, and/or

f) changing the input mode associated with one or more bit-map(s) in the multi-level or multi-modal set.

The client device can maintain the multi-level or multi-modal set as one or more client display surface(s). In an illustrative embodiment, each level and each mode is maintained as a separate client display surface. The client can allocate one or more client viewport(s) for displaying the contents of the client display surface(s). If a client display surface is directly allocated within the display memory of the client's bit-map display device, then this client display surface and its associated viewport share the same underlying data structure(s).

Based on user input at the client device, the client device paints one or more client display surface(s) into its client viewport(s), and thus displays one or more of the bit-map representation(s) on its display screen. In an illustrative embodiment, the client device can display pixels from one or more representation levels or modes at any given time, by displaying selected portions of multiple display surfaces (one per representation level) in multiple client viewports (one viewport per display surface).

In an illustrative embodiment, two or more client viewports can be displayed simultaneously on the client's bit-map display device, or a user interface provided to switch between client viewports. The decision to display multiple viewports simultaneously is based on client device capabilities, the number of pixels available in the client bit-map display device for the client viewport(s), software settings and user preferences.

In an illustrative embodiment, when the overview representation of a multi-level set is being displayed, the client displays as much of this representation as possible within a client viewport that is as large as possible (but no larger than required to display the entire overview representation). This gives the overview representation precedence over display of any sub-region(s) of different representation level(s) or representation mode(s). This is to maintain the advantages of viewing and working with as much of the overall layout as possible at the overview level.

In an illustrative embodiment, the client device can divide a representation into multiple tiles, where the tile size is related to the size of a client viewport. The client device can provide a user interface to select or switch between tiles, pan across adjacent tiles, and/or scroll across adjacent tiles.

Unified Set of Gestures

The present invention provides a unified set of gestures that support navigation through and/or interaction with the multi-level or multi-modal set of bit-maps. Within the unified set of gestures, there are three general classes of gestures: location gestures, selection gestures and input-mode gestures. Location and selection gestures are described in the sections “Location Gestures” and “Selection Gestures”, while other input-mode gestures are described below in the section “Special Input Modes and Input-Mode Gestures”.

These gestures can be implemented in different ways on different clients. Some clients will implement only a subset of the gestures, or assign different meanings to certain gestures. An implementation in accordance with the present invention can:

a) support at least one “swipe” or “drag” gesture (as defined below in the “Selection Gestures” section), and

b) interpret this swipe or drag gesture as a switch or selection from one level of a multi-level set of bit-maps to another level within the same multi-level set, or as a switch or selection from one modal representation to another within the same multi-modal set.

Advantages of the Unified Set of Gestures

The unified set of gestures provides new ways to navigate through and/or interact with a multi-level or multi-modal set of bit-map pixel representations. Compared to indirect actions such as scroll bars, menu selections and pop-up “zoom” dialog boxes, the unified gestures provide direct actions that allow the user to keep the pointing device in the same part of the screen where bit-map is being displayed. Back-and-forth movements to various auxiliary menus, visual controls or tools are minimized or eliminated. The unified gestures greatly reduce the amount that the pointing device (e.g. mouse or pen) has to be moved, and hence greatly improve ease of use.

The user is saved the tedium (and repetitive stress) of back-and-forth movements to scroll bars painted around the perimeter of the client viewport, scrolling across the bit-map to find the region of interest. Instead, the user has direct access through swipe gestures to higher resolution or different modal versions of the region of interest. The user also has direct access to overview (or intermediate) versions that show the overall layout of the input bit-map, without having to assemble a mental image by scrolling through a single representation.

The unified set of gestures are particularly advantageous when using a hand-held device such as a personal digital assistant (PDA) like a PalmPilot or cellular telephone with a bit-map display. In these devices, the bit-map display area is relatively small compared to a standard personal computer (PC), and a pen-based user interface style is typically preferred over a mouse/keyboard user interface style. The unified set of gestures provide a better means to control the interaction with and/or navigation of any input bit-map that has a resolution greater than the bit-map display resolution, and does this in a way that maximizes the utility of a pen-based user interface style. Certain control gestures typically used within a mouse/keyboard user interface style (particularly those that assume two-handed operation) are not available with a pen-based handheld device, but can be provided with the unified set gestures.

These advantages can be grouped into two major categories. The first category consists of advantages from working with a multi-level or multi-modal set of bit-map pixel representations versus working with only a single bit-map pixel representation. The unified set of gestures makes working with a multi-level or multi-modal set simple and practical. The second major category consists of those advantages over previous methods of working with multi-level bit-map pixel representations. The unified set of gestures makes it more efficient and easier to work with multi-level bit-maps.

The advantages versus using a single bit-map pixel representation are as follows:

First, the overview representation is small enough to rapidly download (if supplied by a server), rapidly process on the client device and rapidly display on the client device's bit-map display. This increases perceived user responsiveness. If the user decides, based on viewing the overview representation, that the intermediate and/or detail representation(s) are not needed, then some or all of the processing and display time for these other representation level(s) can be avoided. This further increases perceived user responsiveness, while reducing client processing and client power requirements.

Second, the overview representation is typically small enough to fit entirely within the allocated client viewport on most client devices. This provides the user with a single view of the overall layout of the input bit-map pixel representation. Even if the overview representation cannot fit entirely into the client viewport, it is small enough so that the user can rapidly gain a mental image of the overall layout by scrolling, panning and/or tiling of the overview representation.

Third, the overview representation provides a convenient means of navigating through the input bit-map pixel representation. The user can select those areas to be viewed at a higher resolution (an intermediate representation and/or detail representation), or to be viewed in a different modal representation (such as a text-related rendering with scrolling and word-wrap optimized for the current client viewport). This saves the user considerable time in panning, scrolling and/or tiling through a single full-resolution rendered representation. This also allows the user to choose the most appropriate modal representation of the detail, by selecting a “region of interest” from the overview or intermediate level, and move back and forth quickly and easily between both levels and modes.

Fourth, the user can optionally make selections or perform other user actions directly on the overview representation. This can be an additional convenience for the user, particularly on client devices with a relatively low-resolution bit-map display (such as a PDA device or cellular telephone with a bit-map display). If the intermediate and/or detail representation(s) have not been fully processed, perceived user responsiveness is improved by allowing user actions on the overview representation overlapped with processing the other representation(s).

Fifth, the optional intermediate representation(s) provide many of the advantages of the overview representation while providing increased level(s) of detail.

Sixth, the detail representation provides sufficient detail to view and use most (if not all) aspects of the input bit-map pixel representation. A system implemented in accordance with the present invention lets the user easily switch back and forth among the representation levels, allowing the user to take advantage of working at all available levels. The user is not constrained to work at a single level of detail, but can move relatively seamlessly across levels, while the system maintains the coherency of visual representation and user actions at the different levels.

Seventh, a multi-modal set of representations allows the user to select and view the a rasterized representation of a source visual content element using whatever mode is the most convenient, most efficient, and/or most useful. The present invention provides a set of direct gestures that access the underlying correspondences being maintained between the different modal representations. By combining multi-modal with multi-level, selecting a “region of interest” from an overview in one mode and then viewing the corresponding detail within another mode can be accomplished through a single swipe or “overview drag” gesture.

The advantages over previous methods of working with multi-level bit-map pixel representations are as follows:

First, unified gestures that combine location specification with selection properties reduces the number of required gestures. These save time and can considerably reduce user fatigue (including reduction of actions that can lead to repetitive stress injuries). For example, a “swipe” that moves up or down a level while simultaneously defining a “region of interest” can be compared favorably to any or all of the following methods:

a) moving the location from the client viewport to a menu, selecting a menu item to specify scaling, and then scrolling the scaled viewport to the desired region of interest,

b) moving the location from the client viewport to a menu, selecting a menu item that generates a pop-up dialog box to control scaling, moving the location to the dialog box, selecting one or more scaling control(s) in the pop-up dialog box, and then scrolling the scaled viewport to the desired region of interest,

c) moving the location from the client viewport to a user interface control (or widget) outside the client viewport that controls scaling, selecting the appropriate control (or widget), possibly dragging the control (or widget) to make the appropriate level selection, and then scrolling the scaled viewport to the desired region of interest, and

d) moving the location from the client viewport to an external tool palette that defines a “zoom” tool, selecting the “zoom” tool, moving the location back to the client viewport, dragging the zoom tool across the region of interest, and moving the location back to the tool palette to de-select the “zoom” tool.

Second, unified gestures provide a uniform method of moving up and down the levels of a multi-level set of bit-map pixel representations. In conventional icon/document pairs, there are only two levels: an icon that is a reduced scale version of a bit-map pixel representation, and a full-scale version of the bit-map pixel representation. One set of user interface gestures selects the full-scale version from the icon, a completely different set of gestures creates an icon from the full-scale version. There are typically no intermediate levels, or gestures for selecting or switching to an intermediate level. There are typically no gestures for selecting the region of interest within the icon representation and only displaying the region of interest of the full-scale version within a client viewport. Similarly, there are typically no gestures for displaying only a region of interest within the lower level (icon) representation.

Third, unified gestures provide a uniform method of moving up and down the levels within a single client viewport. In the typical icon and a full-scale bit-map version, the icon and full-scale bit-map are displayed in separate client viewports. There is no notion of sharing a single client viewport between the icon and full-scale version, and then switching between the two. Even when the user interface provides switching between levels within a single client viewport, this switching is done through one of the methods previously described above. These methods not only take more steps, they are often not uniform. Different menu items or visual controls (or widgets) are required to move down a level compared to those required to move up a level. Often there is not even a gesture to move up or down a level, but requires explicitly choosing a level (or zoom factor).

Fourth, the unified set of gestures provides methods to use similar gestures to not only move up or down representation levels but also perform other actions associated with the bit-map pixel representation. For example, a “swipe” up can move to a less detailed (lower) level, a “swipe” down can move to a more detailed (higher) level. In the same example, a horizontal “swipe” can perform a selection action at the current level (such as displaying a menu or displaying additional information about the visual content element). This unifies the level-oriented navigational gestures with a different type of common gesture. A “drag” along a similar path can activate a panning or scrolling navigational operation within the current level, instead of requiring an entirely different navigational paradigm for pan/scroll as compared to zoom. A “tap” at the same location can activate the same selection action as a “swipe”, or activate a different context-dependent action.

### BRIEF DESCRIPTION OF THE DRAWINGS

Other objects, features and advantages will occur to those skilled in the art from the following description of the preferred embodiments, and the accompanying drawings, in which:

FIG. 1 is a schematic diagram of a display surface painting function used in an embodiment of the invention;

FIG. 2A is a view of an input bit-map pixel representation of a web page according to this invention;

FIG. 2B is a sample overview representation of the web page shown in FIG. 2A;

FIG. 2C is a sample intermediate representation of the web page of FIGS. 2A and 2B;

FIG. 2D is a sample detail representation of the web page of FIGS. 2A, 2B and 2C;

FIG. 3A is a view of an input bit-map pixel representation of a spreadsheet according to this invention;

FIG. 3B is a sample overview representation of the spreadsheet shown in FIG. 3A;

FIG. 3C is a sample production representation of the spreadsheet of FIGS. 3A and 3B;

FIG. 4A is a sample display of the overview level on a client device according to this invention;

FIG. 4B is a sample display of the detail level from the overview level of FIG. 4A, on a client device according to this invention;

FIG. 5 is a flowchart of client processing of events according to this invention;

FIG. 6 is a flowchart of end gesture processing according to this invention;

FIG. 7 is a partial event list for this invention;

FIG. 8 is a flowchart of gesture processing according to this invention;

FIG. 9 is a chart of two location mode gestures according to this invention;

FIG. 10 is a flowchart of location mode gesture processing according to this invention;

FIG. 11 is a chart of selection mode gestures according to this invention;

FIG. 12 is a flowchart of selection mode gesture processing according to this invention;

FIG. 13 is a flowchart of special input mode gesture processing according to this invention;

FIG. 14 is a flowchart of tap processing according to this invention;

FIG. 15 is a schematic diagram of pixel transform functions according to this invention;

FIG. 16 is a schematic diagram of mapping client locations to input bit-map according to this invention;

FIG. 17 is a schematic diagram of multi-modal set of representations according to this invention;

FIG. 18 shows an example of correspondence maps according to this invention; and

FIG. 19 shows an example of combining rasterizing and text-related transcoding according to this invention.

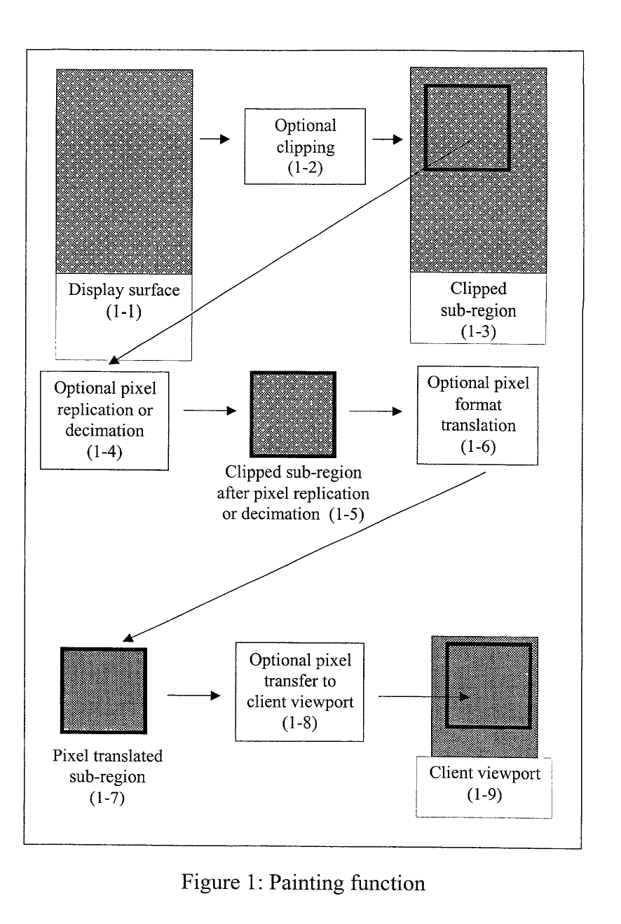

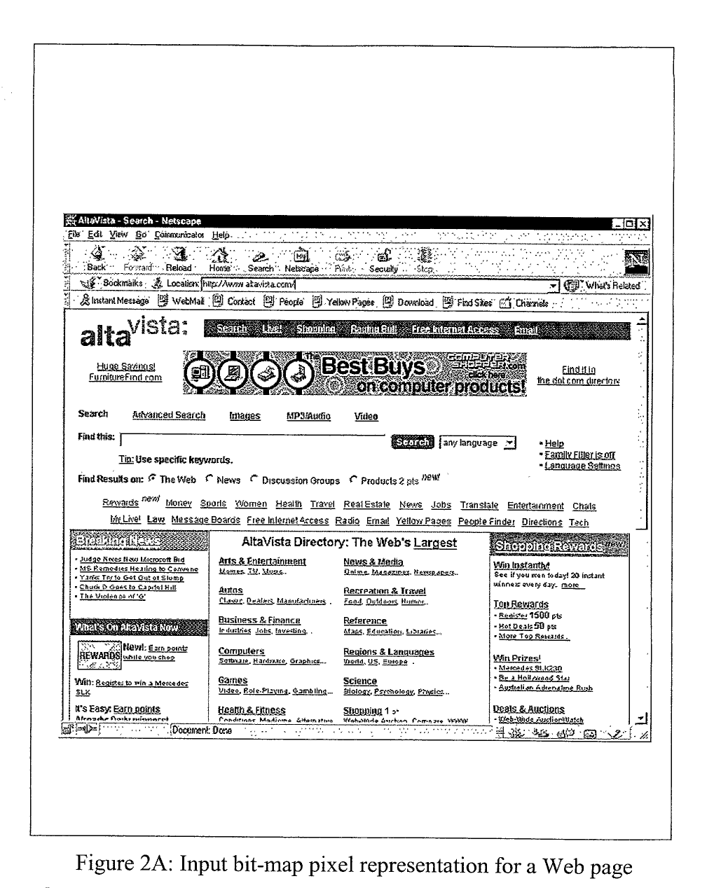

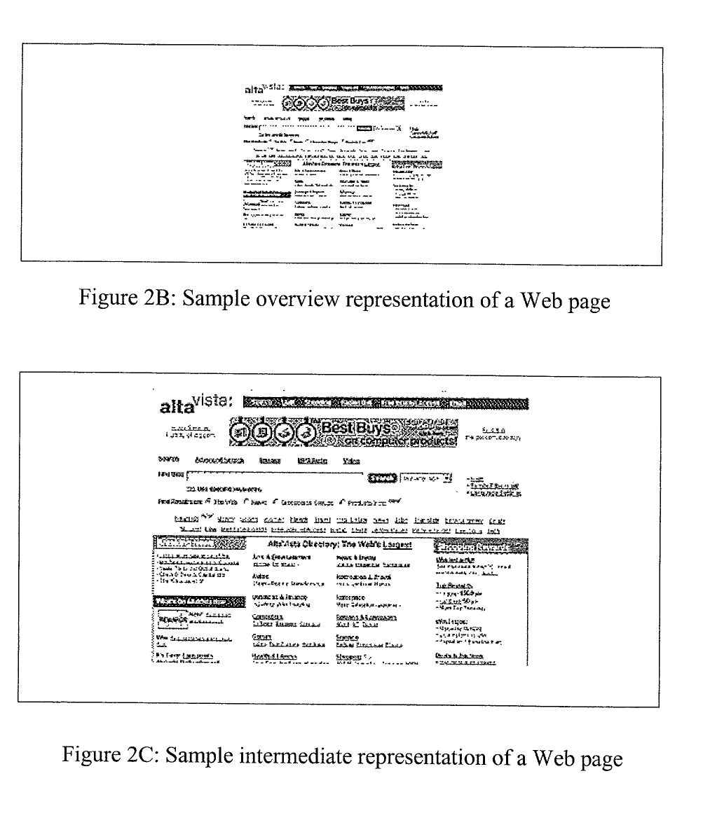

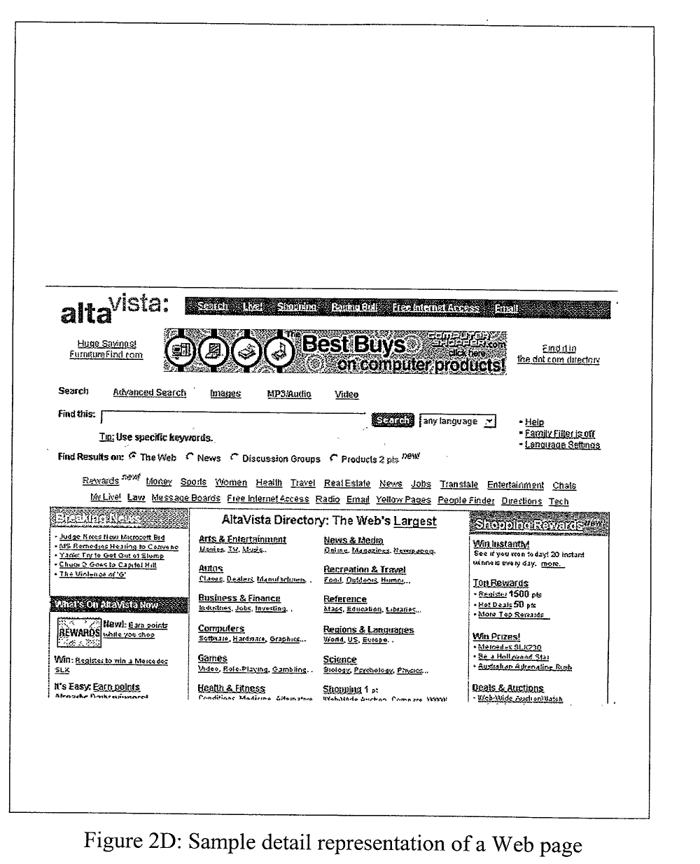

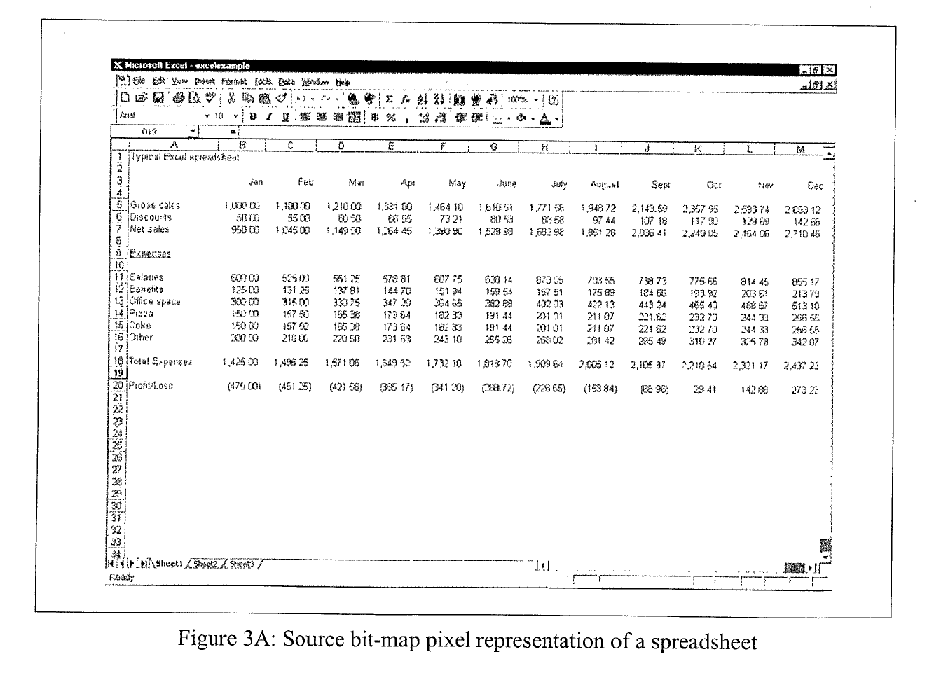

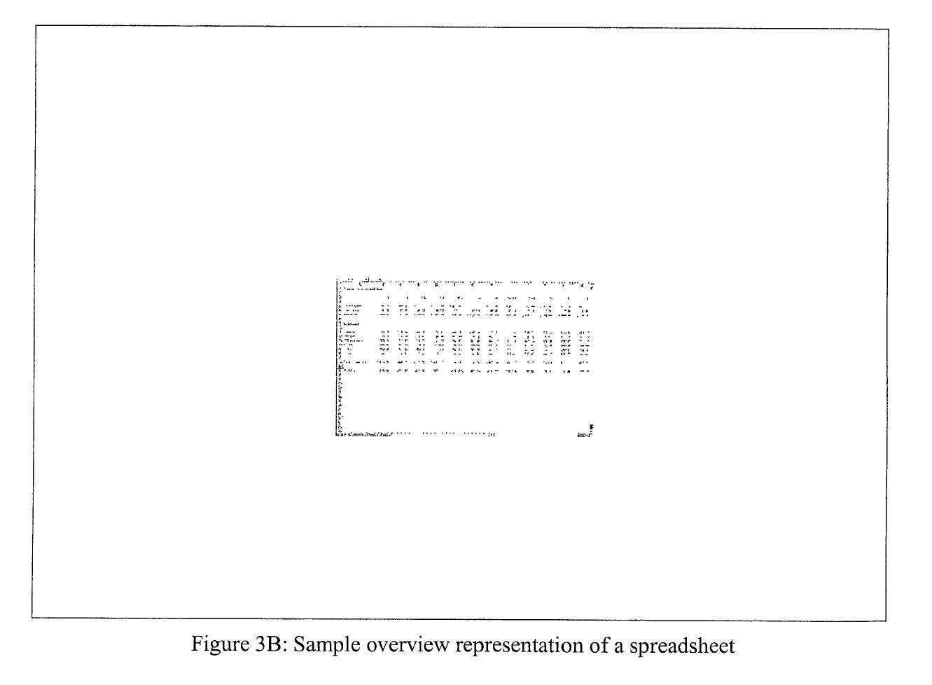

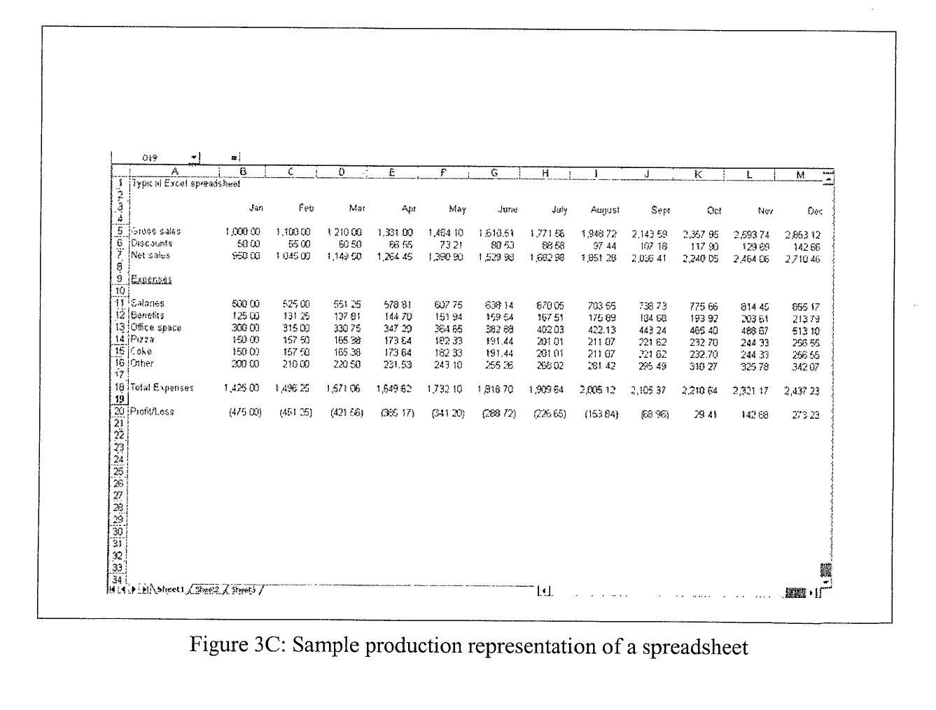

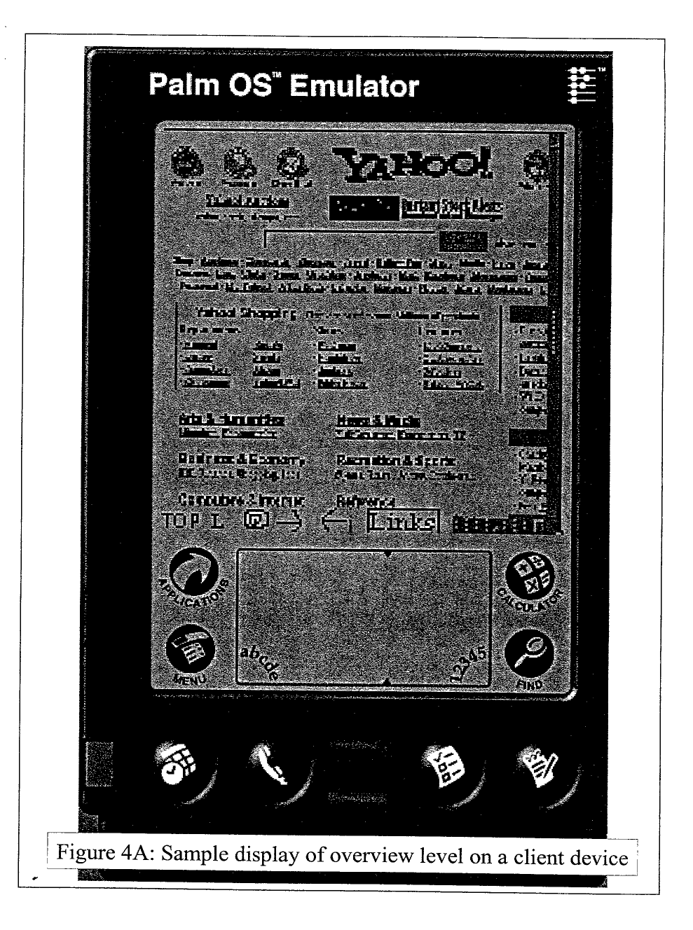

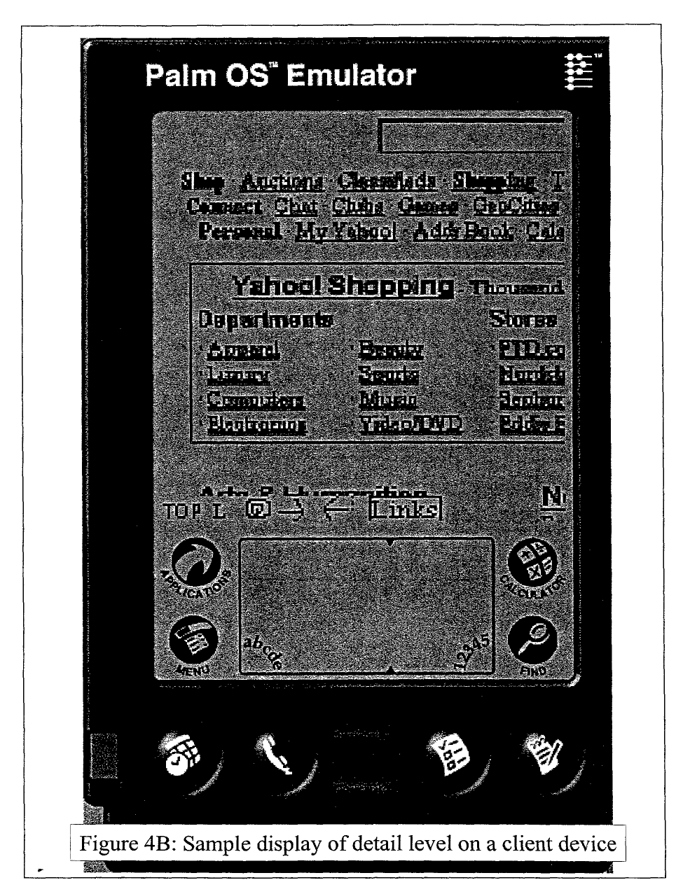

### DETAILED DESCRIPTION OF THE PREFERRED EMBODIMENTS

Location Gestures

A location gesture is interpreted from a sequence of one or more location event(s). Location gestures support movement within a given client viewport. The location gestures can include:

a) “move”: a traversal along a path of one (X,Y) location on a given client viewport to one or more other (X,Y) location(s) on the same client viewport, and

b) “hover”: maintaining the pointing device at the same (X,Y) location on a given client viewport for an interval of time greater than a specified minimum “hover interval”

Some user interfaces cannot support location events, and therefore cannot provide location gestures. This is true for pointing devices that can only provide a pixel location in conjunction with a selection event. For example, a pen device using a pressure-sensitive surface is typically unable to report the pen's location when it is not touching the surface. However, if the pointing device can differentiate between two types of location-aware states, it can use one state for location events and the other for selection events. For example, some pressure-sensitive surfaces can distinguish between levels of pressure. In this case, a lighter pressure can be associated with a location event, and a heavier pressure associated with a selection event.

Move

A move gesture typically requires a minimum of two location events, one for the first (X,Y) location and one for the second. However, some clients will report both a start and end location for a location event, which allows the client to determine if a move gesture was made.

In response to a move gesture, the client can optionally provide appropriate feedback to echo the current position of the pointing device on the bit-map display device. For example, this position feedback can be supplied by painting an appropriate cursor image, highlighting a related portion of the client viewport, or supplying a display of an associated (X,Y) coordinate pair.

Client feedback is not required for move gestures. For example, a pen move over a pressure-sensitive display screen does not necessarily require any visual feedback, since the user is already aware of the pen's position on the display. Hardware limitations and/or stylistic preferences can also limit the client device's echoing of move gestures.

Hover

A hover gesture requires only a single location event. The client can then determine when the recommended “hover start” interval expires, relative to the time associated with the location event. A client typically uses one or more timer event(s) to time the “hover start” interval. The hover gesture is recognized if the pointing device remains within the same location (or within a small radius of this location) and the “hover start” interval expires. In an illustrative embodiment, the recommended “hover start” time-out interval is 1 to 2 seconds.

The client can provide visual and/or audio feedback for a hover gesture. For example, a blinking cursor or other type of location-based feedback can alert the user to the hovering location.

In an illustrative embodiment, the client can interpret a hover gesture as a request for context-dependent information. Context-dependent information can include information about the client software's current state, the type of bit-map pixel representation(s) being display, and/or information related to the current pixel location on the bit-map display device.

For a “hover” on an overview or intermediate level, information related to the current pixel location can include a corresponding pixel region from a detail level or other modal representation (such as a text-related transcoding or text-related summary extraction). In this case, the “hover” acts as a request to “reveal” the corresponding portion of the associated “reveal representation”: the detail level or other modal representation used for the “reveal”. This “reveal” uses the current pixel location to determine the corresponding region in the “reveal representation”. The detail level can be specified by a “reveal target” state variable maintained by the client.

As the user is viewing the overview or intermediate level, corresponding information from the “reveal representation” is “revealed” (displayed as a pop-up, or displayed in a specified section of the client viewport). This allows the user to see small portions of the corresponding “reveal representation” without having to select or switch to this representation. If the “reveal representation” is available to the client in source form, then this “reveal” can be rasterized from the corresponding source representation. Otherwise, the “reveal representation” is selected and displayed in its raster form. If a corresponding portion of the “reveal representation” is not available for the current location (based on correspondence map data), then the “nearest” portion can be revealed. The determination of “nearest” can be based on a computation of the distance between the corresponding pixel location and the pixel location of available content within the “reveal representation” as mapped to the overview (or intermediate) representation. If the difference in corresponding locations exceeds a certain threshold, then nothing is revealed to avoid confusing the user with a “reveal” that does not correspond to the current location. In an illustrative embodiment, the recommended threshold tests that the available “reveal” content is within 3-5 pixels of the specified location in the overview (or intermediate) representation, based on mapping the “reveal” content to this overview (or intermediate) representation.

If such context-dependent information (e.g. associated “reveal” content) is available, the client can display this information in an appropriate form. In an illustrative embodiment, this information is displayed in a pop-up window or within a designated “status information” area of the client display.

Selection Gestures

Selection gestures are differentiated from location events by the client's “input mode”. The input mode is maintained through one or more client data element(s). It can be set through one or more:

a) selection event(s),

b) specific input-mode gesture(s),

c) software interface(s), and/or

d) data element(s) associated with one or more event(s) that are part of the gesture.

The input mode changes the interpretation of user interface event(s) into gestures. In “location” mode, a sequence of location events is interpreted as one or more location gesture(s). In “selection” mode, the same sequence is interpreted as a selection gesture.

For example, a series of mouse moves may be interpreted as a location gesture. But if a mouse button is pressed during the same set of mouse moves, these moves may be interpreted as a selection gesture. In another example, a series of pen moves at one pressure level may be interpreted as location gestures. The same moves at a greater pressure level may be interpreted as selection gestures.

When the client is in selection mode, selection gestures can include:

a) “swipe”: a relatively quick traversal along a path,

b) “drag”: a relatively slower traversal along a path,

c) “tap”: a selection action over a single pixel or a relatively small number of pixels,

d) “double-tap”: two sequential taps within the specified “double-tap” time interval,

e) “hold”: a hover in selection mode

f) “pick”: a hold on a “pick” location that exceeds the “pick confirm” time interval

The swipe and drag gestures are the “selection mode” equivalents to move gestures. In selection mode, the speed of traversal is the primary factor used to differentiate a swipe from a drag gesture. The speed is calculated over the entire path (average speed) and between sampled points along the traversal path (instantaneous speed).

Along with gesture speed and path length, the locations on the path relative to a given client viewport can influence the interpretation of a gesture. A traversal that occurs entirely within a client viewport, one that occurs outside a client viewport, and one that has a path that includes locations both within and outside a client viewport, can each be interpreted as different types of gestures.

A “tap” gesture requires a selection event, such as a button press or a pen press, associated with a pixel location on a client viewport. If the selection event is followed by location or selection events within a small radius of the original pixel location, these can be included within a single tap gesture. This allows the user to wobble the pointing device a little during a tap gesture.

The interpretation of the gesture also depends on selection actions or other user interface cues that occur before, during or after the gesture. For example, a button press action before, during or after a gesture can modify the meaning of the gesture. Similarly, many pressure-sensitive devices report different levels of pressure. The reported pressure level at different stages of a gesture provides a user interface cue for changing the meaning of the gesture. Another example is a voice-activated selection action or cue, so that a spoken word such as “up”, “down” or “go” modifies the interpretation of a gesture.

User preferences and/or software interfaces can alter the interpretation of gestures. The client can have a standard set of interpretations for a set of gestures and any associated selection actions and/or cues. The client can provide a user interface that allows the user to modify these interpretations. The client can provide a set of software interfaces which allow other software on the client (or software in communication with the client) to modify these interpretations. User preferences and/or software interfaces can also expand or limit the number of gestures, selection actions, and/or cues recognized by the client.

Swipe

In an illustrative embodiment, each of the selection gestures has a specific interpretation relative to the multi-level or multi-modal set of bit-map pixel representations.

In an illustrative embodiment, a swipe can be interpreted as a selection or switch to a different representation level of a multi-level set, or to a different mode within a multi-modal set. The interpretation of the swipe can depend on the number of levels supported within a multi-level set, and on whether multi-modal sets are supported. Swiping across multiple modes is discussed below in the section “Multi-Modal Swipe”.

For a multi-level set, each swipe can cycle through the levels of a multi-level set (from overview, through any optional intermediate levels, to the detail level). The cycling behavior can be modified by the direction of the swipe gesture, by indirect user actions (menu selections, button presses), by modifications to the gesture (such as “swipe and hold”, described below), or by state variable(s) maintained by the client.

The swipe direction (up/down, or left/right) can be assigned a meaning for navigating “up” or “down” across the levels. If there are only two levels within a multi-level set, overview and detail, then the direction of the swipe (up or down, left or right) can be ignored, with any swipe interpreted as a switch to the other level.

For a directional swipe, the direction of the swipe (up/down/left/right) is given a semantic meaning. A vertical swipe up can be a selection or switch to a less-detailed (lower level, lower relative pixel resolution) representation. A vertical swipe down can be a selection or switch to a more-detailed (higher level, higher relative pixel resolution) representation. The client can reverse the meanings of “up” and “down” vertical swipes, through user preferences or software settings.

A swipe is considered vertical if it defines movement in the vertical direction above an implementation-dependent threshold, and this movement occurs within a minimum swipe time-out interval (which determines the minimum swipe velocity). In an illustrative embodiment, the recommended minimum swipe distance is five (5) pixels and the minimum swipe time-out interval is 400 milliseconds. Therefore in an illustrative embodiment, if the swipe covers at least five (5) pixels in the vertical direction within 400 milliseconds, it is considered a vertical swipe.

The meaning of a vertical swipe in an illustrative embodiment is based on a mental model of the user moving to different elevations over the input bit-map pixel representation, or “zooming” in and out. At a higher elevation (swipe up, zoom out), the user can view more of the input bit-map but less of the details. At a lower elevation (swipe down, zoom in), the user sees less of the input bit-map but at a greater level of detail.

Since each level of the multi-level set is pre-computed, the quality of the scaling can be much higher than a typical per-pixel decimation or replication used for dynamic zooming over a single bit-map representation. For example, the pre-computed scaling can use filtering and/or sharpening techniques that compute each resultant pixel from a corresponding neighborhood of source pixels. Other techniques, such as filtering and/or image enhancement based on computations over the entire image, can also be used that might be computationally prohibitive during dynamic zooming.

The path of the swipe defines a “region of interest” relative to the current representation level. In a single gesture, the user can navigate up and down the levels while simultaneously defining the region of interest. The region of interest is used to determine the corresponding pixel location(s) within the selected level. The client will attempt to position the selected level's corresponding region of interest for maximum visibility within the appropriate client viewport. For example, a client may position the upper left corner of the corresponding region of interest at the upper left corner of the viewport, or position the center of the corresponding region of interest at the center of the viewport.

In an illustrative embodiment, a vertical swipe up that continues outside the client viewport is interpreted as selecting or switching to the overview (lowest level) representation. A vertical swipe down that continues outside the client viewport is interpreted as selecting or switching to the detail (highest level) representation.

In an illustrative embodiment, if the client viewport's upper or lower bounds are at the upper or lower edges of the bit-map display device, then a “swipe and hold” can be used instead of a continued swipe. In a “swipe and hold”, a swipe gesture is immediately followed by a hold gesture, holding for a specified minimum length of time at or near the border of the client viewport. In a continued swipe or “swipe and hold”, the first part of the path is given precedence in positioning the selected representation level within a client viewport.

Multi-Modal Swipe

For a multi-modal set, a swipe can be interpreted as a selection or switch across levels and/or modes. Each mode can either be a single-level representation or a multi-level set. If there are no multi-level sets within a multi-modal set, then a swipe can be unambiguously interpreted as a selection or switch to a different mode. In this case, the “target” mode for a swipe can be set through any or all of the following means:

a) cycling through the available modes, using the swipe direction (up/down or left/right) to control the cycling behavior, with “swipe and hold” to choose specific modes,

b) toggling between two pre-selected modes,

c) using a “next mode” state variable to determine the “target” mode (as set by user actions, user preferences, or by the client software)

d) determining the “target” mode through a context-sensitive analysis of the swipe “region of interest” (as described below)

When a multi-modal set contains at least one multi-level set, the interpretation of the swipe determines both the level and the mode of the “target” representation. To determine the “target” level from a swipe, every representation in the multi-modal set is assigned a level. If the mode contains a multi-level set, then the level of each representation is known. For a mode with a single representation, the client can assign the mode to a specific level (overview, intermediate or detail).

Given that every representation in a multi-modal set is assigned to a level, the swipe can be interpreted as a selection or switch from one level (current level) to another (“target” level). This can be done using rules similar to those described above in the section “Swipe”.

With the current and “target” levels determined by the swipe, the next step is to determine the “target” mode. The client can use a set of “next mode” state variables, one per level. The state of the “next mode” variable for the “target” level can be used to determine the “target” mode for that level. The client can then select or switch to the representation at the “target” level for the “target” mode.

The client initializes each “next mode” state variable to a valid mode (one that has a representation at the appropriate level). Any updates to a “next mode” variable are applied in such a way that it always points to a “target” mode that has a representation at the assigned level. For example, a “next mode” at the overview level can point to either a multi-level mode that has an overview representation, or to a single-level mode that has been assigned to the overview level. But this “next mode” at the overview level cannot point to a single-level mode assigned to the detail level. In this way, a multi-modal swipe is always guaranteed to select or switch to a valid representation level within a valid mode.

The “next mode” state variable associated with the detail level is herein referred to as the “next detail” state variable. The “next mode” state variable associated with the overview level is herein referred to as the “next overview” state variable.

A “next mode” state variable can be changed by user action. An indirect user action, such as a menu selection or button press, can be associated with a “next mode” state variable. This allows the user to control the “next mode” for a given level, subject to the constraint that this must be a valid “target” for the given level. A “next mode” state variable can also be set by user preference or by the client software.

A context-sensitive determination of “next mode” can automatically set a “next mode” state variable, based on the “region of interest” determined by the swipe path. This context-sensitive technique selects the mode that presents the “best” view of the selected region (at the specified “target” level). This analysis of the “best” mode can be based on the type of visual content represented within the “region of interest” as determined through the appropriate correspondence map(s). For example, a selection over an area dominated by text can use a text-oriented representation mode while another selection over a picture or graphic can use a more graphically oriented representation mode. If a “best” mode is indeterminate, then a default “next mode” can be used.

A context-sensitive determination can also be based on comparing the swipe's “region of interest” with the corresponding coverage of partial representations. The amount of coverage within a partial representation, compared to the swipe's “region of interest” is determined through the appropriate correspondence map(s). If a partial representation in one mode has more coverage than a partial representation in other modes, this mode can be used as the “next mode”. The determination of relative coverage can be based on comparing the corresponding areas of the pixel regions within the rasterized representations.

In an illustrative embodiment, there is one mode that contains a multi-level set, and all other modal representations are considered to be at the “detail” level. This allows a relatively simple interpretation of switching levels across modes. A swipe to a detail representation selects or switches to the appropriate “next detail” representation. A swipe to an overview (or optional intermediate) representation always selects or switches to the appropriate representation within the single multi-level set. The result is that a single overview (or intermediate) representation is used across all modes, but a swipe to the detail is subject to a modal selection process.

Horizontal Swipe

In an illustrative embodiment, a horizontal swipe is considered horizontal if it defines movement in the horizontal direction above an implementation-dependent threshold, and this movement occurs within a minimum swipe time-out interval (which determines the minimum swipe velocity). In an illustrative embodiment, the recommended minimum swipe distance is five (5) pixels and the minimum swipe time-out interval is 400 milliseconds. Therefore in an illustrative embodiment, if the swipe covers at least five (5) pixels in the horizontal direction within 400 milliseconds, it is considered a horizontal swipe.

The client can either treat “left” and “right” horizontal swipes as the same, or give them different interpretations. The differences in interpretation can be set by user preferences. For example, the differences might be based on whether the user expects to read text left-to-right (e.g. English) or right-to-left (e.g. Hebrew).

The client can reverse the interpreted meanings of horizontal and vertical swipes. If the meanings are reversed, then horizontal swipes are given the meanings of vertical swipes and vertical swipes are given the meanings of horizontal swipes. The differences in interpretation can be set by user preferences. For example, the differences might be based on whether the user expects to read text up-and-down (as in many Asian languages) as opposed to side-to-side (as in many Western languages).

A horizontal swipe can be treated as equivalent to a vertical swipe. The equivalence can be directional (such as “left” to “up”, “right” to “down”). If the vertical swipe has no directional interpretation (“swipe up” and “swipe down” are equivalent), then every swipe can be interpreted as having the same semantic meaning, regardless of swipe direction. In this case, a horizontal swipe is given the same interpretation as a vertical swipe, which simplifies the gesture interface.

In an illustrative embodiment, a horizontal swipe can be interpreted as a request to display (or hide) additional information and/or user-interface menus associated with the client viewport. If the optional information and/or menus are currently visible, the horizontal swipe is a “hide” request. Otherwise the horizontal swipe is interpreted as a request to “show” the menus and/or additional information.

Menus provide support for indirect user interface actions related to the current representation being displayed within the client viewport. This can include requesting certain processing functions (such as saving a copy of the current representation), setting state variables (such as switching modes or setting the “next mode”), and setting display preferences (such as setting the font size for a text-related rasterizing function).

Additional information can include any or all of the following:

a) a “title” for the currently displayed representation (such as that provided by an HTML<title>tag),

b) the location (such as a URL, Uniform Resource Locator) of the associated visual content element, and/or

c) status information such as the date and time when the representation was created.

Hiding the menus and/or additional information provides more room to display the current representation within the client viewport. When these are shown, they are either allocated a portion of the client viewport or displayed as an overlay over the current representation. In either case, less of the current representation is visible when the menus and/or additional information are displayed.

This interpretation of a horizontal swipe can be limited to a certain section of the client viewport, such as the section where the menus and/or additional information is displayed when not hidden. This is typically the upper part of the client display surface. In other portions of the client display surface, the horizontal swipe can either have no meaning, or have a meaning that is equivalent to a vertical swipe.

Using the horizontal swipe for a hide/show function saves viewing space while still making the menus and/or additional information readily accessible through a quick swipe gesture. This hide/show interpretation of the horizontal swipe is most applicable when the available pixel resolution of the client viewport is limited. For example, handheld client devices such as PDAs or cell phone with bit-map displays have relatively small client viewports.

Drag

A drag is interpreted as either a panning or scrolling navigational action on the current representation. A panning operation is interpreted as dragging the associated client display surface within the client viewport. As such, a panning operation will appear to drag the client display surface within the client viewport along the same direction as the drag. A scrolling operation is interpreted as moving the client viewport along the client display surface (without moving the client viewport's location within the client's bit-map display device). The decision between pan and scroll can be determined by a modifying selection action or cue, through user preferences and/or through one or more software interface(s).

In an illustrative embodiment, the pan or scroll operation can be continued by either continuing the drag outside the client viewport, or by a hold gesture at the edge of the client viewport. With a hold gesture, the release of the holding gesture ends the continued pan or zoom operation.

In an illustrative embodiment, a drag at the overview level of a multi-level set is given a special interpretation. It is interpreted as selecting a “region of interest” for a special selection action. In an illustrative embodiment of the present invention, the special selection action is a request for:

a) rasterizing (or rendering) the corresponding “region of interest” of the “next detail”, which can result in a partial rasterized representation of the “next detail”, and

b) displaying this rasterized “next detail” representation (full or partial) to the user (by switching the current viewport to this representation, or showing it in a separate client viewport).

The “region of interest” is similar to that defined by a swipe action, but the drag is more deliberate and therefore can give the user more precision over the selection region. The more deliberate drag gesture is also more suitable than a swipe for expressing the user's intent, particularly when the associated special action can involve considerable processing power and/or communications requirements.

In this illustrative embodiment, a drag on an overview specifically requests the creation of a corresponding rasterized “next detail” representation. If the client determines that this is not currently available (or a cached version is no longer valid), then it initiates a rasterizing (or rendering) function for the corresponding “region of interest”. This can create (or update) a full or partial rendered representation of the “next detail” corresponding to the specified “region of interest”.

In contrast, a vertical swipe gesture is interpreted in this illustrative embodiment to use whatever corresponding “next detail” representation already exists (which may be null). The vertical swipe means: “show me what you have at the corresponding detail level”. The overview drag means: “create the corresponding detail level, if it is not already available”.

The “region of interest” being defined by the drag at the overview level can be echoed to the user as a box (or other type of highlighting) being interactively drawn over the selection region. If the user returns back to the drag's point of origin (within a specified minimum delta) and ends the drag gesture, then the drag can be ignored and no special selection action is performed.

If the user ends the drag on the overview representation, and the drag region is above a specified minimum size, then a special selection action is performed. In this illustrative embodiment, this is interpreted as a request for rasterizing (or rendering) the selected “region of interest” of the “next detail”. In a multi-modal set, the mode of the requested detail level can be based on the “next detail” state variable, or through an automated context-sensitive determination of the mode from the selected “region of interest”.

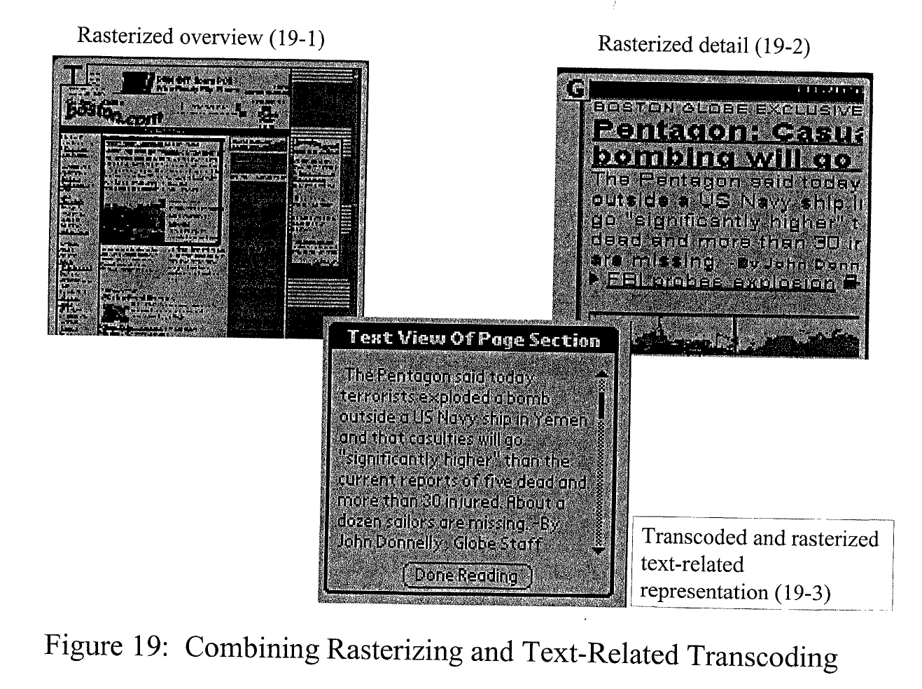

FIG. 19 illustrates a drag on an overview representation (19-1) and the resulting multi-level detail representation (19-2) within a client viewport. When the “next detail” is for a text-related representation, the same overview drag (19-1) can generate (if needed) and display a rasterized text-related representation (19-3) assigned to the detail level.

Tap

In an illustrative embodiment, a tap at any level other than the overview level can be interpreted in a context-dependent fashion. That is, the client can determine the meaning of the tap based on context information. Context information can include the software state maintained by the client, the type of content represented by the bit-map associated with the tap, and/or the pixel location in the bit-map specified by the tap. One such context-dependent interpretation is described above in the section “Selection-List Mode”.

Also in an illustrative embodiment, a tap gesture at the overview level can be interpreted the same as a vertical swipe, and the pixel location of the tap is used as the region of interest.

Double-Tap

A “double-tap” gesture consists of two sequential tap gestures within a specified “double-tap” time-out interval. In an illustrative embodiment, the recommended time-out interval is 500 milliseconds or less. A mouse button double-click and a pen double-tap are examples of possible “double-tap” gestures. In an illustrative embodiment, a “double-tap” gesture can be interpreted as either an “alternate input-mode” gesture, or a request to switch to pop-up menu mode.

If the client supports “double-tap”, it is able to differentiate a “double-tap” from a “tap” gesture. This can be done if the tap gesture is not processed until the double-tap time-out interval is reached or exceeded. For example, after a “tap” has been recognized the client can request that a timer event be sent when the double-tap time interval is reached or exceeded. If the timer event arrives before another tap gesture is recognized, then the tap can be processed. If a second tap gesture is recognized before the time interval, the double-tap can be processed. The client can also require that the pixel location of the second tap of a “double-tap” gesture be within a minimum distance from the first “tap” location.

Hold

A hold gesture is equivalent to a hover gesture, but in selection mode. If the pointing device remains in selection mode and stays at the same location (or within a small radius of this location) for more than the “hold start” time-out interval, then a hold gesture is recognized. In an illustrative embodiment, the recommended “hold start” time-out interval is 500 milliseconds.

The interpretation of a hold gesture depends on whether the hold is considered an independent gesture or part of a combined gesture. A combined gesture associates one gesture with a subsequent gesture. For example, the “swipe and hold” and “drag and hold” gestures (as previously described) are combined gestures. With a combined gesture, the pointing device remains in selection mode between gestures. By not leaving selection mode, there is an implied continuity between gestures. If the pointing device does not remain in selection mode, then the gestures are considered independent.

If the hold gesture is considered an independent gesture, then an illustrative embodiment treats it as an context-dependent input-mode gesture. The context is determined by any state variables (including those set by user preference or indirect user actions), the level and mode of the current representation, and the content related to the current pointer location.

In an illustrative embodiment, a hold gesture at an overview or intermediate level is considered a request for displaying a portion of a corresponding “reveal mode” representation. This is a request for a “reveal” of the corresponding portion of the “reveal representation”, 1 as previously described in the section “Hover”.

Also in an illustrative embodiment, a hold gesture at a detail level is considered part of a “pick” gesture. The “pick” gesture is described in the next section.

Pick

In a “pick” gesture, a “hold” is continued until it is confirmed as a “pick”. The “confirm” is a continuation of the “hold”, at the same location, beyond the “pick confirm” time-out interval. The “confirm” is completed when the user ends the extended “hold” without moving the current location (within a specified delta pixel threshold, typically 2 pixels or less in either the horizontal or vertical dimensions).

When the “pick confirm” time-out interval is exceeded, and the user ends the extended “hold” at the same location, the “hold” is interpreted as a “pick”. If the user ends the “hold” gesture before the “pick confirm” time-out interval, or moves the location before the “pick confirm” time-out interval ends, then the “pick” gesture is canceled.

The purpose of a pick is to identify a location within a client viewport (through the hold), and then signify that a context-dependent selection action should be performed with respect to that location (by continuing the “hold” through the “pick confirm” time interval). The length of the hold required for a “pick” makes the pick a more deliberate gesture than a swipe, drag, tap or hold. The user maintains the hold at the same location until the “pick confirm” interval is exceeded, or the pick gesture is canceled.

The “pick confirm” interval starts after the “hold start” interval ends. The “pick confirm” interval can be variable, based on a context-dependent interpretation of the visual content corresponding to the location. For example, if this location corresponds with a hyperlink, then the “pick” will trigger an action that may take considerable processing and/or communications time. In this case, the “pick confirm” can be longer (typically an additional 400 to 800 milliseconds beyond the “hold start”).

If this location corresponds to a visual control that can be handled locally by the client, then the “pick confirm” interval can be very short or even zero. The client can even reduce the “hold start” time, performing the appropriate action(s) before a “hold” gesture is recognized. This improves perceived responsiveness to gestures that can be handled locally, while reserving the longer “pick” interval for actions that can more noticeably impact the user or the system.

The “pick” gesture can provide the user with visual feedback between the “hold start” and “pick confirm” intervals. During the period between the “hold start” and “pick confirm”, the client can provide visual and/or audio feedback that a “pick” gesture is underway. For example, the client can display a pixel region surrounding the current location as “blinking”, by switching between a standard and reverse video display of the region over a regular time interval (such as cycling every 400 milliseconds). If the visual feedback is provided at or near the pick location, the user also gets visual confirmation of the pick location.

If the client determines that there is no visual control or action corresponding to the location being picked, it can provide visual or audio feedback that this is not a location that can be picked. This feedback can be a specific type of feedback (like an audible “error” tone, or error message), or the absence of feedback that a “pick” gesture is underway. By not providing the expected “pick underway” feedback, the user can understand that the absence of this feedback means that the location cannot be picked.

When the “pick end” interval is reached, the client determines whether to automatically confirm or automatically cancel the pick. The “pick end” interval is recommended to be at least 2 seconds after the “pick confirm” interval is reached. For a valid “pick” location (a location that has a corresponding action), exceeding the “pick end” interval can automatically confirm the “pick” gesture. If this is not a valid “pick” location, exceeding the “pick end” interval can automatically cancel the “pick” gesture. In either case, audio or visual feedback can be provided that the pick gesture was automatically confirmed or cancelled.

When a context-dependent selection action is likely to generate significant processing and/or networking activity, it can be advantageous to provide a more deliberate selection gesture than either a tap or swipe. With a pick gesture, the user is better able to avoid the penalty for an accidental tap or swipe, or accidentally tracing one type of swipe instead of another.

Accidental taps or swipes are more likely in pen-based (or touch-sensitive) user interface styles, where the pen or finger accidentally brushes across a pressure-sensitive surface. In mouse/keyboard style interfaces, selection actions typically require a mouse-button press or key press, making accidental taps and swipes less likely. In an illustrative embodiment, a pick gesture is recommended for context-dependent selection actions in a pen-based user interface style, while a tap and/or horizontal swipe gesture is recommended for context-dependent selection actions in a mouse/keyboard user interface style.

The advantages of a pick gesture are particularly important for clients with lower relative processing power, battery-powered devices (where power drain is a major issue), and/or networks that have lower relative bandwidth and/or higher relative latencies. For example, in a hand-held device communicating through a wireless network, context-dependent selection actions can generate processing and network activities that drain battery power and cause delays waiting for network responses. By using the more deliberate pick gesture, the user has better control over initiating these selection actions.

The client can provide visual and/or audio feedback when the “hold start” interval is exceeded and the start of a “pick” gesture has been recognized. This gives the user feedback that the start of a pick gesture has been recognized and that the user can complete the pick gesture. If the visual feedback is provided at or near the pick location, the user also gets visual confirmation of the pick location.

When the “pick confirm” interval is reached, the user can either:

a) complete the pick gesture (by ending the hold gesture without changing the location, within the specified delta pixel threshold),

b) cancel the pick gesture (by changing the location beyond the delta pixel threshold, and then ending the hold gesture), or

c) continue holding until a pick gesture is either automatically recognized or automatically cancelled (by exceeding a “pick end” interval).

Special Input Modes and Input-Mode Gestures

In addition to location mode and selection mode, “special” input modes can be supported. These additional modes can include:

a) alphanumeric mode: in this mode, certain user interface actions are interpreted as specifying alphanumeric input characters,

b) selection-list mode: in this mode, certain user interface actions are interpreted as specifying one or more selections within a pop-up selection list

c) pop-up menu mode: in this mode, certain user interface actions are interpreted as requesting a pop-up menu of input choices, and

d) mark-up mode: in this mode, certain user interface actions are interpreted as specifying mark-ups to a bit-map pixel representation being displayed.

As previously described, there are multiple ways for the client to change input modes. One such method is for the client to support special input-mode gestures. If the client supports special input-mode gestures, these are interpreted as user requests to change from one input mode to another.

Special input-mode gestures are implementation dependent, and can include context-dependent interpretations of certain location and/or selection gestures. In an illustrative embodiment, an “alternate input-mode” gesture is recommended for switching into (and out of) input modes other than location mode and selection mode. For example, a “double-tap” can be used as the “alternate input-mode” gesture. A double-tap gesture can be implemented in a pen-based user interface as two pen taps in rapid succession (each a quick pen-down/pen-up gesture). In a mouse/keyboard user interface, a double-tap gesture can be implemented as either a left or right mouse-button double-click (reserving the other mouse-button double-click for other purposes).

In an illustrative embodiment, the “alternate input-mode” gesture switches the input mode from either location mode or selection mode into the preferred alternate input mode. The preferred alternate input mode can be selected from any supported special input mode (such as alphanumeric mode, selection-list mode, pop-up menu mode or mark-up mode). The same “alternate input-mode” gesture can then be used to switch back to the previous location mode or selection mode.

In an illustrative embodiment, the preferred alternate input mode can be based on any or all of the following:

a) history (e.g. the last alternate input mode used),

b) software settings,

c) user preferences (e.g. displaying a pop-up set of choices), and/or

d) context-dependent data (such as the type of bit-map pixel representation being displayed, or the current location within the bit-map).

Alphanumeric Mode

A switch to alphanumeric mode can be used to interpret subsequent gestures as handwriting gestures, for input to a handwriting recognition function (such as the Graffiti system on a PalmPilot device). This is particularly relevant to a pen-based user interface implementation of the present invention, although handwriting recognition can be used with a mouse or other pointing device.

In an illustrative embodiment, the location of the pointing device before the switch to alphanumeric mode can be used as the anchor point for displaying the entered text. This location can be set, for example, from the gesture (such as an alternate input-mode gesture) that switches the input mode to alphanumeric mode. If this location corresponds to the location of a rendered alphanumeric input visual control, then the client can send the entered text to the processing function(s) associated with that visual control.

Also in an illustrative embodiment, the client can echo handwriting gestures by drawing the corresponding strokes on the bit-map display device. These can be displayed as an overlay, over whatever other bit-map(s) are being displayed, with the overlay removed as each character is recognized and/or when exiting alphanumeric mode.

Selection-List Mode

A switch to selection-list mode can be done through a specific input-mode gesture. One such gesture is a tap gesture on a pixel location that the client has associated with a selection list. When the client enters selection mode, it can display a pop-up list of available selections. Location and selection actions with pixel locations within the displayed selection list can be interpreted as selection-list location and selection gestures, and the client can provide appropriate visual feedback.

The client determines when to exit selection-list mode. This can be done based on criteria such as the user making a selection, the movement of the pointing device outside the pop-up selection area, or reaching a specified time-out interval.

Pop-up Menu Mode

In some client implementations of the present invention, a specific input-mode gesture is provided for switching to pop-up menu mode. For example, a right mouse-button click is the commonly used gesture on Microsoft Windows® platforms for requesting a pop-up menu. Another example is interpreting a hold gesture as a request for a pop-up menu.

When the client enters pop-up menu mode, it can display the appropriate pop-up menu. Location and selection actions with pixel locations within the displayed selection list can be interpreted as pop-up menu location and selection gestures, and the client can provide appropriate visual feedback.

The client determines when to exit pop-up menu mode. This can be done based on criteria such as the user making a selection, the movement of the pointing device outside the pop-up menu area, or reaching a specified time-out interval.

Mark-up Mode

A switch to mark-up mode can be used to interpret subsequent gestures as mark-up gestures. In an illustrative embodiment, these can be visually echoed as overlays drawn on the bit-map display. Mark-up overlays can further processed by the client when the user exits mark-up mode, and subsequently erased based on a user or software decision (restoring the underlying pixels that may have been occluded by the mark-up gestures).

In an illustrative embodiment of mark-up mode, the user is using mark-up gestures to generate new visual content related by the client to the bit-map pixel representation(s) being marked up. The client determines how to further process the mark-up, including how to relate the mark-up to the bit-map(s) being marked up.

Audio Feedback

The client can provide audio feedback for selected gestures. This can be done in addition, or as an alternative, to visual feedback. Audio feedback can help confirm to the user that the client has recognized certain gestures. It can also be used during a gesture to provide feedback on the choices available to the user in completing, continuing and/or canceling the gesture. In an illustrative embodiment, audio feedback is recommended for swipe gestures, pick gestures, and any supported input-mode gestures (including any “alternate input-mode” gesture).

Audio feedback can be helpful when a gesture is not valid or can no longer be processed. For example, a “swipe up” on an overview representation is typically not meaningful (when “swipe up” means select or switch to the next lower level of the bit-map set). In another example, when a drag gesture has nothing more to drag the user may appreciate being notified. In either case, appropriate audio feedback can be used to alert the user.

Interpreting Events into Gestures

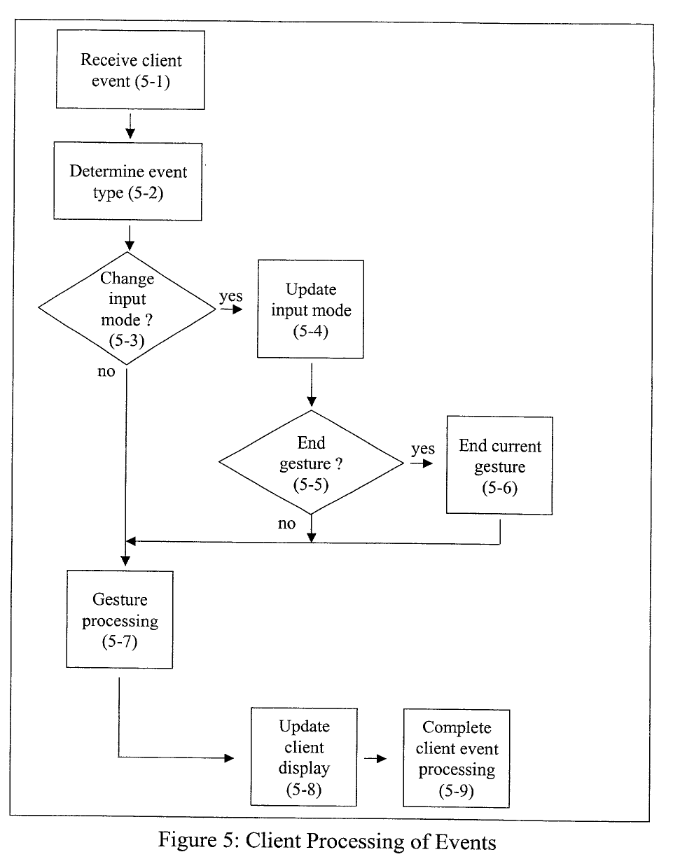

FIG. 5 is a flow chart for exemplary client software processing of events in an illustrative embodiment of the invention. The client software maintains information about the “current gesture” in one or more state variable(s). The current gesture is the gesture currently being expressed by the user as a sequence of one or more user interface actions. Each user interface action is represented by one or more client event(s). The current gesture can be “none”, if the client software has not yet detected the start of a new gesture.

In addition to the current gesture, the client software can also maintain a “pending” gesture. A pending gesture is a gesture that has ended (in terms of associated user interface events), but has not been completely processed. Pending gestures can be used when the meaning of a gesture depends in part on a subsequent gesture and/or the expiration of a time-out interval. For example, a “tap” gesture can be pending while determining if it is part of a “double-tap” gesture. If it is subsequently determined not to be part of a “double-tap”, then it can be processed as a tap gesture. Otherwise, it is processed as part of the double-tap.

The processing begins with the client software receiving a client event (5-1). This event can be generated by the client's operating system, by a function supplied by the client software, or by some other client software that is capable of communicating events to the client software. These events can be user interface events, timer events or other events supported by the client software.

In an illustrative embodiment, a client event is fully processed before another event is received. This ensures that events are handled sequentially, and that any side effects of event processing are applied in the proper order. The receipt of additional client events is temporarily disabled during the “receive client event” (5-1) step and then re-enabled during the “complete client event processing” (5-11) step. Depending on the implementation of client software, additional events received during client event processing can either be queued for later processing or they can be ignored.

The next step is to determine the event type (5-2). The event type can be a location event, selection event, timer event or other event type. The event type and related event information can be used in subsequent steps of client event processing.

The client software determines if it should change the input mode (5-3) before gesture processing (5-7). This decision can be based on the type of event, data associated with the event, and/or one or more software state variable(s). Input mode can be changed before gesture processing in order to:

a) end the current gesture (or process the pending gesture) based on the change in input mode, and/or

b) prepare for gesture processing (5-7).

For example, the client software may switch to alphanumeric mode when it receives an alphanumeric key-press and is not currently in alphanumeric mode. In another example, the client may detect one or more special modifier(s) within an event-related data (such as a right mouse-button press) that triggers a switch to a special input mode (such as pop-up menu mode).

If the client software decides to change the input mode before gesture processing, then the client software updates the input mode (5-4) to the new mode. Updating the input mode can include providing any visual and/or audio feedback associated with this change. Any time the client software switches input mode, it can choose to save the previous input mode. This allows the client software to revert to a previous input mode as needed. For example, the client software may decide to revert to the previous location or selection mode after entering and then leaving a special input mode.

After updating the input mode (5-4), the client software determines if it should end the current gesture (5-6) before gesture processing (5-7). This decision is based on whether there is a current (or pending) gesture, and whether a change in input mode should be interpreted as the implicit end of the current gesture (and/or as a trigger to process the pending gesture). If the current gesture should be ended (or pending gesture should be processed), then the “end current gesture” function (5-6) is performed. This function is further described below in the section “Ending the Current Gesture”.

The client software proceeds to gesture processing (5-7), which is further described below in the section “Gesture Processing”.

The function of updating the client display (5-8) is shown as the next step in the flowchart. However, this step can be done at any time after receiving the client event (5-1), or be divided into sub-steps that are processed during and/or after selected steps shown in FIG. 5.

The client display update function (5-8) makes any appropriate changes or updates to the client display in response to receiving the client event, and to reflect the current gesture (if any). This can include changes or updates to the client display surface, client viewport and/or other pixels in the client's bit-map display. Updates can be applied as necessary to multiple client display surfaces (e.g. for displaying different levels of a multi-level set of bit-maps) and/or to multiple client viewports.

The final step is to complete the client event processing (5-9) by performing any other functions related to processing a client event. This can include functions such as updating data element(s) and/or data structure(s), providing additional user interface feedback (such as audio feedback or status lights), and/or enabling or disabling the receipt of additional client events.

Ending the Current Gesture

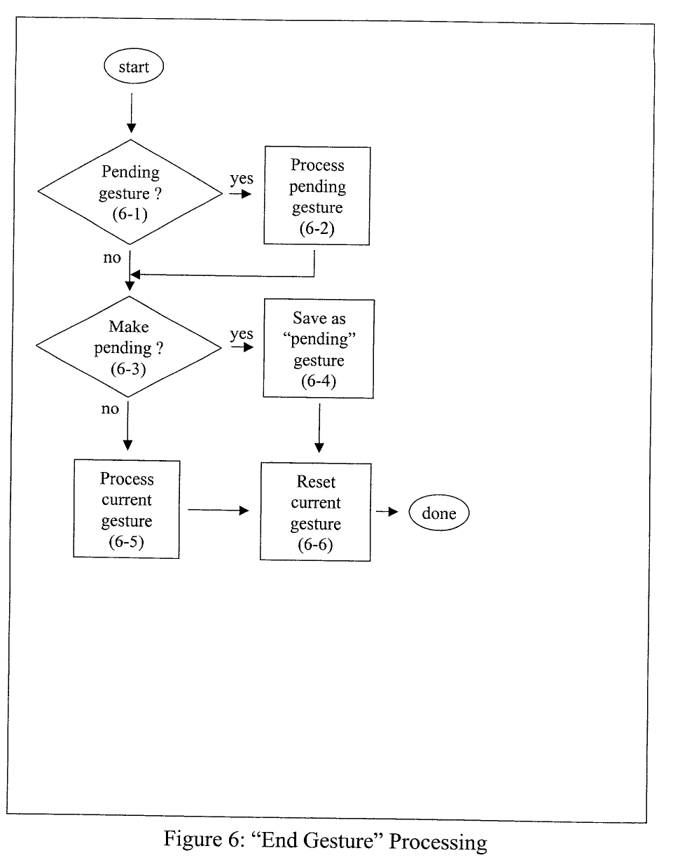

Exemplary client processing of the “end current gesture” function, in accordance with an illustrative embodiment, is shown in FIG. 6. Ending the current gesture starts with determining if there is a pending gesture (6-1). If there is a pending gesture, this gesture is processed first. Processing the pending gesture (6-2) performs any gesture-related functions associated with the pending gesture. Gesture-related functions can include client processing based on the interpreted meaning of the gesture. It can also include any visual and/or audio feedback indicating that the gesture has been processed. After the pending gesture is processed, it is reset to “none” and any related time-out interval(s) are also reset to “none”.

The processing of the pending gesture (6-2) can depend on the current gesture. For example, a pending “tap” gesture can be interpreted as part of a “double-tap” gesture if both the pending and current gestures are compatible “tap” gestures. If the processing of the pending gesture depends on the current gesture, this processing can be deferred until the current gesture is processed. State variable(s) associated with the current gesture can be modified to reflect a combination with the pending gesture, before the pending gesture is reset to “none”.

After processing the pending gesture (if any), the client software determines if the current gesture should be processed (6-5) or instead saved as a new “pending” gesture (6-4). This decision is based on information such as the type of the current gesture, data associated with the current gesture (including data from processing a previous pending gesture), the current input mode, and/or other client software state variable(s).

If the current gesture is saved as the “pending” gesture (6-4), then information associated with the current gesture is used to set or modify data variables associated with the pending gesture. Saving the current gesture as the pending gesture essentially defers processing of the current gesture.

If the current gesture is not saved as the pending gesture, then the client software processes the current gesture (6-5). Processing the current gesture (6-5) performs any gesture-related functions associated with the current gesture. Gesture-related functions can include client processing based on the interpreted meaning of the gesture. It can also include any visual and/or audio feedback indicating that the gesture has been processed.

The final step in the “end current gesture” function is to reset the current gesture to “none”. If the current gesture has any associated time-out interval(s), each interval is also reset to “none”.

Event Lists

Gestures are interpreted from a sequence of one or more event(s). In an illustrative embodiment, an event list can be used to track the sequence of one or more event(s) that compose a gesture. A new event list starts with no events. Entries are added to the event list in the sequence that events are processed. As each event is added to the event list, exemplary gesture processing can use the event list to determine if a gesture has started, is continuing, or is completed or cancelled. As the gesture starts, continues, or is completed or cancelled, processing functions associated with the gesture can use the event list as inputs.

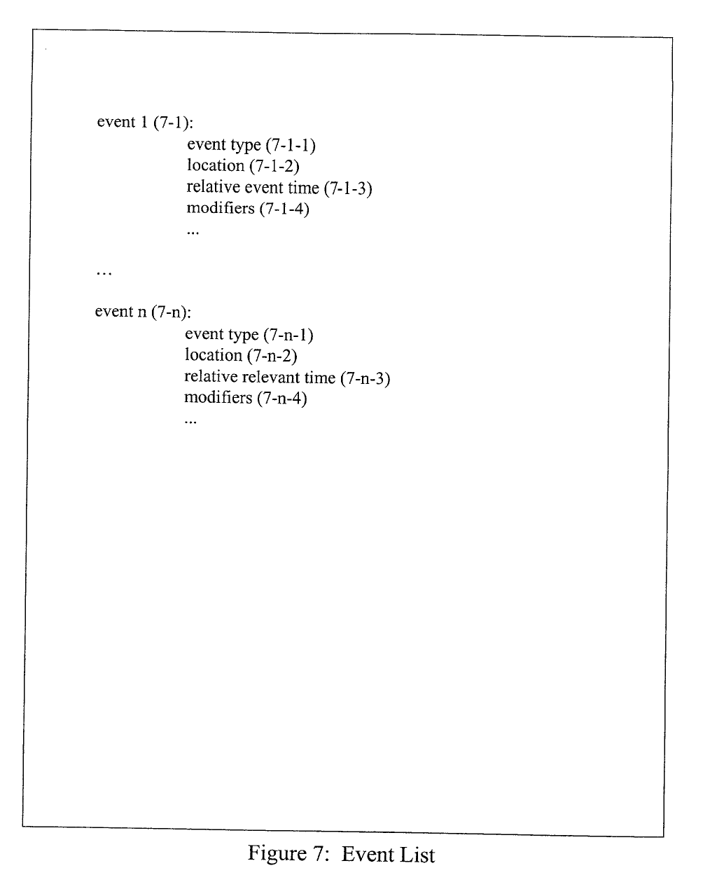

An exemplary event list, in accordance with an illustrative embodiment, is shown in FIG. 7. Each entry (7-1 through 7-n) in the event list corresponds to an event. An entry in the event list can include data associated with the event, such as the event type (7-1-1), associated pixel location (7-1-2), relative event time (7-1-3), and modifiers associated with the event (7-1-4).

The event list can be started before a gesture is recognized, since a gesture can begin before it is recognized (e.g. swipe and pick gestures). Also, multiple gestures can begin with the same event sequence (e.g. hold and pick gestures). When a gesture is recognized, exemplary gesture processing can either use the current event list, start a new event list, or remove any events from the beginning of the list that are not considered part of the gesture. After a gesture is completed or cancelled, the event list can be cleared or a new event list started.

The event list for a pending gesture can be saved, for use when the pending gesture is processed. Event lists can also be saved as a log of event sequences, for later analysis or automated “replay” of events captured in the event list.

Gesture Processing

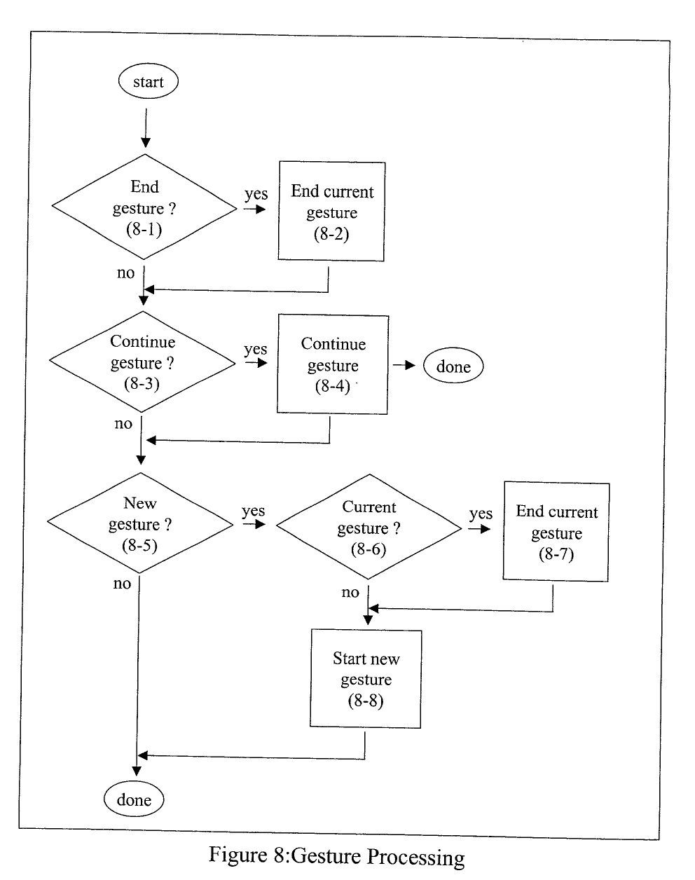

Exemplary gesture processing, in accordance with an illustrative embodiment, is shown in FIG. 8. The client software decides (8-1) if the event represents the end of the current gesture (if there is a current gesture), or a signal to process the pending gesture (if there is a pending gesture). Any or all of the following can be used as the basis for this decision:

a) a location or selection event that specifically ends the current gesture,

b) a location or selection event that starts a new gesture (and therefore implicitly ends the current gesture), and

c) a timer event where the client software determines that a gesture time-out interval has elapsed.

If the event represents the end of the current gesture, then the client software ends the current gesture (8-2). This performs any additional processing associated with completing the gesture (and/or processing the pending gesture). The processing can include any visual and/or audio feedback indicating that the gesture has ended. The “end current gesture” function (8-2) has been previously described in the section “Ending the Current Gesture”.

The client then decides if the event represents a continuation of the current gesture (8-3). This is determined based on information such as the type of event, event-related data, the type of the current gesture, and data related to the current gesture. Only certain gestures can be continued, and each gesture defines the events that can continue the gesture.

If the gesture is continued by the event, the client software performs any functions associated with continuing the current gesture (8-4). This step can update any state variable(s) related to the current gesture, to reflect the event being processed. For example, if the current gesture is tracing a path over a client viewport, then each event's associated location can be added to a location vector that defines this path. If the “continue gesture” function (8-4) is performed, gesture processing is done for this event.

If the gesture is not continued by the event, then the client software determines if the event represents the start of a new gesture (8-5). This decision is based on information such as the type of event, event-related data and software state variable(s). If the event represents the start of a new gesture, the client software determines if there is already a current or pending gesture. If so, “end current gesture” (8-7) processing is done, as previously described in step (8-2).

If the event represents the start of a new gesture, then the client software starts the new gesture (8-8). Starting a new gesture includes setting the current gesture to the new gesture, and setting any associated gesture time-out interval(s). Starting a new gesture can also include providing any visual and/or audio feedback associated with starting a new gesture.

Exemplary gesture processing, in accordance with an illustrative embodiment, can be further described with respect to the current input mode and event type. The current input mode and event type can be used as inputs to the decisions made during gesture processing. These further descriptions are provided below in the sections “Location Mode Gesture Processing”, “Selection Mode Gesture Processing” and “Special Input Mode Gesture Processing”.

Location Mode Gestures

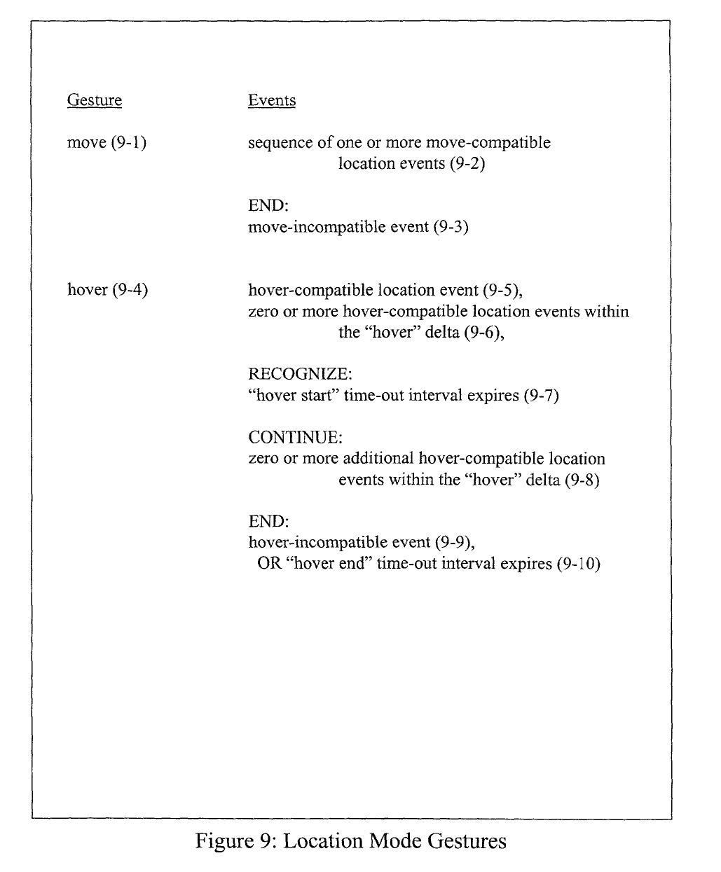

FIG. 9 is a chart summarizing exemplary interpretation of events into location mode gestures, in accordance with an illustrative embodiment. The chart shows each gesture, the event(s) that start and/or continue the gesture, and event(s) that end the gesture. For certain gestures, the chart shows the event(s) used to recognize the gesture and then continue after the gesture is recognized.

Certain events are considered “compatible” or “incompatible” with a gesture. The compatibility or incompatibility of an event with a gesture is determined within each client implementation. This can be determined based on information such as:

a) the type of gesture,

b) the type of event,

c) the location associated with the event,

d) modifiers associated with the event,

e) the relative event time,

f) other event-related data,

g) previous events in the event list,

h) the current input mode, and/or

i) other software state variable(s) accessible to the client software.

For example, a selection event is incompatible with a move or hover gesture and therefore will end either gesture. An event with a location outside the current client viewport is also typically classified as incompatible with the current gesture. A location event within the current client viewport is usually compatible with a move or hover gesture, but an event modifier might make that event incompatible with the gesture.

A move gesture (9-1) starts with a move-compatible location event (9-2), and can continue with additional move compatible events (9-2). The move gesture ends with a move-incompatible event (9-3).

A hover gesture (9-4) starts with a hover-compatible location event (9-5). The client implementation of the hover gesture defines a maximum “hover” delta, the maximum number of pixels in both the vertical and horizontal directions that the pointing device can traverse while still continuing the hover. This delta allows the pointing device to wobble a certain amount without ending the hover gesture. The hover gesture continues if any hover-compatible events are received with a location within the hover delta (9-6).

The hover gesture is recognized when a “hover start” time-out interval expires (9-7). This interval time-out is computed with respect to the relative time of the first hover-compatible location event (9-5). Until the gesture is recognized, the events in the event list are not identified as a hover gesture. These events could be part of a move gesture or other gesture. Processing functions associated with the hover gesture are not begun until the hover gesture is recognized.

After the hover gesture is recognized, the gesture can continue with any number of hover-compatible location events with locations within the “hover” delta (9-8). The hover gesture ends with a hover-incompatible event (9-9) or when an optional “hover end” time-out interval expires (9-10). The optional “hover end” time-out interval is computed with respect to the relative time when the “hover start” time-out interval expired (9-7). The “hover end” time-out interval can be used to prevent hover gestures from continuing indefinitely.

Location Mode Gesture Processing

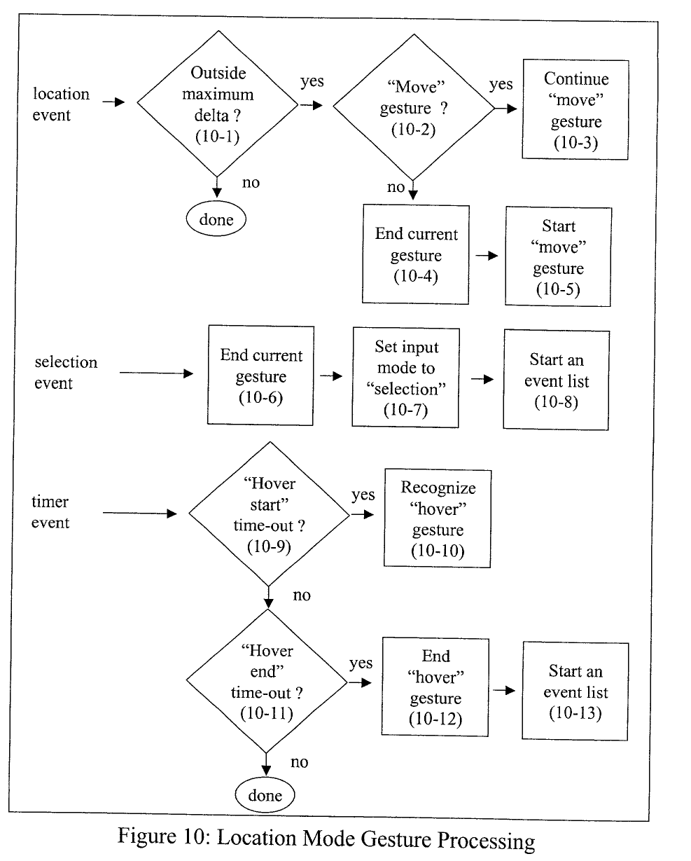

FIG. 10 illustrates exemplary gesture processing, in accordance with an illustrative embodiment, when the current input mode is location mode. FIG. 10 shows three different processing flows, based on the type of event.

If the event is a location event, processing begins by determining if the current location is within the maximum delta (10-1). The current event's location is compared to the location of the first event (if any) in the event list. The recommended maximum delta is a maximum distance, in pixels, over both the horizontal and vertical dimensions. In an illustrative embodiment, the recommended maximum delta is no more than two (2) pixels in each dimension.

If the event's location is outside the maximum delta, then processing continues. If the difference in locations is within the maximum delta, then processing ends. If event list is empty (or there is no event list), then a new event list is started using the current event as the event list's first entry and processing ends.

If the difference exceeds the recommended maximum delta (10-1), then the client software determines if the current gesture is a “move” gesture (10-2). If so, the move gesture is continued (10-3), which includes adding the current event to the event list. If not, the client software ends the current gesture (10-4) as described above in the section “Ending the Current Gesture”. Then client software then starts a new “move” gesture (10-5). This sets “move” as the current gesture, sets any time-out interval(s) associated with a move gesture, and starts a new event list using the current event as the event list's first entry.

If the event is a selection event, the client software ends the current gesture (10-6) in a manner similar to that described in (10-4). The client software then sets the input mode to “selection” (10-7). The client software can also set any time-out intervals associated with selection mode, such as a “tap” time-out interval and/or “hold” time-out interval (as further described below in the section “Selection Mode Gesture Processing: Timer Events”). The client software starts a new event list (10-8) using the current event as the event list's first entry.

The type of selection event cannot typically be determined until subsequent events are processed. For example, subsequent events are typically required to differentiate between “swipe”, “drag” and “tap” gestures that all start with a single selection event. But if the client software can determine the type of gesture from this event, it can set the current gesture to this gesture type.

If the event is a timer event, the client software determines if a “hover start” time-out interval has elapsed (10-9). If so, the client recognizes a “hover” gesture (10-10), indicating that the user is currently hovering over a specific location within the associated client viewport. In an illustrative embodiment, the recommended minimum hover interval is two (2) seconds.

When starting a hover gesture, the client software can set the recommended maximum delta to a hover-related value. In an illustrative embodiment, the recommended maximum hover delta is no more than four (4) pixels in one dimension. A higher hover maximum delta decreases the sensitivity to wobbles in pointer location during the hover gesture, requiring a larger movement to end the hover gesture. Alternatively, the hover maximum delta can be the same as or less than the standard maximum delta.

If a “hover start” time-out interval has not elapsed, the client software determines if a “hover end” time-out interval has elapsed (10-11). If so, the client software ends the current hover gesture (10-12) in a manner similar to that described in (10-4), including resets of“hover start” and “hover end” time-out intervals to “none”. The client software starts a new empty event list (10-13), or clears the current event list.

Selection Mode Gestures

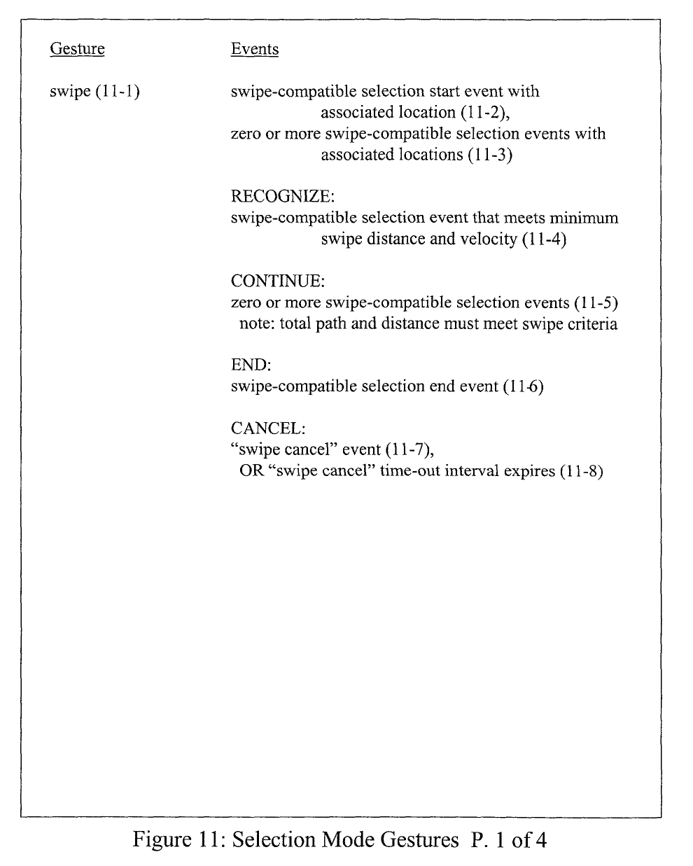

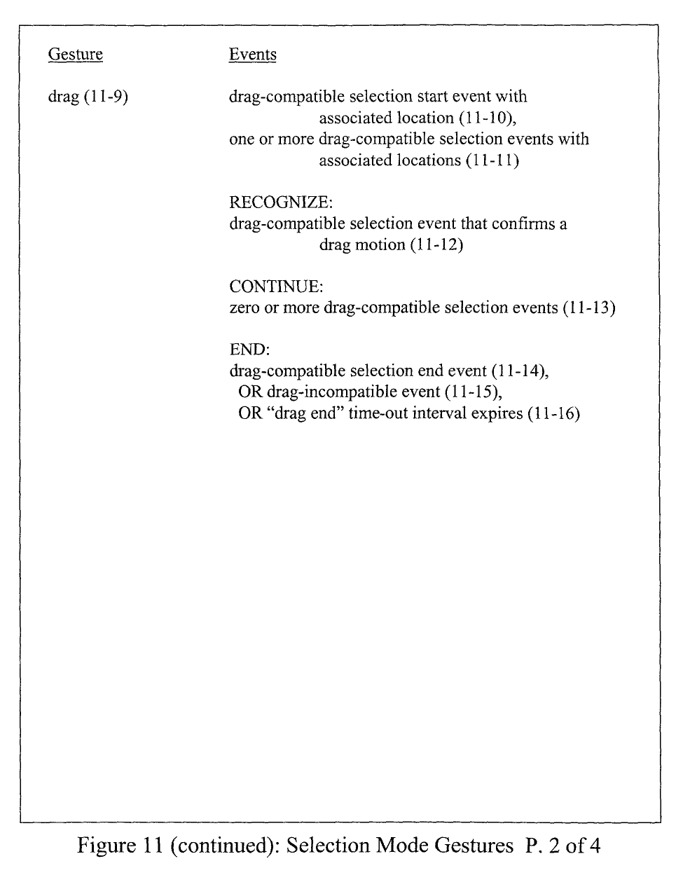

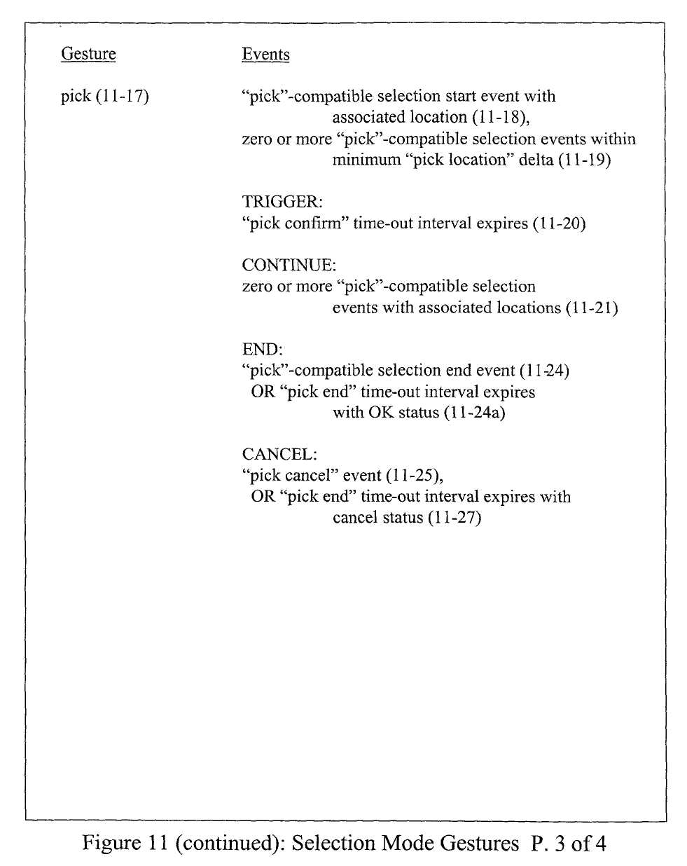

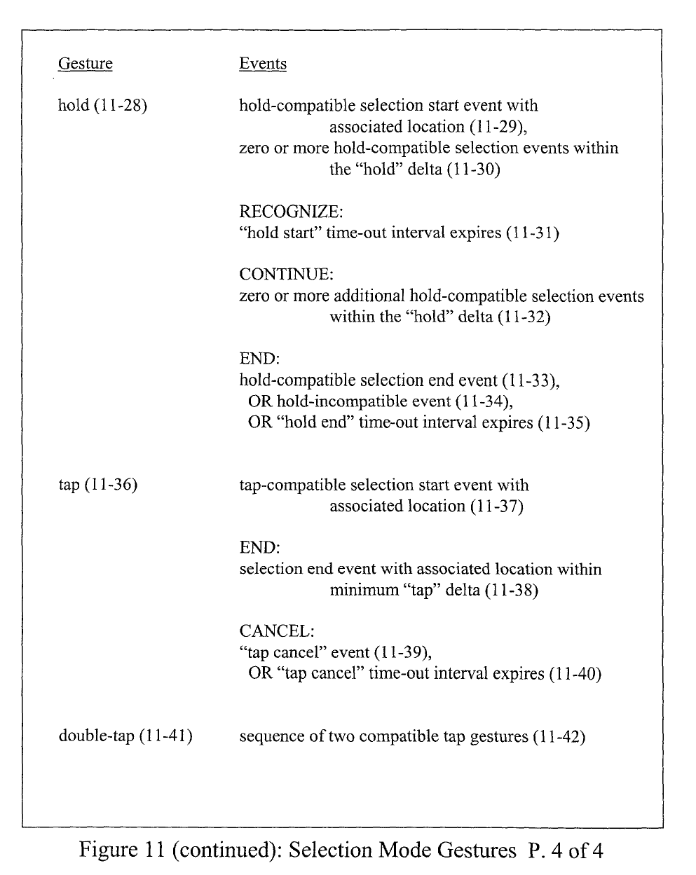

FIG. 11 is a chart summarizing exemplary interpretation of events into selection mode gestures, in accordance with an illustrative embodiment. The chart shows each gesture, the event(s) that start and/or continue the gesture, event(s) that end the gesture, and (for certain gestures) events that cancel the gesture. For certain gestures, the chart shows the event(s) used to recognize the gesture and then continue after the gesture is recognized. The “pick” gesture also defines a trigger event, which helps differentiate the pick from a hold gesture.

Certain events are considered “compatible” or “incompatible” with a gesture. The compatibility or incompatibility of an event with a gesture is determined within each client implementation. A compatible event can start or continue a gesture, while an incompatible event ends the gesture. This is further described above in the section “Location Mode Gesture Processing”.

Selection Mode Gestures: Swipe

A swipe gesture (11-1) starts with a swipe-compatible selection start event (11-2). A selection start event is an event with one or more modifier(s) that indicate the start of a selection. For example, pen-down and left mouse-button down are typical indicators of the start of a selection. In addition to event modifiers, other event-related data or other software state variable(s) can be used to determine if the event is a selection start event. The selection start event has an associated location to start a swipe event.

The swipe gesture can continue with any number of swipe-compatible selection events (11-3). The swipe gesture is recognized when a swipe-compatible selection event meets the minimum swipe distance and velocity requirements (11-4). The swipe can be continued with any number of swipe-compatible selection events (11-5), provided the total path and average velocity criteria for the total swipe path are still being met.

The swipe gesture ends with a swipe-compatible selection end event (11-6). A selection end event is an event with one or more modifier(s) that indicate the end of a selection. For example, pen-up and left mouse-button up are typical indicators of the end of a selection. In addition to event modifiers, other event-related data or other software state variable(s) can be used to determine if the event is a selection end event.

Depending on the client implementation, processing functions associated with the swipe can be done either when the swipe is recognized or when the swipe ends.

The swipe gesture is cancelled by a “swipe cancel” event (11-7). This can be a swipe-incompatible event, or any event that the client software recognizes as canceling the swipe gesture.

If the swipe gesture is recognized, an optional “swipe cancel” time-out interval can be set. If set, this puts a maximum time limit on completing the swipe gesture. If this time limit expires (11-8), the swipe gesture is cancelled. If a swipe gesture is cancelled, an attempt can be made to interpret the event list as a different gesture. If that is not successful, a new event list is started (or the current event list is cleared).

Selection Mode Gestures: Drag

A drag gesture (11-9) is started with a drag-compatible selection start event (11-10) with an associated location. It can be continued with any number of drag-compatible selection events (11-11) with associated locations. The drag gesture is recognized a drag-compatible selection event confirms a drag motion (11-12). A drag motion is confirmed when the minimum swipe distance has been met, but the velocity of this motion is below the minimum swipe velocity. Any number of drag-compatible selection events (11-13) can continue the drag gesture.

A drag gesture ends with a drag-compatible selection end event (11-14), a drag-incompatible event (11-15) (including an event that confirms a swipe motion), or a “drag end” time-out interval expires (11-16). The optional “drag end” time-out interval prevents a drag gesture from continuing indefinitely.

Selection Mode Gestures: Pick

A pick gesture is an extension of a hold gesture, for a location that has an associated pick action. A pick gesture (11-17) starts with a pick-compatible selection start event (11-18) with an associated location. This starting event determines the location of the pick. If the location has an associated pick action (for example, it corresponds to a hyperlink or an input selection box), then a pick gesture starts. Any subsequent pick-compatible selection events, until the pick is recognized, has a location within the “pick location” delta (11-19). Moving outside this delta (recommended to be 2 pixels in the horizontal or vertical dimensions) cancels the pick gesture.

The trigger event for a pick is when the “pick confirm” interval for the pick expires (11-20). After the trigger event, the pick is continued with zero or more “pick” compatible selection events (11-21) with associated locations. These events are within the “pick location” delta, or the pick gesture is cancelled.

The pick is recognized when a “pick”-compatible selection end event occurs after the “pick confirm” time interval is exceeded. This means that the pick gesture was completed without being cancelled.

A pick can be cancelled at any time by a “pick cancel” event (11-25). A “pick cancel” is any event that cancels the pick gesture before it is successfully completed. For example, a selection end event before the “pick confirm” interval begins can cancel the pick gesture. Moving the location beyond the “pick location” delta can also cancel the pick. “Pick cancel” can include any “pick”-incompatible event, an event that is not compatible with a pick gesture.

If the pick gesture continues beyond the “pick end” time interval (11-26), then the pick gesture is either automatically recognized or automatically cancelled. The pick gesture is automatically recognized (11-24a) if the location is a valid pick location and the pick action can be processed (OK status). It is automatically cancelled (11-27) if the location is not a valid pick location, or the client software cannot process the pick action (cancel status).

If a pick gesture is cancelled, an attempt can be made to interpret the event list as a different gesture. If that is not successful, a new event list is started (or the current event list is cleared).

Depending on the client implementation, processing functions associated with the pick can be done either when the pick is recognized or when the pick ends.

Selection Mode Gestures: Hold

A hold gesture (11-28) starts with a hold-compatible selection start event (11-29) with an associated location. The client implementation of the hold gesture defines a maximum “hold” delta, the maximum number of pixels in both the vertical and horizontal directions that the pointing device can traverse while still continuing the hold. This delta allows the pointing device to wobble a certain amount without ending the hold gesture. The hold gesture continues if any hold-compatible selection events are received with a location within the hold delta (11-30).

The hold gesture is recognized when a “hold start” time-out interval expires (11-31). This interval time-out is computed with respect to the relative time of the first hold-compatible location event (11-29). Until the gesture is recognized, the events in the event list are not identified as a hold gesture. These events could be part of a pick gesture or other gesture. Processing functions associated with the hold gesture are not begun until the hold gesture is recognized.

After the hold gesture is recognized, the gesture can continue with any number of hold-compatible location events with locations within the “hold” delta (11-32). The hold gesture ends with a hold-compatible selection end event (11-33), a hold-incompatible event (11-34) including any event that confirms the gesture as a pick gesture, or when an optional “hold end” time-out interval expires (11-35). The optional “hold end” time-out interval is computed with respect to the relative time when the “hold start” time-out interval expired (11-31). The “hold end” time-out interval can be used to prevent hold gestures from continuing indefinitely.

Selection Mode Gestures: Tap and Double-Tap

A tap gesture (11-36) starts with a tap-compatible selection start event (11-37). The client implementation of the tap gesture defines a “tap” delta, the maximum number of pixels in both the vertical and horizontal directions that the pointing device can traverse while successfully ending the tap. This delta allows the pointing device to wobble a certain amount without canceling the tap gesture. The tap gesture ends with a any tap-compatible selection end event with a location within the tap delta (11-38).

A tap is cancelled by any “tap cancel” event (11-39), any event that the client software recognizes as canceling the tap gesture. This can include any tap-incompatible event. The tap can also be canceled if the “tap cancel” time-out interval expires before the tap is successfully completed (11-40). The optional “tap cancel” time-out interval is computed with respect to the relative time associated with the tap-compatible selection start event (11-37). The “tap cancel” time-out interval places a time limit from tap start to tap end, and also can be used to prevent tap gestures from continuing indefinitely.

If a tap gesture is cancelled, an attempt can be made to interpret the event list as a different gesture. If that is not successful, a new event list is started (or the current event list is cleared).

A double-tap gesture (11-41) is a sequence of two compatible tap gestures (11-42).

Selection Mode Gesture Processing

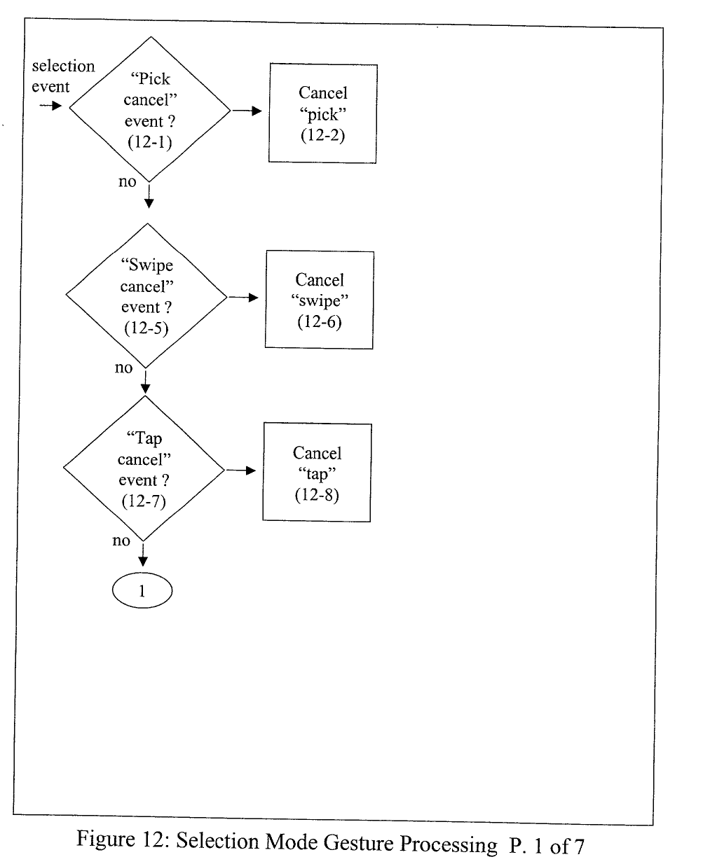

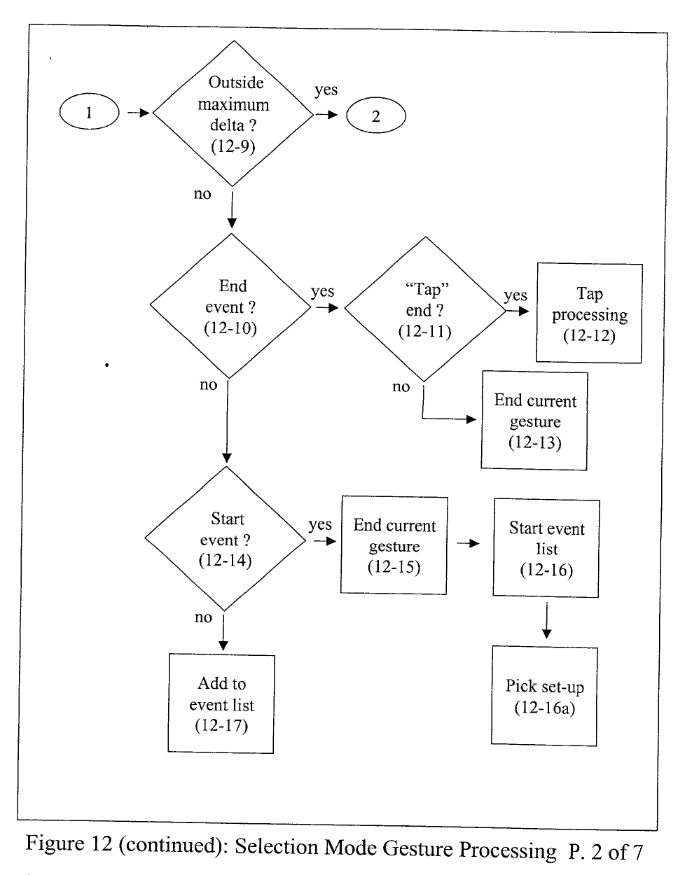

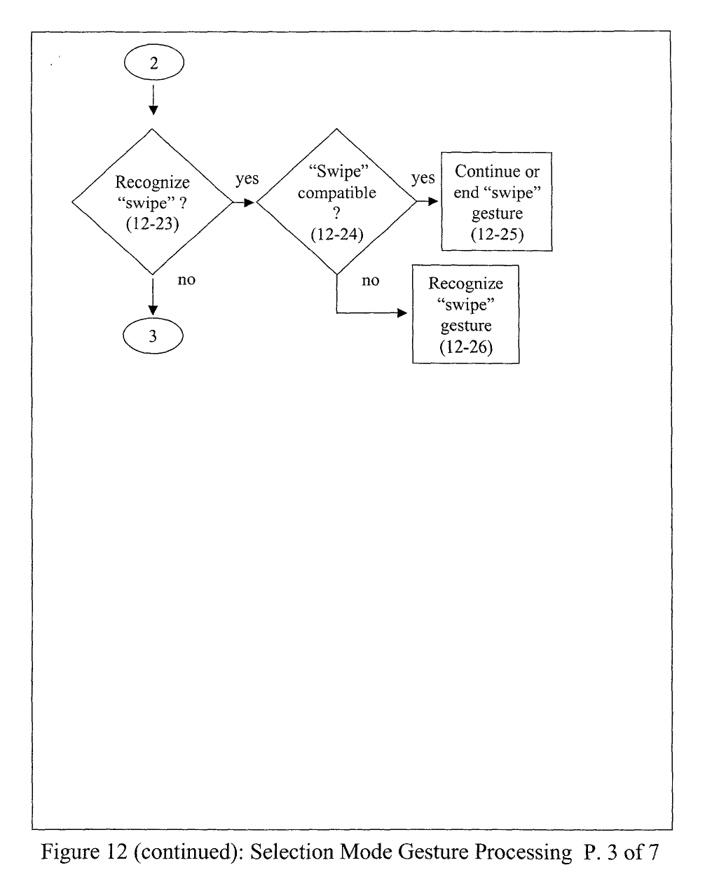

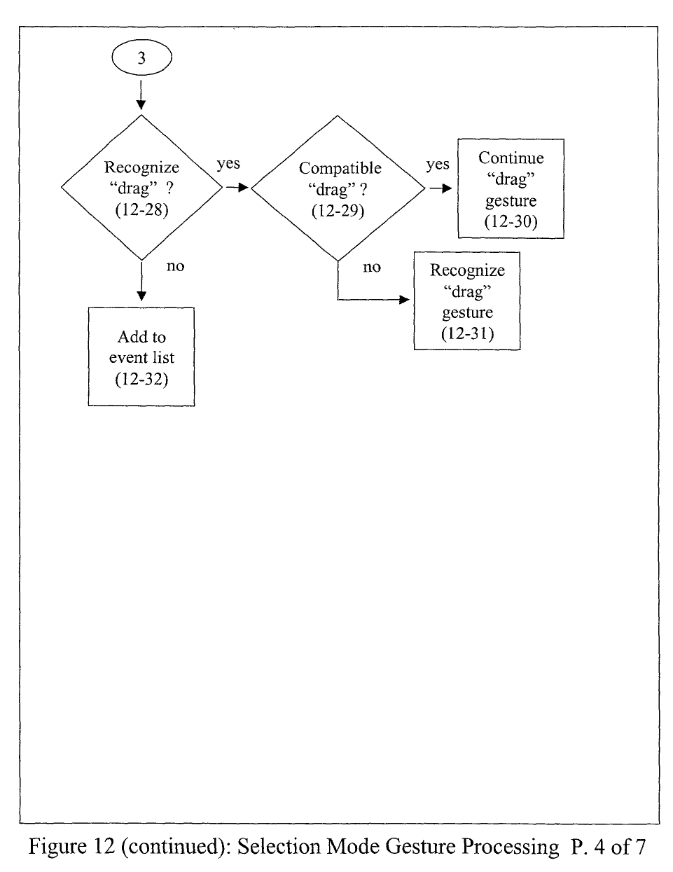

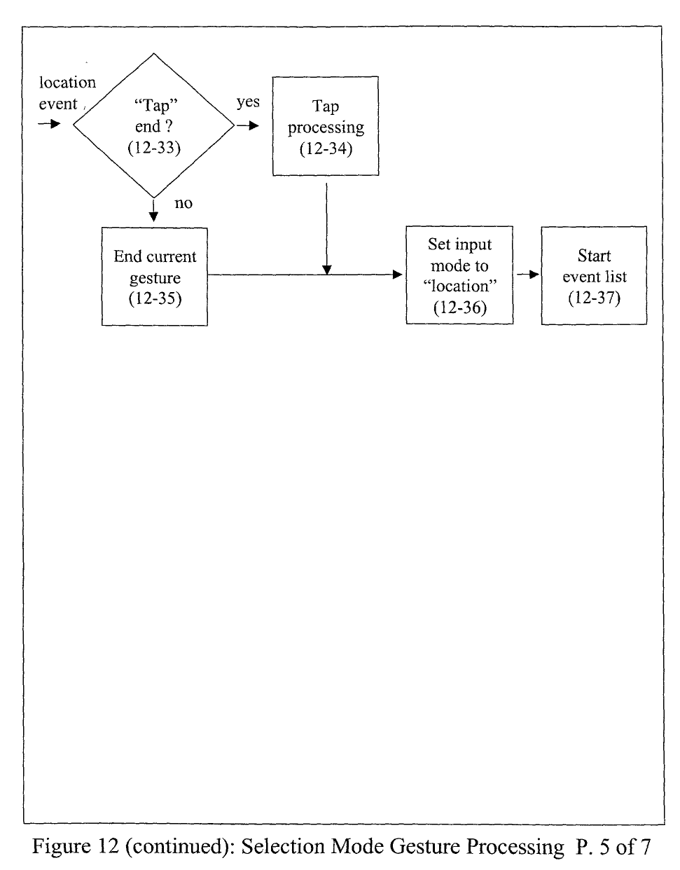

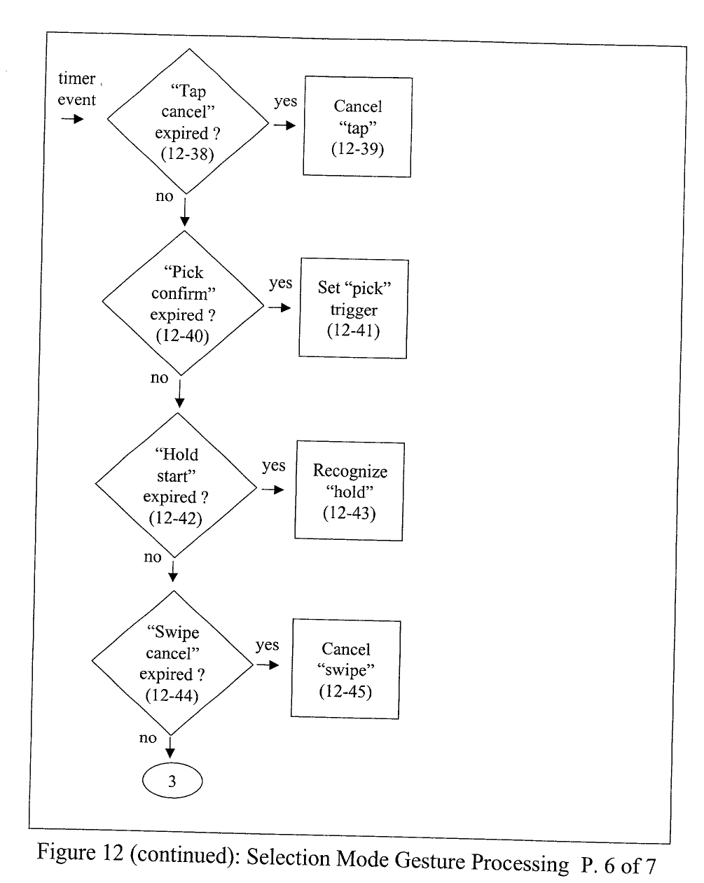

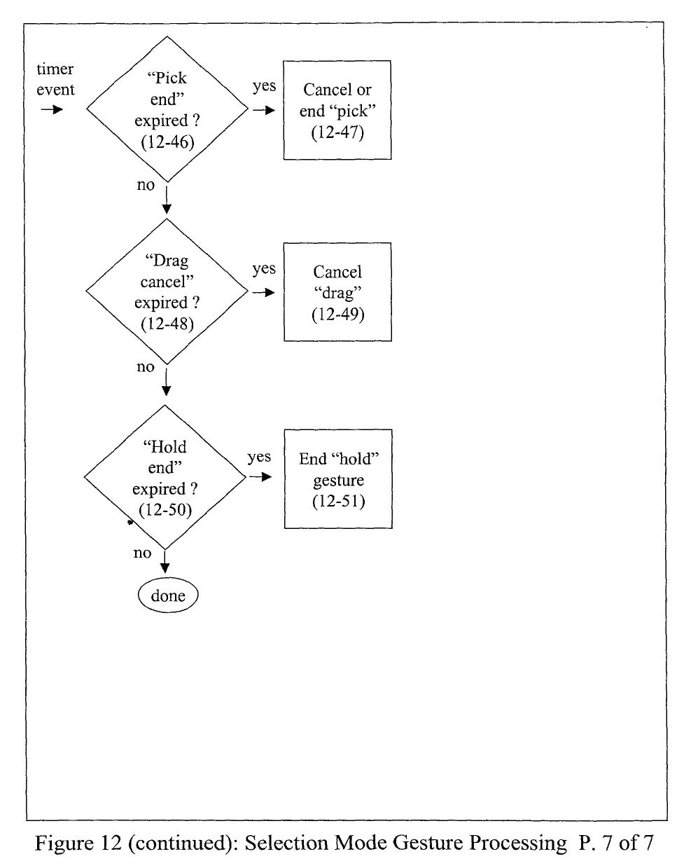

FIG. 12 illustrates exemplary gesture processing, in accordance with an illustrative embodiment, when the current input mode is selection mode. FIG. 12 shows three different processing flows, based on the type of event. Some of these processing steps use a location vector, a set of pixel locations that define a path over a client display surface.

Selection Mode Gesture Processing: Selection Event

If the event is a selection event, processing begins by determining if the event is a cancel event, with respect to the current gesture. A “pick cancel” event (12-1) cancels the current pick gesture (12-2). A “swipe cancel” event (12-5) cancels the current swipe gesture (12-6). A “tap cancel” event (12-7) cancels the current tap gesture (12-8).

If the event is not a cancel event, then the client software determines if the current location is outside the maximum delta (12-9). The current event's location is compared to the location of the first event (if any) in the event list. The recommended maximum delta is a maximum distance, in pixels, over both the horizontal and vertical dimensions. This maximum delta can be changed during gesture processing, to reflect the current state of a gesture or other client software state variable(s). If the current gesture is “none”, then a default maximum delta is used. In an illustrative embodiment, the recommended default maximum delta is no more than two (2) pixels in each dimension.

To compare with the maximum delta, the client software uses at least one entry in the event list. If event list is empty (or there is no event list), then a new event list is started using the current event as the event list's first entry and processing continues to determining if the event is an end event (12-10).

If the difference in locations is within the maximum delta, or the selection event has no associated location, then the client determines if the selection event represents an “end” event (12-10). An end event is any event that the client software recognizes as ending the current gesture. For example, a left mouse-button up or pen-up are commonly used as selection end events.

If the event is recognized as an end event, the client software determines if this event successfully completes a “tap” gesture (12-11). For example, a mouse click (left mouse-button down, followed by left mouse-button up) is a typical “tap” gesture in a mouse/keyboard user interface. If the selection event is considered to complete a tap gesture, the client performs “tap processing” (12-12) as further described below in the section “Tap Processing”. Otherwise, the client software ends the current gesture (12-13), in a manner similar to that described above in “Ending the Current Gesture”.

If the current gesture is a “pick” that has been triggered (the “pick confirm” interval was exceeded), then the pick is processed as part of ending the current gesture (12-13). If the current gesture is a “pick” that has not been triggered, then the pick gesture is cancelled as part of ending the current gesture.

If the event is not recognized as an end event, the client software determines if the event represents a start event (12-14). A start event is any event that the client recognizes as starting a gesture. For example, a left mouse-button down or pen-down are commonly used selection events to start a gesture. If the event is recognized as a start event, the client ends the current gesture (12-15) in a manner similar to step (12-13). Then the client software starts a new event list (12-16), using the current event as the event list's first entry.

If the client software starts a new gesture, it also does set-up processing for a pick (12-16a). First, it determines if the location is associated with a pick action. If not, there is no set-up required. If so, the client software determines if the type of action, and sets a “pick confirm” time-out interval based on the type of action. If the action can be done entirely locally and with minimal processing impact, the “pick confirm” interval is typically relatively short (recommended to be under 200 milliseconds). Otherwise the “pick confirm” interval is set longer to require a deliberate user confirmation (recommended to be at least 400 milliseconds after the end of the “hold start” interval).

If the event is not recognized as a start event, it is added to the event list (12-17). If there is currently no event list, a new event list is created with the current event as the event list's first entry.

If location difference is outside the recommended maximum delta (12-1), then the client software determines if the event is part of either a “swipe” or “drag” gesture.

The client software determines if it can recognize a “swipe” gesture (12-23). The total path displacement is computed from the start location (first entry in the event list) to the current location. If the event list is empty, or there is no event list, then the start location may be available in the data related to the current event. If not, then a swipe gesture cannot be recognized through this event.

The swipe duration is computed from the relative time that the swipe gesture began to the relative time of the current event. If there is an entry in the event list with relative motion compared to the start location, this is when the “swipe” began. If there is no such entry in the event list, then the “swipe” motion begins with the current event, and the client software determines (or estimates) the duration of the current event. If the event duration is not directly available, it can be estimated as the interval between the relative time of the current event and the relative time of the most recent previous event of a similar type.

Using the swipe displacements (in both the horizontal and vertical dimensions) and swipe duration, an average swipe velocity can be computed in each dimension. A swipe gesture can be recognized if, in at least one dimension, the total path displacement and average velocity meet certain minimum thresholds. In an illustrative embodiment:

a) the recommended minimum swipe displacement is at least five (5) pixels in either the horizontal or vertical direction,

b) the recommended average velocity threshold is a span of at least five (5) horizontal or vertical pixels within 400 milliseconds.

The swipe gesture may also have limitations on its path direction. For example, in an illustrative embodiment a horizontal swipe direction may not be recognized. If the direction is not within the limitations, the swipe gesture is not recognized.

If a swipe gesture is recognized from this event, then the client software determines if the current gesture is a compatible swipe gesture (12-24). If the current gesture is not a swipe gesture, then the current event is not compatible. Modifiers for the current event can be tested for compatibility with any corresponding state variable(s) associated with the current gesture. For example, the mouse button settings or pen pressure of the current event can be compared with the overall settings for the current gesture.

The motion path of the event can also be tested for compatibility with the overall direction of the path defined by the event list. For example, if the overall direction of the path is “vertical up”, then a “vertical down” event vector may not be considered compatible. Any abrupt discontinuity in the path direction introduced by the current event can be considered a basis for determining that the event is not compatible.

If the client software determines that the current swipe gesture is compatible, the client software can either continue or end the current swipe gesture (12-25). Continuing performs any associated processing, such as adding the current event to the event list. A client implementation may determine that the swipe motion is already sufficient to complete the swipe gesture, and therefore ends the swipe gesture (in a manner similar to that described above in the section “Ending the Current Gesture”).

If the current gesture is not a compatible “swipe” gesture, then the client software recognizes the swipe gesture. This sets “swipe” as the current gesture, and sets any time-out interval(s) associated with a swipe gesture. It can also include any visual and/or audio feedback to indicate that a swipe gesture has been started.

When recognizing the swipe gesture, the client software determines if all the events in the event list are part of this swipe gesture. If so, events in the event list are preserved, and the current event is added to the event list. If not, client software can determine if these previous events had already been recognized as a gesture. If the previous events had been recognized as a gesture, the client software can first end the gesture represented by these previous events (in a manner described above in the section “Ending the Current Gesture”) or just clear these previous events (thus canceling the previous gesture). This decision is implementation dependent.

If the event does not represent a swipe motion (12-23), then processing proceeds to determining if a “drag” gesture can be recognized from this event (12-28). This uses a process similar to determining a “swipe” gesture, but with lower minimum thresholds for path displacement and/or velocity. These lower thresholds distinguish a drag motion from either a swipe gesture. In an illustrative embodiment:

a) the recommended minimum drag displacement is at least three (3) pixels in either the horizontal or vertical direction,

b) the recommended average velocity threshold is a span of at least three (3) horizontal or vertical pixels within 1.5 seconds.

As with swipe, directional limitations can be placed on a drag gesture as appropriate within a client implementation. In an illustrative embodiment, there are no directional limitations placed on a drag gesture.

If the client software recognizes a “drag” gesture from this event, it determines if the current gesture is a compatible “drag” gesture (12-29). Tests for compatibility can include tests similar to those used for the swipe gesture. To be compatible, the current gesture has to be a drag gesture. Modifiers for the current event can be tested for compatibility with any corresponding state variable(s) associated with the current gesture. For example, the mouse button settings or pen pressure of the current event can be compared with the overall settings for the current gesture. If the drag gesture has a directional limitation, a compatibility test can compares the event vector's direction against the overall path direction.

If the current gesture is a compatible drag gesture, then the client software continues the current drag gesture (12-30). This performs any associated processing, such as adding current event to the event list. It can also include providing any visual and/or audio feedback associated with continuing a drag gesture.

If the current gesture is not a compatible “drag” gesture, then the client software recognizes the drag gesture (12-31). This sets “drag” as the current gesture, and sets any time-out interval(s) associated with a drag gesture. It can also include any visual and/or audio feedback to indicate that a drag gesture has been started.

When recognizing the drag gesture, the client software determines if all the events in the event list are part of this drag gesture. If so, events in the event list are preserved, and the current event is added to the event list. If not, client software can determine if these previous events had already been recognized as a gesture. If the previous events had been recognized as a gesture, the client software can first end the gesture represented by these previous events (in a manner described above in the section “Ending the Current Gesture”) or just clear these previous events (thus canceling the previous gesture). This decision is implementation dependent.

If the client software does not recognize a drag gesture, then it adds the event to the event list (12-32).

Selection Mode Gesture Processing: Location Event

If the event is a location event, the client software first determines if the current event completes a “tap” gesture (12-33). If so, tap processing (12-34) is performed, as described below in the section “Tap Processing”.

If the event does not complete a “tap” gesture then the client software ends the current gesture (12-35) as described above in the section “Ending the Current Gesture”.

The current input mode is set to location mode (12-36). The client software can also set any time-out intervals associated with location mode, such as a “hover” time-out interval (as further described above in the section “Location Mode Gesture Processing”). The client software starts a new event list (12-37) using the current event as the event list's first entry.

Selection Mode Processing: Timer Event

If the event is a timer event, the client software determines if any relevant time-out intervals have expired. If the interval being tested is set to “none”, then the test can be skipped and the answer assumed to be “no”. These tests can be done in any order, provided that the resulting processing is independent of the order in which the tests are made. If there are inter-dependencies, then the client implementation can order the tests in an appropriate manner. FIG. 12 shows an illustrative set of tests with an illustrative ordering.

The first test is for the “tap cancel” interval (12-38). If this interval has expired, then the client software cancels the current tap gesture (12-39). If the “pick confirm” interval has expired (12-40), then the client software sets the “pick” trigger (12-41). If the “hold start” interval has expired (12-42), then the client software recognizes a hold gesture (12-43). (Note that a hold gesture can become a pick gesture, if there is a “pick confirm” interval and it expires before the gesture is ended or cancelled.) If the “swipe cancel” interval has expired (12-44), then the client software cancels the current swipe gesture (12-45).

If the “pick end” interval has expired (12-46), then the client software either automatically ends or automatically cancels the current pick gesture (12-47). This decision is based on whether or not the location is associated with a pick action. If the “drag cancel” interval has expired (12-48), then the client software cancels the current drag gesture (12-49). If the “hold end” interval has expired (12-50), then the client software ends the current hold gesture (12-51).

When recognizing a gesture, the client software determines if all the events in the event list are part of this gesture. If so, events in the event list are preserved, and the current event is added to the event list. If not, client software can determine if these previous events had already been recognized as a gesture. If the previous events had been recognized as a gesture, the client software can first end the gesture represented by these previous events (in a manner described above in the section “Ending the Current Gesture”) or just clear these previous events (thus canceling the previous gesture). This decision is implementation dependent.

Special Input Mode Processing

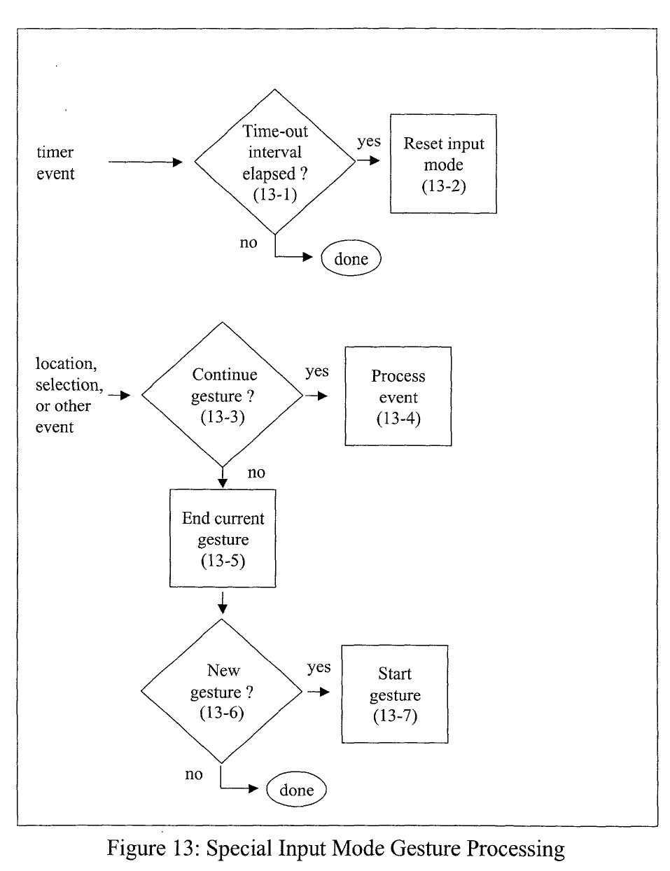

FIG. 13 illustrates exemplary gesture processing, in accordance with an illustrative embodiment, when the current input mode is a special input mode (an input mode other than location or selection mode). Special input modes can include modes such as alphanumeric mode, selection-list mode, pop-up menu mode or mark-up mode.

If the event is a timer event, then the client software determines if a relevant time-out interval has elapsed (13-1). If so, the client software resets the input mode (13-2). This leaves the special input mode, and resets to either location mode or selection mode. The choice between reset to selection mode or reset to location mode can be made based on factors such as the current special input mode before the reset, the default input mode, and the previous input mode (as previously saved during client event processing).

For all other events, client software processing starts with a decision to continue the current gesture (13-3) based on the current event. If the client software decides to continue the current gesture, then the event is processed (13-4) within the context of the current gesture. This performs whatever processing functions are appropriate for the current input mode, current event and current gesture. This can include adding the event to the event list. It can also include providing appropriate visual and/or audio feedback to reflect processing of the event.

If the client software decides not to continue the current gesture, or if the current gesture is “none”, then the client software ends the current gesture (13-5) as further described in the above section “Ending the Current Gesture”.

The client software then determines if the current event should be interpreted as the start of a new gesture (13-6). If so, the client software starts the new gesture (13-7). This performs any processing appropriate to starting the gesture, including any visual and/or audio feedback. The current gesture is set to the new gesture, and any associated time-out intervals are set. Starting the new gesture can also change the current input mode and/or start a new event list (or clear the current event list).

Tap Processing

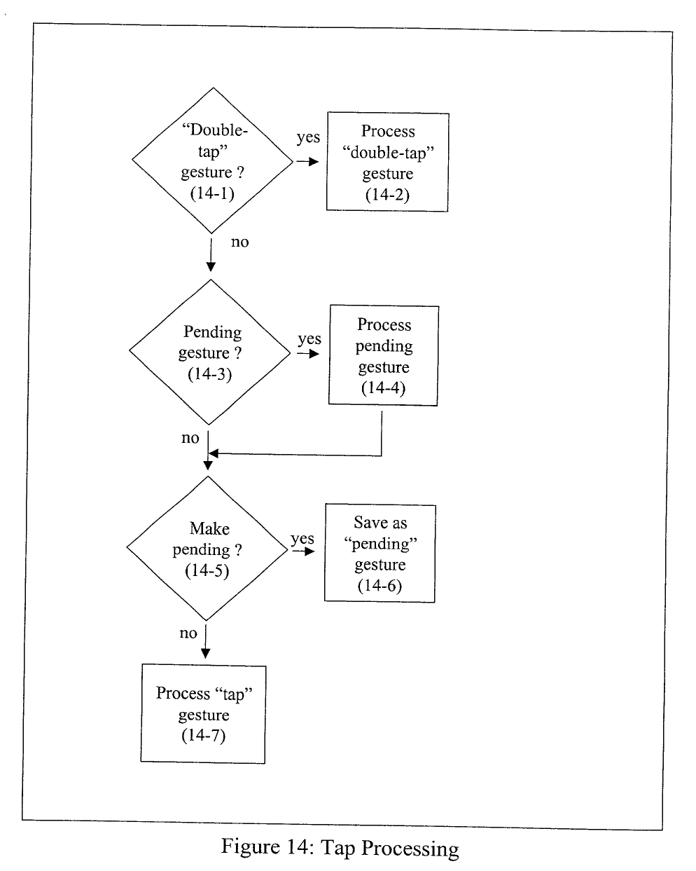

FIG. 14 illustrates exemplary tap processing, in accordance with an illustrative embodiment, when the completion of a “tap” gesture has been identified. In tap processing, the client software determines if this “tap” gesture is part of a “double-tap” gesture (14-1). This step is skipped if the client software does not support “double-tap” gestures, and processing continues with the “pending gesture” decision (14-3).

If the client software does support “double-tap” gestures, then the current “tap” gesture is compared with the pending gesture. The client software can determine if the pending gesture and current gesture are compatible “tap” gesture. The client software can also determine if the time interval between the two gestures is within a specified “double-tap” time-out interval. Based on these and/or other appropriate tests, the client determines if the gesture is a “double-tap” gesture.

If a “double-tap” gesture is recognized, then the client software processes the “double-tap” gesture (14-2). This performs any gesture-related functions associated with the double-tap. Gesture-related functions can include client processing based on the interpreted meaning of the gesture. It can also include any visual and/or audio feedback indicating that the gesture has been processed. The current gesture and pending gesture are set to “none”, and any associated time-out intervals are also set to “none”.

If a “double-tap” gesture is not recognized, or the client software does not support double-tap gestures, then the client software determines if there is a pending gesture (14-3). If so, it processes the pending gesture (14-4) in a manner similar to that previously described in the section “Ending the Current Gesture”.

The client software determines if it should make the “tap” gesture a pending gesture (14-3). Saving a gesture as a pending gesture has been previously described in the section “Ending the Current Gesture”.

If the “tap” gesture is not made into a pending gesture (14-3), then the client software processes the “tap” gesture (14-5). This performs any gesture-related functions associated with the tap gesture. Gesture-related functions can include client processing based on the interpreted meaning of the gesture. It can also include any visual and/or audio feedback indicating that the gesture has been processed. The current gesture is set to “none”, and any associated time-out intervals are also set to “none”. The client software can create a new event list (or clear the current event list).

Pixel Transform Function

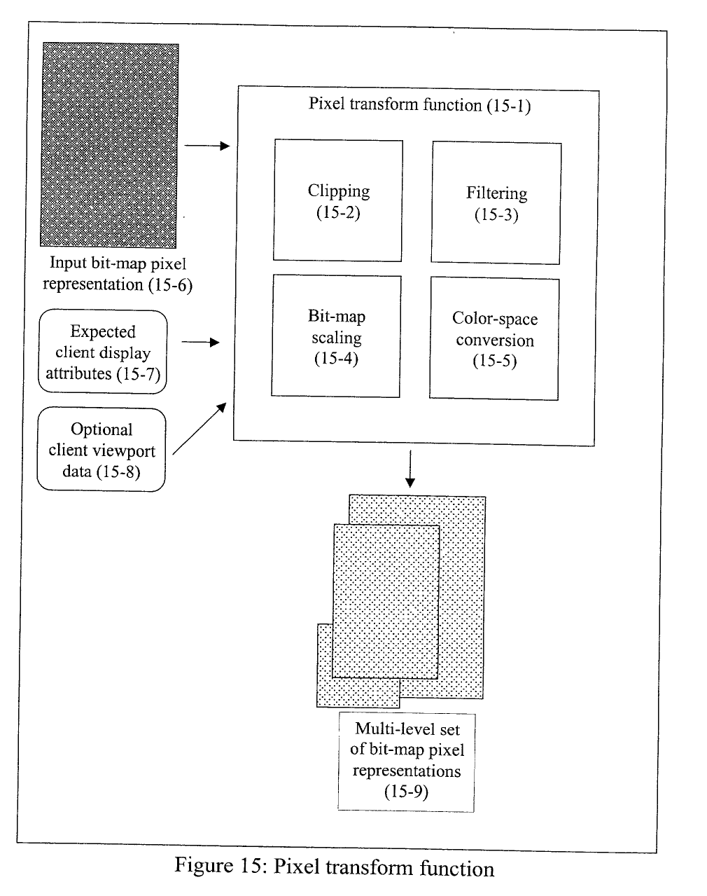

FIG. 15 is a diagram of an illustrative embodiment of a pixel transform function to transform an input bit-map pixel representation into a multi-level set of bit-maps. The illustrative pixel transform function (15-1) can use expected client display attributes (15-7) and optional client viewport data (15-8) as inputs to the process of transforming the input bit-map (15-6) into a multi-level set of bit-map pixel representations (15-9).

The pixel transform function determines the sequence of transform operations and the parameters for each such operation. The transform operations can include any number of, and any sequencing of, clipping (15-2), filtering (15-3), bit-map scaling (15-4) and/or color-space conversion (15-5) operations. The different representation levels of the multi-level set (15-9) are generated by changes to the sequence of transform operations and/or their parameters.

Each transform operation is applied to an input bit-map pixel representation and generates an output bit-map pixel representation. The source can be the original input bit-map (15-6) or an intermediate bit-map pixel representation generated by a previous transform operation. The output can be an intermediate bit-map pixel representation (for use by another transform operation) or a completed output bit-map pixel representation (a member of a 15-9 multi-level set).

With the proper parameters, any of the transform operations can act as a 1:1 mapping from the input to the output. A 1:1 mapping can be implemented as a 1:1 pixel transfer operation. Alternatively, a 1:1 mapping can be an “in place” mapping, where the input and output bit-map pixel representations share the same data structure(s).

Clipping (15-2) selects sub-regions of an input bit-map pixel representation for inclusion or exclusion in the output bit-map pixel representation. In the illustrative embodiment, clipping is done on pixel boundaries of rectangular sub-regions. Also in the illustrative embodiment, the selection of excluded sub-regions is based, for example, on one or more of the following criteria:

a) analysis of the sub-region to determine if it contains “white space” or other repetitive patterns of pixels,

b) determination that a sub-region contains unwanted content (such as an unwanted advertising banner on a Web page) based on information supplied by the rendering function (such as the type of content associated with the sub-region),

c) determination that a sub-region contains information that does not need to be included in the destination bit-map pixel representation based on its positional location (for example, the lower or lower right portion) and/or information supplied by the rendering function (such as the type of content associated with the sub-region),

d) determination that a sub-region does not fit within the pixel resolution selected for the destination bit-map pixel representation, and/or

e) determination that a sub-region does not fit within the expected client viewport

Filtering (15-3) applies an image processing filtering operation to the input bit-map pixel representation to create the output bit-map pixel representation. Filtering operations are well-known in the field of image processing. Common types of filters include sharpen filters (including edge enhancement filters), blur filters (including Gaussian blurs), noise reduction filters, contrast filters, and brightness (or luminance) filters. Well-known filtering techniques include convolution filters, min-max filters, threshold filters, filters based on image histograms.

Bit-map scaling (15-4) generates a scaled version of the input bit-map pixel representation. This allows the pixel transform function to scale an input bit-map pixel representation to be more suitable for the expected pixel resolution of the client display surface and/or client viewport. In multi-level remote browsing, bit-map scaling is used to create the different levels of representations at different pixel resolutions.

Bit-map scaling operations are well known in the field of image processing. Scaling can be used to enlarge or reduce a bit-map pixel representation. Scaling can also change the aspect ratio. High-quality scaling requires processing “neighborhoods” of pixels, so that the pixel value of each output pixel is computed from multiple input pixels surrounding a specified pixel (or sub-pixel) location.

In the illustrative embodiment, an output pixel location is mapped to a corresponding sub-pixel location on the input bit-map pixel representation. The pixel values of the pixels surrounding that sub-pixel location are used to compute the output pixel value, using a weighted combination of pixel values based on their distance from the sub-pixel location.

Color-space conversion (15-5) converts the tonal range and/or range of pixel values of an input bit-map pixel representation. For example, a 24-bit RGB color bit-map can be color-space converted to a 4-bit grayscale bit-map. Another example is converting a 24-bit RGB color-space into an 8-bit lookup-table color-space. A third example is a “false color” mapping of a gray-scale tonal range into a color tonal range. Techniques for color-space conversion are well known in the field of image processing.

In the illustrative embodiment, color-space conversion is primarily used for color-space reduction: reducing the tonal range and/or range of pixel values. Color-space reduction in the illustrative embodiment is based on the expected client display attributes and/or optional client viewport data. When the client has a limited tonal range and/or limited range of pixel values, color-space conversion on the server can result in considerable data reduction without affecting the perceived image quality on the client.

Even if the client can support a wide range of pixel values and multiple tonal ranges, the data reduction advantages of color-space reduction can be considerable. This is particularly true in multi-level browsing, where decisions can be made at each representation level about both color-space and pixel resolution. For example, different color reductions might be applied at the overview, intermediate and detail levels.

In the illustrative embodiment, the transform operations for the overview representation are different from those used for the detail representation. This is because the overview representation has a considerably lower pixel resolution than the detail representation. Also in the illustrative embodiment, the overview representation's pixel resolution and aspect ratio are more sensitive to optional client viewport data than the detail representation. To produce a useful representation at a lower resolution typically requires more filtering. For example, a sharpen filter in the sequence of transform operations can improve the perceived image quality of the overview representation.

Transform operations can be processed sequentially, such that one operation is completed before the next operation begins, or structured as a pipeline. In a pipeline configuration, the input bit-map is segmented into sub-regions and the sequence of operations is performed on a “per sub-region” basis. Pipelining can be more efficient, particularly if it is directly supported by the underlying computer hardware. Pipelining can also enable faster display of selected sub-region(s), resulting in faster perceived user responsiveness (even if the time to complete operations on sub-regions is the same or even greater than a non-pipelined configuration).

Mapping Representation-Level Locations to the Source Bit-Map Representation

In location events and certain selection events, the event is associated with an (X,Y) pixel location on a client display surface. For a multi-level set, the client display surface represents one or more derived bit-map(s) of the multi-level set. In an illustrative embodiment, each client display surface is mapped from a single derived representation level.

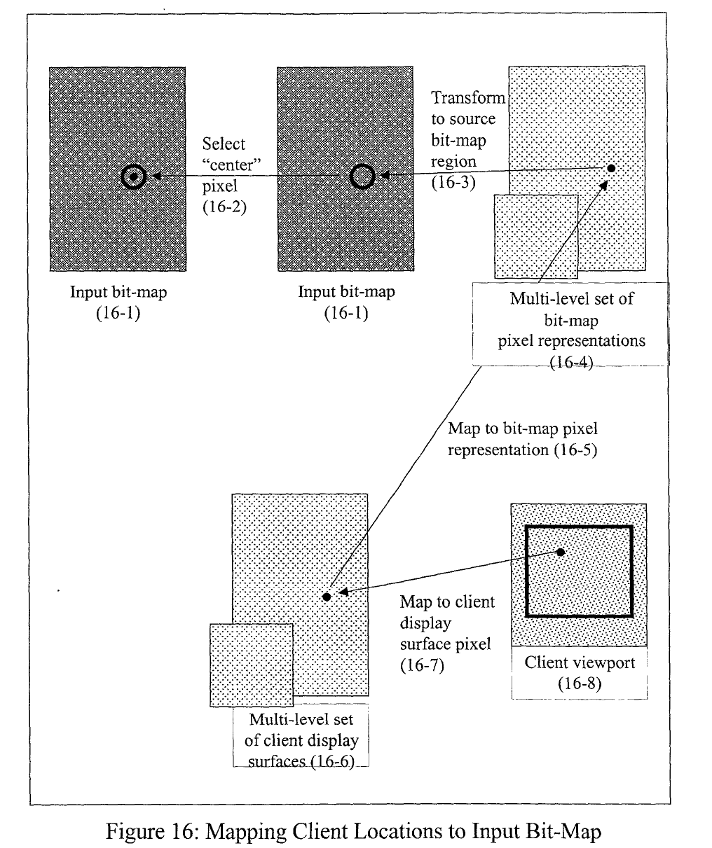

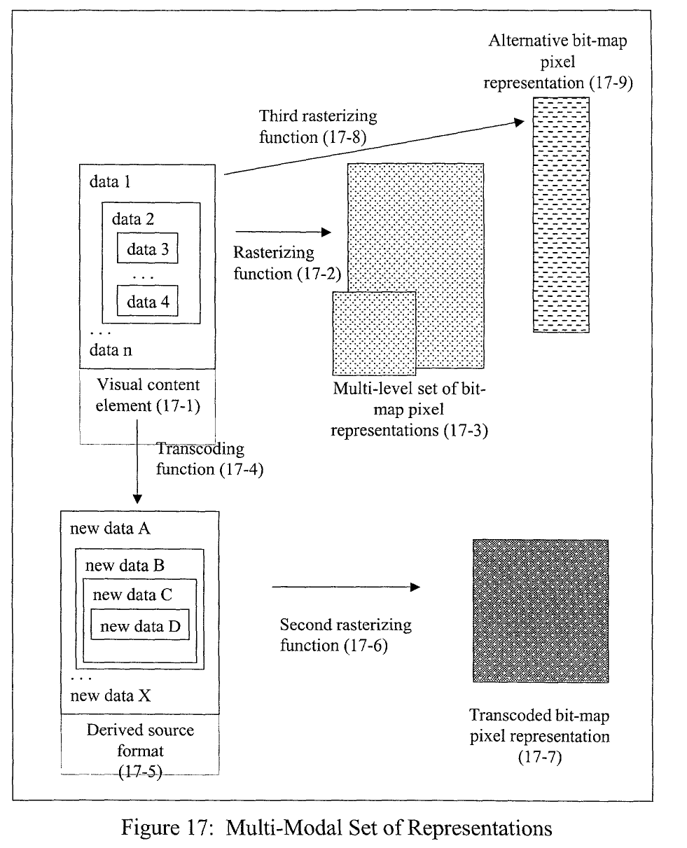

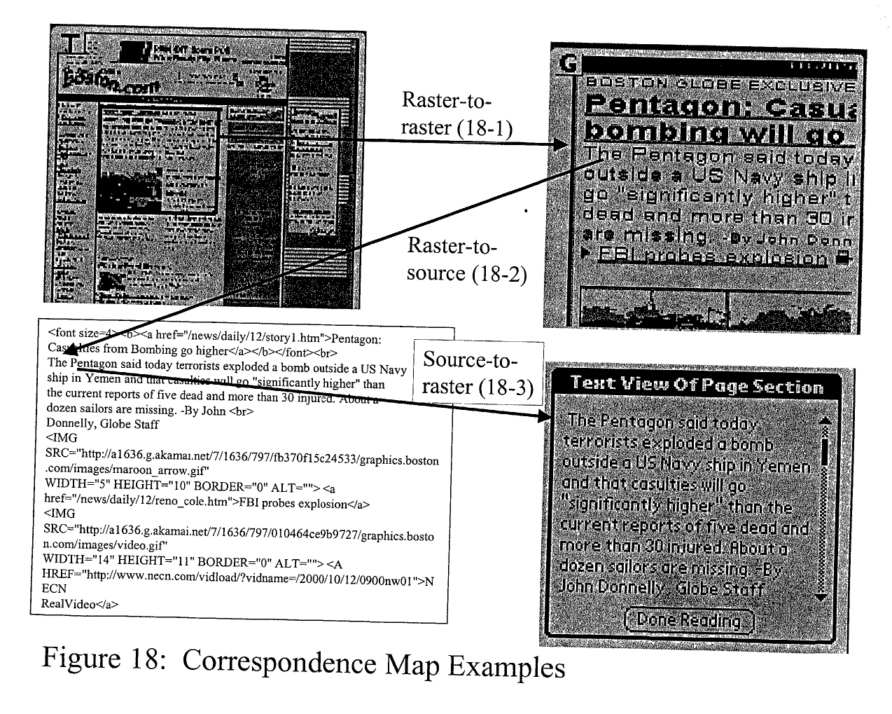

In some processing functions, it is useful to map the location on the client display surface back to a corresponding area within the input bit-map pixel representation. An exemplary process of mapping from such a client pixel location to the input bit-map pixel representation is illustrated in FIG. 16.

If the location coordinates are initially reported in terms of the client viewport (16-8), then the client maps (16-7) these coordinates to the equivalent coordinates on its client display surface. The mapping from a pixel location on the client viewport to a pixel location on the client display surface is typically a 1:1 mapping (unless the painting function inserts a pixel “zoom” or “shrink” operation).

The client display surface (X,Y) pixel coordinate pair can then be mapped to the input bit-map pixel representation (16-1). Illustratively, this function has these steps:

a) determine the representation level associated with the client display surface coordinates;

b) map the client display surface coordinates to pixel coordinates associated with the appropriate bit-map pixel representation of the multi-level set; and

c) transform the pixel coordinates associated with the bit-map pixel representation to input bit-map pixel coordinates.

In an illustrative embodiment, there is one client display surface associated with each representation level. But if a client display surface is associated with more than one representation level, then the client is responsible for maintaining the mapping. The client is able to unambiguously map each pixel in the client display surface to a single representation level, or to no representation level (if the pixel is not associated with a representation level, e.g. from an additional control or additional information added by the client).

With the representation level established, the software performs the mapping (16-5) of the (X,Y) pixel coordinate pair from the client display surface to an (X,Y) pixel coordinate pair in the appropriate bit-map pixel representation (16-4) of the multi-level set.

The mapping (16-3) of representation-level coordinates to proxy display surface coordinates is not necessarily 1:1. The overview representation is a scaled view of the input bit-map pixel representation. The transforms to generate the detail representation and any optional intermediate representations can optionally include scaling. Therefore, the mapping from the representation-level coordinates to input bit-map pixel coordinates can result in a sub-pixel region on the input bit-map rather than a single pixel location.

This sub-pixel region has coordinates that are on sub-pixel boundaries within the input bit-map. This region may cover a part of a single source pixel, an entire source pixel, or portions of multiple source pixels within the input bit-map. In an illustrative embodiment, this sub-pixel region is interpreted as a circular sub-pixel region, although it could be interpreted as an elliptical region, rectangular region or other geometric shape.

This sub-pixel region is used as the basis for any related processing functions using the corresponding area of the input bit-map. This can include generating events on a display surface that includes a mapping of the corresponding area of the input bit-map pixel representation. In an illustrative embodiment, the related processing function can calculate the centroid of the sub-pixel region.

Then, in an illustrative embodiment, the software can calculate (16-2) the “center pixel”: the pixel with the centroid smallest distance to the sub-region centroid. The coordinates of this center pixel, as mapped to the display surface of the corresponding area, are used as the (X,Y) location for the generated event(s). Note that the input bit-map (16-1) is shown twice in FIG. 16, in order to illustrate the actions taken by the select “center” pixel step (16-2).

In the illustrative embodiment, the distance calculation is a standard geometric distance calculation such as: the square root of (X1−X2)²+(Y1−Y2)², where (X1, Y1) are the sub-pixel coordinates of the sub-pixel region's centroid and the (X2, Y2) are the sub-pixel coordinates of the selected pixel's centroid. If more than one pixel has the same smallest distance (within the error tolerance of the distance calculation), the software selects one of these pixels as the “center” pixel.

If the sub-pixel region spans multiple pixels on the input bit-map, then the related processing function can choose to perform related processing (such as generating a set of events) at a sampled set of pixel locations over the sub-pixel region. The sampled locations may or may not include the calculated closest center pixel.

Although specific features of the invention are shown in some drawings and not others, this is for convenience only, as aspects of the invention can be combined as would be apparent to those skilled in the art.

Other embodiments will occur to those skilled in the art, and are within the scope of the following claims.

What is claimed is:

1. A method of navigating within a plurality of bit-maps through a client user interface, comprising the steps of:
displaying at least a portion of a first one of the bit-maps on the client user interface;
receiving a gesture at the client user interface; and
in response to the gesture, altering the display by substituting at least a portion of a different one of the bit-maps for at least a portion of the first bit-map.

2. The method of claim 1 wherein the bit-maps depict common subject matter at different resolutions.

3. The method of claim 1 wherein the gesture comprises a location gesture.

4. The method of claim 3 wherein the location gesture comprises a sequence of at least one client event.

5. The method of claim 3 wherein the gesture comprises at least one of a move and a hover.

6. The method of claim 5 wherein the user interface comprises a pointing device.

7. The method of claim 6 wherein the move gesture comprises a pointing device start location on the client interface and a pointing device end location on the client interface.

8. The method of claim 6 wherein the hover gesture comprises a hover start event followed by the pointing device remaining relatively still for at least a predetermined time interval.

9. The method of claim 1 wherein the gesture comprises a selection gesture.

10. The method of claim 9 wherein the gesture comprises at least one of a swipe, a drag, a pick, a tap, a double-tap, and a hold.

11. The method of claim 10 wherein the user interface comprises a pointing device.

12. The method of claim 11 wherein the swipe gesture comprises a pointing device movement of at least a certain distance within no more than a predetermined time.

13. The method of claim 12 wherein the swipe gesture further comprises a pointing device movement in a particular determined direction across the user interface.

14. The method of claim 12 wherein the swipe gesture further comprises a pointing device movement that begins within the client device viewport, and ends outside of the client device viewport.

15. The method of claim 11 wherein the drag gesture comprises a pointing device movement of at least a certain distance within no more than a predetermined time.

16. The method of claim 11 wherein the hold gesture comprises a hold start event followed by the pointing device remaining relatively still within a predetermined hold region for at least a predetermined hold time interval.

17. The method of claim 16 wherein the pick gesture comprises the pointing device continuing to remain relatively still within a predetermined hold region for at least a predetermined pick time interval beyond the hold time interval.

18. The method of claim 11 wherein the tap gesture comprises two sequential pointing device selection actions without substantial motion of the pointing device.

19. The method of claim 18 wherein the double tap gesture comprises four sequential pointing device selection actions, without substantial motion of the pointing device, within a predetermined double tap time.

20. The method of claim 1 wherein one bit-map includes a source visual content element rasterized into a bit-map representation through a first rasterizing mode and at least one other bit-map includes the source visual content element rasterized into a bit-map representation through a second rasterizing mode.

21. The method of claim 20 wherein the first and second rasterizing modes can differ from one another by at least one of a difference in a parameter of the rasterizing function, a difference in rasterizing algorithm, a difference in a parameter of a transcoding step, a difference in transcoding algorithm, and the insertion of at least one transcoding step before the rasterizing.

22. The method of claim 1 further including creating at least one correspondence map to map between corresponding parts of different bit-maps, to allow correspondences to be made between related areas of related bit-maps.

23. The method of claim 22 wherein a correspondence map is a source to source map that maps the correspondences from one source to another related source.

24. The method of claim 22 wherein a correspondence map is a source to raster map that maps the correspondences from a source element to a rasterized representation of that source element.

25. The method of claim 22 wherein a correspondence map is a raster to source map that maps the correspondences from a rasterized representation of a source element to that source element.

26. The method of claim 22 wherein a correspondence map is a raster to raster map that maps corresponding pixel regions within the raster representations.

27. The method of claim 20 wherein a first rasterizing mode is a rasterization and another rasterizing mode comprises a transcoding step.

28. The method of claim 27 further including an intermediate transcoding step to extract text-related aspects of the source visual content element and store them in a transcoded representation.

29. The method of claim 1 wherein one bit-map includes a source visual content element rasterized into a bit-map representation through one rasterizing mode, to accomplish an overview representation.

30. The method of claim 29 wherein another bit-map includes a text-related summary extraction of a source visual content element from the overview representation.

31. The method of claim 30 wherein the text-related summary extraction is displayed separately from the overview representation on the client user interface display.

32. The method of claim 31 wherein the text-related summary extraction is displayed over the portions of the overview representation containing the extracted source visual content element.

33. The method of claim 32 wherein the text-related summary extraction is displayed apart from the portions of the overview representation containing the extracted source visual content element.

34. The method of claim 1 wherein the method is accomplished in a client-server environment.

35. A system for navigating within a plurality of bit-maps comprising:
a client user interface for entry of user interface events;
a client display for displaying at least a portion of a first one of the bit-maps; and
a client processor in communication with the client user interface and the client display, the client processor detecting a user interface event and determining a gesture type in response thereto, the client processor altering the display of the at least a portion of a first one of the bit-maps by substituting at least a portion of a different one of the bit maps for at least a portion of the first bit-map
